(19) United States
(12) Patent Application Publication
(10) Pub. No.: US 2022/0132517 A1
(43) Pub. Date: Apr. 28, 2022

(54) METHOD AND APPARATUS FOR PARTIAL BEAM FAILURE RECOVERY IN A WIRELESS COMMUNICATIONS SYSTEM

(71) Applicant: Samsung Electronics Co., Ltd., Suwon-si (KR)

(72) Inventors: Dalin Zhu, Richardson, TX (US); Eko Onggosanusi, Coppell, TX (US); Jinhyun Park, Seoul (KR); Youngrok Jang, Seoul (KR); Hyoungju Ji, Seoul (KR)

(21) Appl. No.: 17/451,611

(22) Filed: Oct. 20, 2021

Related U.S. Application Data
(60) Provisional application No. 63/105,133, filed on Oct. 23, 2020.
(60) Provisional application No. 63/139,110, filed on Jan. 19, 2021.
(60) Provisional application No. 63/179,752, filed on Apr. 26, 2021.
(60) Provisional application No. 63/255,643, filed on Oct. 14, 2021.

(51) Int. Cl. H04W 72/08; H04W 72/04; H04L 5/00; H04B 1/74

(52) U.S. Cl. CPC H04W 72/085; H04W 72/044; H04B 1/74; H04W 72/042; H04L 5/0051; H04L 5/0042

(57) ABSTRACT

Apparatuses and methods for beam failure recovery in a wireless communication system. A method for operating a user equipment (UE) includes receiving a first pair of reference signal (RS) sets including (i) a first set of RSs for detecting a first beam failure and (ii) a second set of RSs for identifying a first candidate beam for recovering the first beam failure and receiving a second pair of RS sets including (i) a third set of RSs for detecting a second beam failure and (ii) a fourth set of RSs for identifying a second candidate beam for recovering the second beam failure. The method further includes detecting the first or second beam failure; identifying a physical uplink control channel (PUCCH) resource for transmission of a recovery request for the detected first or second beam failure; and transmitting a first signal to request recovery of the first or second beam failure using the PUCCH resource.

### CROSS-REFERENCE TO RELATED APPLICATIONS AND CLAIM OF PRIORITY

The present application claims priority to:
U.S. Provisional Patent Application No. 63/105,133, filed on Oct. 23, 2020;
U.S. Provisional Patent Application No. 63/139,110, filed on Jan. 19, 2021;
U.S. Provisional Patent Application No. 63/179,752, filed on Apr. 26, 2021; and
U.S. Provisional Patent Application No. 63/255,643, filed on Oct. 14, 2021. The content of the above-identified patent document is incorporated herein by reference.

### TECHNICAL FIELD

The present disclosure relates generally to wireless communication systems and, more specifically, the present disclosure relates to beam failure recovery in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a beam failure recovery in a wireless communication system.

In one embodiment, a user equipment (UE) is provided. The UE includes s transceiver configured to receive a first pair of reference signal (RS) sets including (i) a first set of RSs, through a first set of RS resources, for detecting a first beam failure and (ii) a second set of RSs, through a second set of RS resources, for identifying a first candidate beam for recovering the first beam failure and receive a second pair of RS sets including (i) a third set of RSs, through a third set of RS resources, for detecting a second beam failure and (ii) a fourth set of RSs, through a fourth set of RS resources, for identifying a second candidate beam for recovering the second beam failure. The first set of RSs and the second set of RSs have a same resource set index or identity (ID). The third set of RSs and the fourth set of RSs have a same resource set index or ID. The UE also includes a processor operably coupled to the transceiver. The processor is configured to detect the first or second beam failure and identify a physical uplink control channel (PUCCH) resource, from a first PUCCH resource associated with the first set of RSs and a second PUCCH resource associated with the third set of RSs, for transmission of a recovery request for the detected first or second beam failure. The transceiver is further configured to transmit a first signal to request recovery of the first or second beam failure using the PUCCH resource.

In another embodiment, a base station (BS) is provided. The BS includes a processor and a transceiver operably coupled to the processor. The transceiver is configured to transmit: a first pair of RS sets including (i) a first set of RSs, through a first set of RS resources, for detecting a first beam failure and (ii) a second set of RSs, through a second set of RS resources, for identifying a first candidate beam for recovering the first beam failure, or a second pair of RS sets including (i) a third set of RSs, through a third set of RS resources, for detecting a second beam failure and (ii) a fourth set of RSs, through a fourth set of RS resources, for identifying a second candidate beam for recovering the second beam failure. The first set of RSs and the second set of RSs have a same resource set index or ID. The third set of RSs and the fourth set of RSs have a same resource set index or ID. Responsive to the first or second beam failure, the transceiver is further configured to receive a first signal including a request for recovery of the first or second beam failure through a PUCCH resource that is one of a first PUCCH resource associated with the first set of RSs and a second PUCCH resource associated with the third set of RSs.

In yet another embodiment, a method for operating a UE is provided. The method includes receiving a first pair of reference signal (RS) sets including (i) a first set of RSs, through a first set of RS resources, for detecting a first beam failure and (ii) a second set of RSs, through a second set of RS resources, for identifying a first candidate beam for recovering the first beam failure and receiving a second pair of RS sets including (i) a third set of RSs, through a third set of RS resources, for detecting a second beam failure and (ii) a fourth set of RSs, through a fourth set of RS resources, for identifying a second candidate beam for recovering the second beam failure. The first set of RSs and the second set of RSs have a same resource set index or ID. The third set of RSs and the fourth set of RSs have a same resource set index or ID. The method further includes detecting the first or second beam failure; identifying a PUCCH resource, from a first PUCCH resource associated with the first set of RSs and a second PUCCH resource associated with the third set of RSs, for transmission of a recovery request for the detected first or second beam failure; and transmitting a first signal to request recovery of the first or second beam failure using the PUCCH resource.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIGS. 4 and 5 illustrate example wireless transmit and receive paths according to this disclosure;

FIG. 6A illustrates an example of a beam failure for a primary cell (PCell) according to embodiments of the present disclosure;

FIG. 6B illustrates a signaling flow of a beam failure recovery operation for a primary cell (PCell) according to embodiments of the present disclosure;

FIG. 7A illustrates an example of a beam failure for a secondary cell (SCell) according to embodiments of the present disclosure;

FIG. 7B illustrates a signaling flow of a beam failure recovery operation for a secondary cell (SCell) according to embodiments of the present disclosure;

FIG. 8 illustrates an example of a beam failure in a multi-TRP system according to embodiments of the present disclosure;

FIG. 9 illustrates another example of a beam failure in a multi-TRP system according to embodiments of the present disclosure;

FIG. 10 illustrates an example of a beam failure in a multi-PDCCH/DCI based multi-TRP system according to embodiments of the present disclosure;

FIG. 11 illustrates a signaling flow for a reduced TRP-specific or per TRP BFR procedure in a multi-TRP system according to embodiments of the present disclosure;

FIG. 12 illustrates an example of MAC entities for cell-specific or TRP-specific BFR operation according to embodiments of the present disclosure;

FIG. 13 illustrates an example of BFD RSs configurations in a multi-TRP system according to embodiments of the present disclosure;

FIG. 14 illustrates another example of BFD RSs configurations in a multi-TRP system according to embodiments of the present disclosure;

FIG. 15 illustrates an example of a MAC entity for partial BFR in a multi-TRP system according to embodiments of the present disclosure; and

FIG. 16 illustrates another example of a MAC entity for partial BFR in a multi-TRP system according to embodiments of the present disclosure.

### DETAILED DESCRIPTION

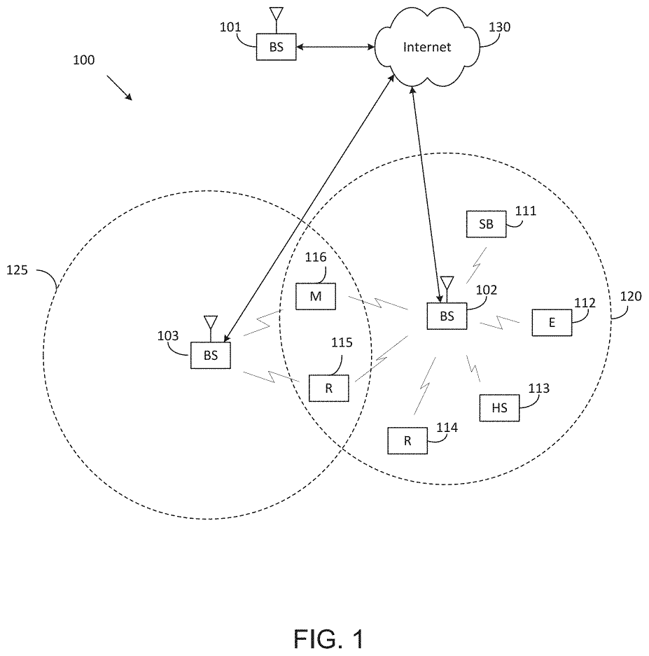

FIG. 1 through FIG. 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v 16.1.0, “NR; Physical Channels and Modulation”; 3GPP TS 38.212 v 16.1.0, “NR; Multiplexing and Channel coding”; 3GPP TS 38.213 v 16.1.0, “NR; Physical Layer Procedures for Control”; 3GPP TS 38.214 v 16.1.0, “NR; Physical Layer Procedures for Data”; 3GPP TS 38.321 v 16.1.0, “NR; Medium Access Control (MAC) protocol specification”; and 3GPP TS 38.331 v 16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of UEs within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3GPP NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for partial beam failure recovery in a wireless communication system. In certain embodiments, and one or more of the gNBs 101-103 includes circuitry, programing, or a combination thereof, for partial beam failure recovery in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

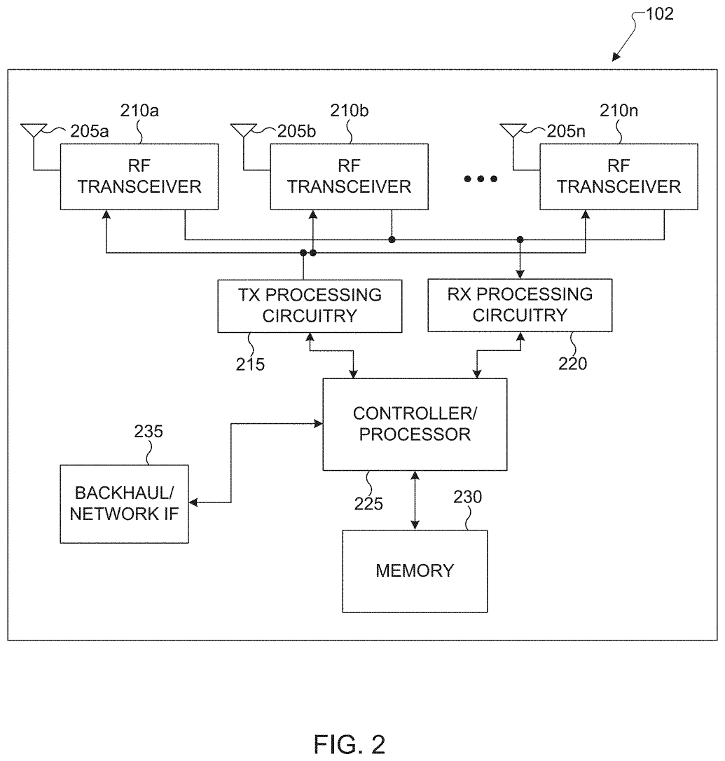

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support routing functions to route data between different network addresses. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

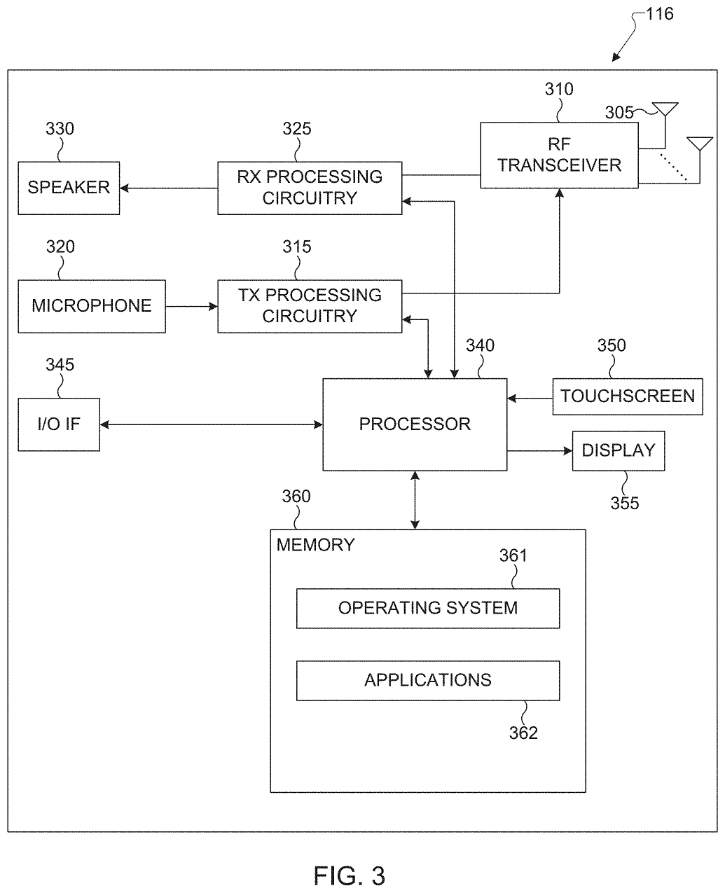

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, TX processing circuitry 315, a microphone 320, and receive (RX) processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of forward channel signals and the transmission of reverse channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for a partial beam failure in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

A communication system includes a downlink (DL) that refers to transmissions from a base station or one or more transmission points to UEs and an uplink (UL) that refers to transmissions from UEs to a base station or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 0.5 milliseconds or 1 millisecond, include 14 symbols and an RB can include 12 SCs with inter-SC spacing of 30 KHz or 15 KHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB transmits one or more of multiple types of RS including channel state information RS (CSI-RS) and demodulation RS (DMRS). A CSI-RS is primarily intended for UEs to perform measurements and provide CSI to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE can determine CSI-RS transmission parameters through DL control signaling or higher layer signaling, such as radio resource control (RRC) signaling, from a gNB. Transmission instances of a CSI-RS can be indicated by DL control signaling or be configured by higher layer signaling. A DM-RS is transmitted only in the BW of a respective PDCCH or PDSCH and a UE can use the DMRS to demodulate data or control information.

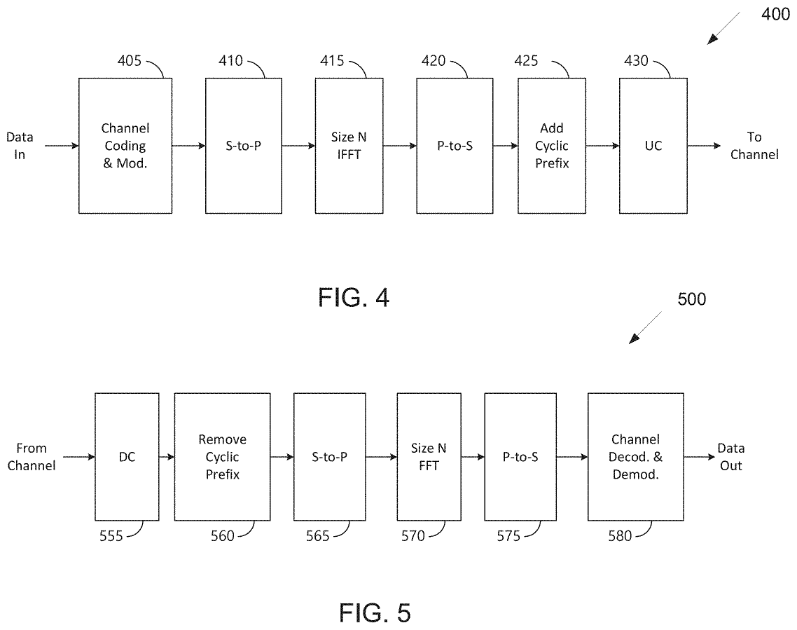

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support the beam indication channel in a multi-beam system as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

In a wireless communications system, a radio link failure (RLF) could occur if a significant/sudden link quality drop is observed at the UE side. If a RLF occurs, fast RLF recovery mechanisms, therefore, become essential to promptly re-establish the communication link(s) and avoid severe service interruption. At higher frequencies, e.g., millimeter-wave (mmWave) frequencies or FR2 in the 3GPP NR, both the transmitter and receiver could use directional (analog) beams to transmit and receive data signals. Hence, prior to declaring a full RLF, the UE could first detect and recover a potential beam failure if the signal qualities/strengths of certain beam pair links (BPLs) are below a certain threshold for a certain period of time.

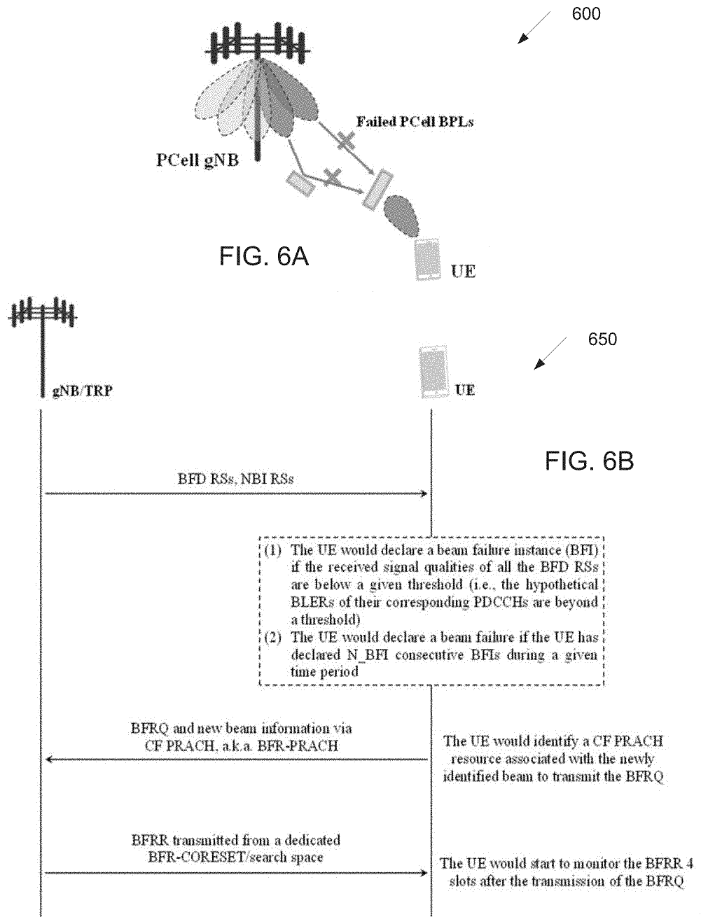

FIG. 6A illustrates an example of a beam failure 600 for a primary cell (PCell) according to embodiments of the present disclosure. An embodiment of the beam failure 600 for a primary cell (PCell) shown in FIG. 6A is for illustration only.

FIG. 6B illustrates a signaling flow 650 of a beam failure recovery operation for a primary cell (PCell) according to embodiments of the present disclosure. An embodiment of the beam failure recovery operation 650 for a primary cell (PCell) shown in FIG. 6B is for illustration only. For example, the signaling flow 650 may be implemented between a UE (e.g., 111-116 as illustrated in FIG. 1) and BSs station (e.g., 101-103 as illustrated in FIG. 1).

The 3GPP Rel. 15 beam failure recovery (BFR) procedure mainly targets for a primary cell (PCell or SpCell) under the carrier aggregation (CA) framework as illustrated in FIG. 6A. The BFR procedure in the 3GPP Rel. 15 comprises the following key components, which are also illustrated in FIG. 6B: (1) beam failure detection (BFD); (2) new beam identification (NBI); (3) BFR request (BFRQ); and (4) BFRQ response (BFRR).

As illustrated in FIG. 6B, the UE is first configured by the gNB with a set of BFD RS resources to monitor the link qualities between the gNB and the UE. One BFD RS resource could correspond to one (periodic) CSI-RS/SSB resource configured as a QCL-typeD (spatial quasi-co-location) RS in a TCI state of a CORESET. If the received signal qualities of all the BFD RS resources are below a given threshold (implying that the hypothetical BLERs of the corresponding CORESETs/PDCCHs are above a given threshold), the UE could declare a beam failure instance (BFI). Further, if the UE has declared a predefined number of consecutive BFIs within a given time period, the UE would declare a beam failure.

After declaring/detecting the beam failure, the UE would transmit the BFRQ to the gNB via a contention-free (CF) PRACH (CF BFR-PRACH) resource, whose index is associated with a new beam identified by the UE. Specifically, to determine a potential new beam, the UE could be first configured by the network with a set of SSB and/or CSI-RS resources (NBI RS resources), e.g., through the higher layer parameter candidateBeamRSList. The UE would then measure the NBI RSs and calculate their corresponding beam metrics such as L1-RSRPs. If at least one of the measured L1-RSRPs of the NBI RSs is beyond a given threshold, the UE would select the beam that corresponds to the NBI RS with the highest L1-RSRP as the new beam. To determine a CF BFR-PRACH resource to carry the BFRQ, the UE could be first configured by the network with a set of PRACH resources, each associated with a NBI RS resource. The UE could then select the PRACH resource that has the one-to-one correspondence to the selected NBI RS resource (the new beam) to send the BFRQ to the gNB. From the index of the selected CF PRACH resource, the gNB could know which beam is selected by the UE as the new beam.

Four slots after the UE has transmitted the BFRQ, the UE could start to monitor a dedicated CORESET/search space for BFRQ response. The dedicated CORESET is addressed to the UE-specific C-RNTI, and would be transmitted by the gNB with the newly identified beam. If the UE detects a valid UE-specific DCI in the dedicated CORESET for BFRR, the UE would assume that the beam failure recovery request has been successfully received by the network, and the UE would complete the BFR process. Otherwise, if the UE does not receive the BFRR within a configured time window, the UE would initiate a contention-based random access (CBRA) process to reconnect to the network.

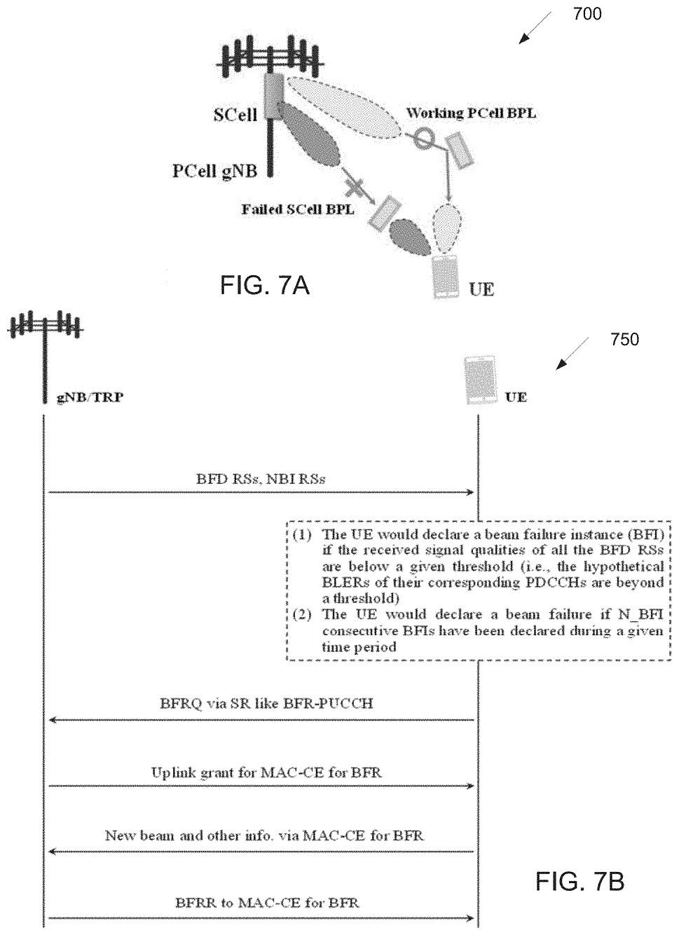

FIG. 7A illustrates an example of a beam failure 700 for a secondary cell (SCell) according to embodiments of the present disclosure. An embodiment of the beam failure 700 for a secondary cell (SCell) shown in FIG. 7A is for illustration only.

In the 3GPP Rel. 16, the BFR procedures were customized for the secondary cell (SCell) under the CA framework, in which the BPL(s) between the PCell and the UE is assumed to be always working. An illustrative example of the SCell beam failure is given in FIG. 5A. In FIG. 5B, the key components of the Rel. 16 SCell BFR are presented. It is evident from FIG. 5B that prior to sending the BFRQ, the Rel. 15 and Rel. 16 BFR procedures have similar BFD settings/configurations.

FIG. 7B illustrates a signaling flow 750 of a beam failure recovery operation for a secondary cell (SCell) according to embodiments of the present disclosure. An embodiment of the signaling flow 750 shown in FIG. 7B is for illustration only. For example, the signaling flow 750 may be implemented between a UE (e.g., 111-116 as illustrated in FIG. 1) and BSs station (e.g., 101-103 as illustrated in FIG. 1).

After declaring/detecting the beam failure for the SCell, the UE would transmit the BFRQ as a scheduling request (SR) over the PUCCH (or PUCCH-SR) for the working PCell. Further, the UE would only transmit the BFRQ at this stage without any new beam index, failed SCell index or other information. This is different from the Rel. 15 procedure, in which the UE would indicate to the network both the BFRQ and the new beam index at the same time. Allowing the gNB to quickly know the beam failure status of the SCell without waiting for the UE to identify a new beam could be beneficial. For instance, the gNB could deactivate the failed SCell and allocate the resources to other working SCells.

The UE could be indicated by the network an uplink grant in response to the BFRQ PUCCH-SR, which would allocate necessary resources for the MAC CE to carry new beam information (if identified), failed SCell index and etc. over the PUSCH for the working PCell. After transmitting the MAC CE for BFR to the working PCell, the UE would start to monitor the BFRR. The BFRR could be a TCI state indication for a CORESET from/associated with the corresponding SCell. The BFRR to the MAC CE for BFR could also be a normal uplink grant for scheduling a new transmission for the same HARQ process (with the same HARQ process ID) as the PUSCH carrying the MAC CE for BFR. If the UE could not receive the BFRR within a preconfigured time window, the UE could transmit the BFRQ PUCCH-SR again, or fall back to CBRA process.

The above described BFR procedures for PCell and SCell would not be suited for a multi-TRP system, in which multiple TRPs could be geographically non-co-located, and one or more BFLs between the UE and the TRP(s) could fail. In this disclosure, a TRP can represent a collection of measurement antenna ports, measurement RS resources and/or control resource sets (CORESETs). For example, a TRP could be associated with one or more of: a plurality of CSI-RS resources, a plurality of CRIs (CSI-RS resource indices/indicators), a measurement RS resource set, for example, a CSI-RS resource set along with its indicator, a plurality of CORESETs associated with a CORESETPoolIndex, and a plurality of CORESETs associated with a TRP-specific index/indicator/identity. Furthermore, different TRPs could broadcast/be associated with different physical cell identities (PCIs) and one or more TRPs in the system could broadcast/be associated with different PCIs from that of serving cell/TRP.

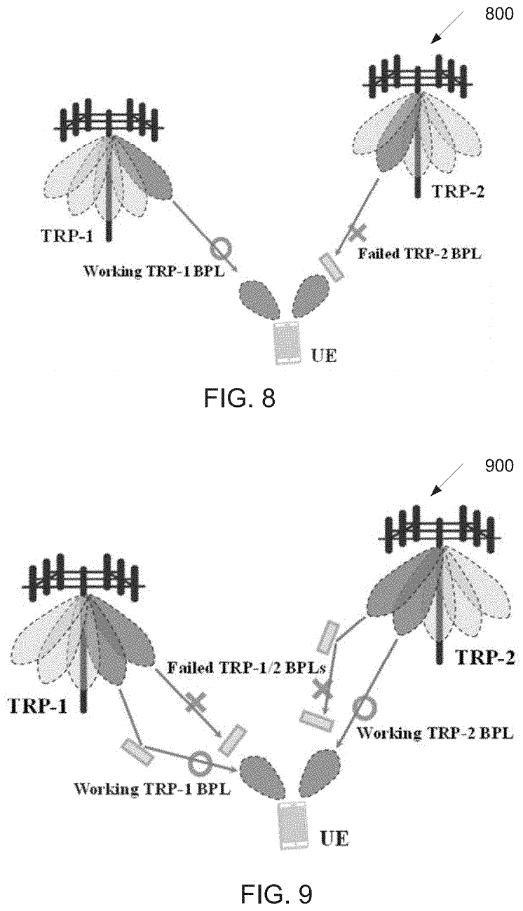

FIG. 8 illustrates an example of a beam failure in a multi-TRP system 800 according to embodiments of the present disclosure. An embodiment of the beam failure in a multi-TRP system 800 shown in FIG. 8 is for illustration only.

In FIG. 8, a conceptual example of BPL failure in a multi-TRP system is presented. As can be seen from FIG. 8, two TRPs, TRP-1 and TRP-2, are simultaneously/jointly performing DL transmissions to the UE in either a coherent or a non-coherent fashion. As the two TRPs are not physically co-located, their channel conditions between the UE could be largely different from each other. For instance, the BPL between one coordinating TRP (TRP-2 in FIG. 8) and the UE could fail due to blockage, while the BPL between the other coordinating TRP (TRP-1 in FIG. 8) and the UE could still work.

According to the BFR procedures defined in the 3GPP Rel. 15 and Rel. 16, however, the UE would trigger or initiate the BFR only when the received signal qualities of all the configured BFD RSs fall below a threshold for a certain period of time. Hence, there is a need to customize the BFR procedures for the multi-TRP system (TRP-specific BFR and/or partial BFR). For instance, the UE could initiate or trigger the BFR when the received signal qualities of the BFD RSs for at least one TRP fall below the threshold for a given period of time.

FIG. 9 illustrates another example of a beam failure in a multi-TRP system 900 according to embodiments of the present disclosure. An embodiment of the beam failure in a multi-TRP system 900 shown in FIG. 9 is for illustration only.

In FIG. 9, another example of beam failure in a multi-TRP system is presented. Different from the example shown in FIG. 8, the failed BFD RSs, and therefore, the corresponding BPLs are across the two TRPs in the multi-TRP system, and there are still working BPLs between the two TRPs and the UE. Based on the Rel. 15 and Rel. 16 BFR firing/triggering conditions, the UE would not trigger or initiate a BFR for the example shown in FIG. 9 because not all the BFD RSs are failed. To avoid a potential RLF, the UE could still initiate or trigger the BFR even though only a subset of the BFD RSs fail, resulting in the so-called partial BFR design. Detailed partial BFR mechanisms and signaling support need to be specified for a multi-TRP system, which are not characterized in the prior arts.

In the present disclosure, several new BFR strategies are developed for both multi-TRP and single-TRP systems, targeting for facilitating the overall BFR process meanwhile minimizing the chance of a full radio link failure. Specifically, several key parameters, configurations and procedure components in the baseline 3GPP Rel. 15 and/or Rel. 16 BFR procedures are customized to better enable the TRP-specific and/or partial BFR operation. In the present disclosure, the partial BFR for multi-TRP could be referred to as per TRP BFR or non-per TRP partial BFR. The optimized BFR related parameters, configurations and procedure components include BFD RSs, NBI RSs, BFRQ, BFRR, inter-operation between partial BFR and full cell-specific BFR and etc.

For example, in one of the embodiments in this disclosure, the two coordinating TRPs in a multi-TRP system are first categorized as a primary TRP and a secondary TRP depending on their traffic types. If the UE has detected beam failure for the secondary TRP, the UE could just or only send the BFRQ for the secondary TRP to the gNB through either the primary TRP or the secondary TRP, and skip the remaining BFR procedures such as identifying a potential new beam for the secondary TRP, monitoring BFRR for the secondary TRP and etc. After sending the BFRQ, the UE could fall back to the single-TRP operation, i.e., communicate only with the primary TRP, meanwhile wait for further configuration from the gNB regarding the secondary TRP. Such an “incomplete” or reduced BFR procedure is not specified in the current 3GPP NR systems.

In the present disclosure, various TRP-specific or per TRP BFR strategies are designed for both multi-PDCCH/DCI and single-PDCCH/DCI based multi-TRP systems. For the multi-PDCCH based framework, the UE would receive different DCIs/different CORESETs associated with different values of higher layer signaling index CORESETPoolIndex transmitted from different coordinating TRPs in the multi-TRP system. For the single-PDCCH/DCI based framework, the UE would receive different copies/replicas of the same DCI transmitted from different coordinating TRPs in the multi-TRP system. For both multi-PDCCH/DCI and single-PDCCH/DCI based frameworks, a set of TRP-specific BFR parameters and configurations are defined. A reduced BFR procedure is also developed aiming at reducing the overall BFR process latency and signaling overhead.

In one embodiment, various TRP-specific/per TRP BFD RS configuration methods for multi-TRP BFR are provided.

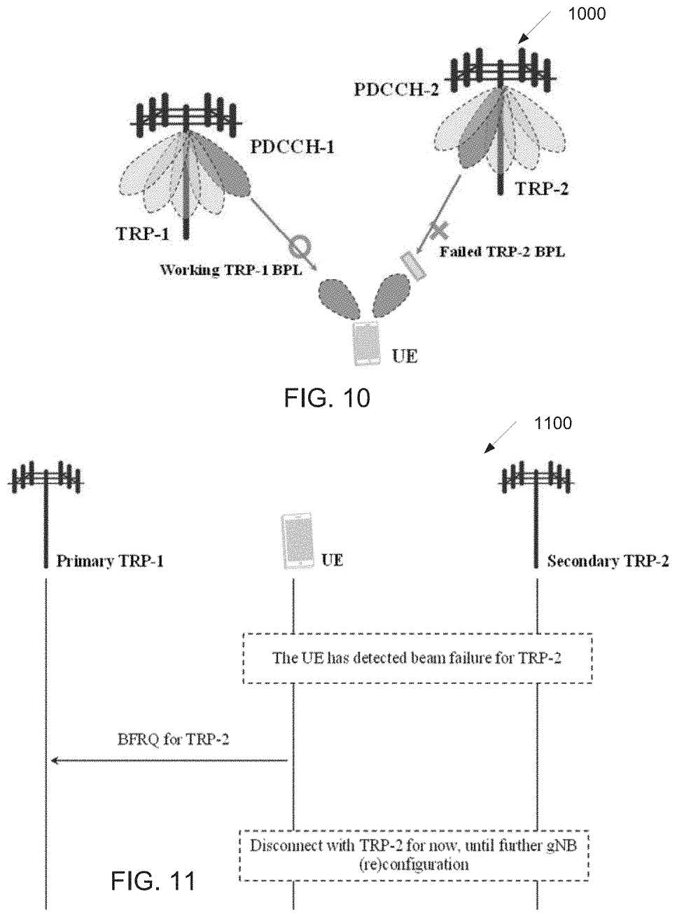

FIG. 10 illustrates an example of a beam failure in a multi-PDCCH/DCI based multi-TRP system 1000 according to embodiments of the present disclosure. An embodiment of the beam failure in a multi-PDCCH/DCI based multi-TRP system 1000 shown in FIG. 10 is for illustration only.

In FIG. 10, an illustrative example of a multi-PDCCH/DCI based multi-TRP system is presented. It is evident from FIG. 10 that the UE could receive different PDCCHs/DCIs, i.e., PDCCH-1 and PDCCH-2, associated with different values of CORESETPoolIndex from different coordinating TRPs, i.e., TRP-1 and TRP-2. Further, as shown in FIG. 10, the BPL(s) between the UE and TRP-2 is blocked, while the BPL(s) between the UE and TRP-1 still works.

If the UE follows the 3GPP Rel. 15/16 BFR procedures, the UE is unable to quickly recover the failed BPL(s) with TRP-2, which could result in a potential RLF and/or other performance degradations. This is because in the 3GPP Rel. 15/16, the UE could only initiate/trigger a BFR process if the UE fails to detect all the BFD RSs transmitted from both TRP-1 and TRP-2 during a certain period of time (also referred to as cell-specific BFR), implying that all the BPLs between the UE and the two coordinating TRPs have failed. Hence, there is a need to design and optimize the BFR procedures on a per TRP basis. To start with, a set of TRP-specific BFR parameters such as TRP-specific BFD RSs, NBI RSs, BFD thresholds/timers, and etc. are first defined, and their corresponding configuration methods such as explicit versus implicit, new MAC entities and etc. are also specified.

In one embodiment, various explicit TRP-specific/per TRP BFD RS configuration methods are provided.

For the single-TRP operation, the UE could be explicitly configured by the network (e.g., via higher layer RRC signaling) a single list/set of BFD RSs, e.g., via higher layer parameter failureDetectionResources or beamFailureDetectionResourceList. In the present disclosure, the list/set of the BFD RSs can also be referred to as a BFD RS beam set denoted by q0. The BFD RSs in the BFD RS beam set q0 could be periodic 1-port CSI-RS resource configuration indexes or SSB indexes or other types of SSBs/CSI-RSs. The UE would keep monitoring the radio link qualities of the BFD RSs in q0, and as long as their radio link qualities, e.g., in terms of their corresponding/associated beam metrics such as measured L1-RSPRs, drop below a given threshold for a certain period of time, the UE could declare beam failure for the TRP.

For the multi-TRP system, the UE could also be explicitly configured by the network (e.g., via higher layer RRC signaling) S_q0 (1≤S_q0≤maxS_q0) BFD RS beam sets each containing N_q0 (1≤N_q0≤maxN_q0) BFD RSs, where maxS_q0 is the maximum number of BFD RS beam sets (e.g., maxS_q0=2 per BWP), which could be indicated/configured by the network to the UE via RRC or/and MAC CE or/and DCI based signaling or autonomously determined by the UE and reported to the network as a UE capability/feature signaling or both, and maxN_q0 is the maximum number of BFD RSs per BFD RS beam set (e.g., maxN_q0=2), which could be indicated/configured by the network to the UE via RRC or/and MAC CE or/and DCI based signaling or autonomously determined by the UE and reported to the network as a UE capability/feature signaling or both; the quantity N_q0 could be the same or different across the S_q0 BFD RS beam sets; each BFD RS could correspond to a 1-port CSI-RS resource configuration index or a SSB index or other types of SSB/CSI-RS.

The S_q0 BFD RS beam sets and/or the N_q0 BFD RSs in each BFD RS beam set could be associated with different coordinating TRPs in the multi-TRP system. In one example, the UE could be configured by the network a single BFD RS beam set (S_q0=1) containing two BFD RSs (N_q0=2), denoted by BFD-RS-1 and BFD-RS-2 in q0, via higher layer RRC signaling. The first BFD RS in the BFD RS beam set, i.e., BFD-RS-1, could be associated with a first TRP associated with a lower PCI value/CORESETPoolIndex value/etc., e.g., TRP-1 in FIG. 10, and the second BFD RS in the list/BFD RS beam set, i.e., BFD-RS-2, could be associated with a second TRP associated with a higher PCI value/CORESETPoolIndex value/etc., e.g., TRP-2 in FIG. 10.

Alternatively, the UE could be explicitly indicated by the network the association rule/mapping relationship between the configured BFD RS(s)/BFD RS beam set(s) and the coordinating TRPs via RRC or/and MAC CE or/and DCI based signaling. Optionally, the UE could autonomously determine the association rule/mapping relationship between the configured BFD RS(s)/BFD RS beam set(s) and the coordinating TRPs, and indicate to the network their determined association rule/mapping relationship. Furthermore, the mapping between the S_q0 BFD RS beam set(s) and/or the N_q0 BFD RS(s) in a given BFD RS beam set q0 and the TRPs could be fixed/deterministic per RRC configuration. Various means of explicitly configuring the BFD RSs/BFD RS beam sets and associating them with the TRPs or TRP-specific index/ID values in the multi-TRP system are presented as follows.

The UE could be first configured by the network (e.g., via higher layer RRC signaling) a list/set/pool of N_trp TRP-specific index/ID values. In the present disclosure, a TRP-specific index/ID could correspond to a PCI, a CORESETPoolIndex, a CORESET index/ID, a CORESET group index/ID, a TRP-specific RS ID, a TRP-specific index/ID or a TRP-specific higher layer signaling index. The UE could also receive from the network one or more MAC CE activation commands/bitmaps to activate/update one or more TRP-specific index/ID values in the higher layer configured list/set/pool of TRP-specific index/ID values.

The UE could be configured/indicated by the network (e.g., via RRC or/and MAC CE or/and DCI based signaling) a single BFD RS beam set (S_q0=1) containing at least two (N_q0≥2) BFD RSs. For instance, the UE could be configured by the network the single BFD RS beam set (S_q0=1) via a higher layer parameter beamFailureDetectionResourceList and the at least two BFD RSs (N_q0≥2) configured therein corresponding to periodic CSI-RS resource configuration indexes and/or SSB indexes via a higher layer parameter failureDetectionResources. One or more of the N_q0 BFD RSs in the configured BFD RS beam set could be associated with/linked to a TRP or a TRP-specific index/ID value such as PCI, CORESETPoolIndex or CORESET index/ID in the higher layer configured list/set/pool of TRP-specific index/ID values in the multi-TRP system, wherein the UE could be configured two CORESETPoolIndex values or is not provided CORESETPoolIndex value for a first CORESET but is provided CORESETPoolIndex value of 1 for a second CORESET.

In one example of Option-0.A, the first BFD RS or the BFD RS with the lowest resource index/ID in the configured BFD RS beam set could correspond/link to the lowest (or the highest) TRP-specific index/ID value such as PCI value or CORESETPoolIndex value in the higher layer configured list/set/pool of TRP-specific index/ID values, the second BFD RS or the BFD RS with the second lowest resource index/ID in the configured BFD RS beam set could correspond/link to the second lowest (or the second highest) TRP-specific index/ID value such as PCI value or CORESETPoolIndex value in the higher layer configured list/set/pool of TRP-specific index/ID values, and so on, and the last BFD RS or the BFD RS with the highest resource index/ID in the configured BFD RS beam set could correspond/link to the highest (or the lowest) TRP-specific index/ID value such as PCI value or CORESETPoolIndex value in the higher layer configured list/set/pool of TRP-specific index/ID values. That is, the k-th BFD RS or BFD RS k or the BFD RS with the k-th lowest resource index/ID in the configured BFD RS beam set could correspond/link to the k-th lowest (or highest) TRP-specific index/ID value such as PCI value, CORESET index/ID value, CORESET group index/ID value or CORESETPoolIndex value in the higher layer configured list/set/pool of TRP-specific index/ID values, where k=0, 1, . . . , N_q0−1.

In another one example, for N_q0=2, the first BFD RS in the configured BFD RS beam set could be a target RS of a TCI state associated with CORESETPoolIndex=0, and the second BFD RS configured in the BFD RS beam set could be a target RS of a TCI state associated with CORESETPoolIndex=1. In yet another example, the k-th BFD RS or BFD RS k or the BFD RS with the k-th lowest (or highest) resource index/ID in the configured BFD RS beam set could link to/correspond to/be associated with CORESETPoolIndex value k, where k=0, 1.

In yet another example, the first BFD RS or the BFD RS with the lowest resource index/ID in the configured BFD RS beam set could correspond/link to the first entry in the higher layer configured list/set/pool of TRP-specific index/ID values, the second BFD RS or the BFD RS with the second lowest resource index/ID in the configured BFD RS beam set could correspond/link to the second entry in the higher layer configured list/set/pool of TRP-specific index/ID values, and so on, and the last BFD RS or the BFD RS with the highest resource index/ID in the configured BFD RS beam set could correspond/link to the last entry in the higher layer configured list/set/pool of TRP-specific index/ID values. That is, the k-th BFD RS or BFD RS k or the BFD RS with the k-th lowest resource index/ID in the configured BFD RS beam set could correspond/link to the k-th entry in the higher layer configured list/set/pool of TRP-specific index/ID values, where k=0, 1, . . . , N_q0−1.

As aforementioned, in the present disclosure, a TRP-specific index/ID could correspond to a PCI, a CORESETPoolIndex, a CORESET index/ID, a CORESET group index/ID, a TRP-specific RS ID, a TRP-specific index/ID or a TRP-specific higher layer signaling index. Other association rules/mapping relationships between the N_q0 BFD RSs in the configured BFD RS beam set and the coordinating TRPs or the TRP-specific index/ID values in the multi-TRP system are also possible.

In one example of Option-0.B, the UE could be explicitly indicated by the network the association rule(s)/mapping relationship(s) between the N_q0 BFD RSs in the configured BFD RS beam set and the coordinating TRPs or the TRP-specific index/ID values in the multi-TRP system. For instance, the UE could be indicated by the network that the i-th BFD RS or BFD RS i or the BFD RS with the i-th lowest index/ID value in the configured BFD RS beam set (i∈{0, 1, . . . , N_q0−1}) is associated with/linked to the j-th lowest (or highest) TRP-specific index/ID value such as PCI or CORESETPoolIndex or the j-th entry in the higher layer configured list/set/pool of TRP-specific index/ID values (j∈{0, 1, . . . , N_trp−1}), where i could be different from j; further, this indication could be via higher layer (RRC) or/and MAC CE or/and DCI based signaling; this indication could be via a separate (dedicated) parameter or joint with another parameter. Other methods to indicate/configure the explicit association rule(s)/mapping relationship(s) between the N_q0 BFD RSs in the configured BFD RS beam set and the coordinating TRPs or the higher layer configured TRP-specific index/ID values in the multi-TRP system are also possible.

In one example of Option-0.C, the UE could only be indicated by the network that the N_q0 BFD RSs configured in the BFD RS beam set are for different coordinating TRPs or different TRP-specific index/ID values in the multi-TRP system, and are used for detecting and/or triggering the TRP-specific/partial BFR; the UE could also be indicated by the network which BFD RS(s) is associated with the same TRP or the same TRP-specific index/ID value such as PCI or CORESETPoolIndex; this indication could be via higher layer (RRC) or/and MAC CE or/and DCI based signaling; this indication could be via a separate (dedicated) parameter or joint with another parameter.

In one example of Option-0.D, the UE could be indicated by the network one or more TRP-specific index/ID values such as PCIs, CORESET index/ID values, CORESET group index/ID values or CORESETPoolIndex values along with the configuration of the BFD RSs/BFD RS beam set; this indication could be via higher layer (RRC) or/and MAC CE or/and DCI based signaling; this indication could be via a separate (dedicated) parameter or joint with another parameter. For instance, a list/set of N_q0 TRP-specific index/ID values could be indicated in the parameter configuring the BFD RS beam set, e.g., in the higher layer parameter beamFailureDetectionResourceList. The association/mapping between the N_q0 BFD RSs configured in the BFD RS beam set and the N_q0 TRP-specific index/ID values indicated in the parameter configuring the BFD RS beam set could follow those specified in Option-0.A, Option-0.B or Option-0.C. For instance, the k-th BFD RS or BFD RS k or the BFD RS with the k-th lowest resource index/ID in the configured BFD RS beam set could correspond/link to the k-th lowest (or highest) TRP-specific index/ID value such as PCI value or CORESETPoolIndex value or the k-th entry in the list/set of N_q0 TRP-specific index/ID values indicated in the parameter configuring the BFD RS beam set, where k=0, 1, . . . , N_q0−1.

The UE could be configured/indicated by the network (e.g., via RRC or/and MAC CE or/and DCI based signaling) at least two BFD RS beam sets (S_q0≥2) each containing at least one (N_q0≥1) BFD RS. For instance, the UE could be configured by the network two BFD RS beam sets (S_q0=2) q0-0 and q0-1, e.g., via higher layer parameters beamFailureDetectionResourceList0 and beamFailureDetectionResourceList1, respectively. Each BFD RS beam set, i.e., q0-0 or q0-1 for S_q0=2, could contain/comprise/include one or more BFD RSs (N_q0≥1) corresponding to one or more periodic CSI-RS resource configuration indexes and/or SSB indexes configured via a higher layer parameter failureDetectionResources.

One or more of the configured S_q0 BFD RS beam sets could be associated with/linked to a TRP or a TRP-specific index/ID value such as PCI or CORESETPoolIndex in the higher layer configured list/set/pool of TRP-specific index/ID values in the multi-TRP system, wherein the UE could be configured two CORESETPoolIndex values or is not provided CORESETPoolIndex value for a first CORESET but is provided CORESETPoolIndex value of 1 for a second CORESET.

In one example of Option-1.A, the first BFD RS beam set or the BFD RS beam set with the lowest set ID/index could correspond/link to the lowest (or the highest) TRP-specific index/ID value such as PCI value or CORESETPoolIndex value in the higher layer configured list/set/pool of TRP-specific index/ID values, the second BFD RS beam set or the BFD RS beam set with the second lowest set ID/index could correspond/link to the second lowest (or the second highest) TRP-specific index/ID value such as PCI value or CORESETPoolIndex value in the higher layer configured list/set/pool of TRP-specific index/ID values, and so on, and the last BFD RS beam set or the BFD RS beam set with the highest set ID/index could correspond/link to the highest (or the lowest) TRP-specific index/ID value such as PCI value or CORESETPoolIndex value in the higher layer configured list/set/pool of TRP-specific index/ID values. That is, the k-th BFD RS beam set or BFD RS beam set k or the BFD RS beam set with the k-th lowest set index/ID could correspond/link to the k-th lowest (or highest) TRP-specific index/ID value such as PCI value, CORESET index/ID value, CORESET group index/ID value or CORESETPoolIndex value in the higher layer configured list/set/pool of TRP-specific index/ID values, where k=0, 1, . . . , S_q0−1. For instance, the k-th BFD RS beam set or BFD RS beam set k or the BFD RS beam set with the k-th lowest set index/ID could correspond/link to CORESETPoolIndex value k, where k=0, 1.

In another example, for S_q0=2, the BFD RS(s) in the first BFD RS beam set (q0-0) could be the target RS(s) of the TCI state(s) associated with CORESETPoolIndex=0, and the BFD RS(s) in the second BFD RS beam set (denoted by q0-1) could be the target RS(s) of the TCI state(s) associated with CORESETPoolIndex=1. In yet another example, the first BFD RS beam set or the BFD RS beam set with the lowest set index/ID could correspond/link to the first entry in the higher layer configured list/set/pool of TRP-specific index/ID values, the second BFD RS beam set or the BFD RS beam set with the second lowest set index/ID could correspond/link to the second entry in the higher layer configured list/set/pool of TRP-specific index/ID values, and so on, and the last BFD RS beam set or the BFD RS beam set with the highest set index/ID could correspond/link to the last entry in the higher layer configured list/set/pool of TRP-specific index/ID values. That is, the k-th BFD RS beam set or BFD RS beam set k or the BFD RS beam set with the k-th lowest set index/ID could correspond/link to the k-th entry in the higher layer configured list/set/pool of TRP-specific index/ID values, where k=0, 1, . . . , S_q0−1.

As aforementioned, in the present disclosure, a TRP-specific index/ID could correspond to a PCI, a CORESETPoolIndex, a CORESET index/ID, a CORESET group index/ID, a TRP-specific RS ID, a TRP-specific index/ID or a TRP-specific higher layer signaling index. Other association rules/mapping relationships between the S_q0 BFD RS beam sets (and therefore, the BFD RSs configured therein) and the coordinating TRPs or the TRP-specific index/ID values in the multi-TRP system are also possible.

In one example of Option-1.B, the UE could be explicitly configured/indicated by the network the association rule(s)/mapping relationship(s) between the S_q0 BFD RS beam sets and the coordinating TRPs or the TRP-specific index/ID values in the multi-TRP system. For instance, the UE could be indicated by the network that the i-th BFD RS beam set or BFD RS beam set i or the BFD RS beam set with the i-th lowest set index/ID value (i∈{0, 1, . . . , S_q0−1}) is associated with/linked to the j-th lowest (or highest) TRP-specific index/ID value such as PCI or CORESETPoolIndex or the j-th entry in the higher layer configured list/set/pool of TRP-specific index/ID values (j∈{0, 1, . . . , N_trp−1}), where i could be different from j; further, this indication could be via higher layer (RRC) or/and MAC CE or/and DCI based signaling; this indication could be via a separate (dedicated) parameter or joint with another parameter. Other methods to indicate/configure the explicit association rule(s)/mapping relationship(s) between the S_q0 BFD RS beam sets and the coordinating TRPs or the higher layer configured TRP-specific index/ID values in the multi-TRP system are also possible.

In one example of Option-1.C, the UE could only be indicated by the network that the S_q0 BFD RS beam sets (and therefore, the BFD RSs configured therein) are for different coordinating TRPs or different TRP-specific index/ID values in the multi-TRP system, and are used for detecting and/or triggering the TRP-specific/partial BFR; the UE could also be indicated by the network which BFD RS beam set(s) is associated with the same TRP or the same TRP-specific index/ID value; this indication could be via higher layer (RRC) or/and MAC CE or/and DCI based signaling; this indication could be via a separate (dedicated) parameter or joint with another parameter.

In one example of Option-1.D, the UE could be indicated by the network one or more TRP-specific index/ID values such as PCIs, CORESET index/ID values, CORESET group index/ID values or CORESETPoolIndex values along with the configuration of the BFD RS beam sets; this indication could be via higher layer (RRC) or/and MAC CE or/and DCI based signaling; this indication could be via a separate (dedicated) parameter or joint with another parameter. For instance, a TRP-specific index/ID value could be indicated in the parameter configuring BFD RS beam set. For S_q0=2, a first TRP-specific index/ID value such as PCI, CORESETPoolIndex, CORESET group index/ID or CORESET index/ID could be indicated in the parameter configuring q0-0, e.g., in the higher layer parameter beamFailureDetectionResourceList0, and a second TRP-specific index/ID value such as PCI, CORESET index/ID, CORESET group index/ID or CORESETPoolIndex could be indicated in the parameter configuring q0-1, e.g., in the higher layer parameter beamFailureDetectionResourceList1. A BFD RS beam set is therefore associated with/linked to the TRP-specific index/ID value indicated in the parameter configuring the BFD RS beam set. For instance, for S_q0=2, CORESETPoolIndex value 0 could be indicated in the parameter configuring q0-0, e.g., in the higher layer parameter beamFailureDetectionResourceList0, and CORESETPoolIndex value 1 could be indicated in the parameter configuring q0-1, e.g., in the higher layer parameter beamFailureDetectionResourceList1. A BFD RS beam set is therefore associated with/linked to the CORESETPoolIndex value indicated in the parameter configuring the BFD RS beam set.

In one example of Option-2, the UE could be configured/indicated by the network two lists/BFD RS beam sets (S_q0=2), denoted by q0-0 and q0-1. The first BFD RS beam set q0-0 could contain at least one BFD RS and is used by the UE for detecting and/or triggering the full cell-specific BFR. The second BFD RS beam set q0-1 could contain at least two BFD RSs and is used by the UE for detecting and/or triggering the TRP-specific/partial BFR in a multi-TRP system. The configuration of the BFD RSs in the second BFD RS beam set q0-1, and therefore, the association between the BFD RSs in the second BFD RS beam set q0-1 and the coordinating TRPs in the multi-TRP system or the TRP-specific index/ID values, could follow those specified in Option-0.A, Option-0.B, Option-0.0 or Option-0.D.

In another example, the UE could be configured/indicated by the network more than two lists/BFD RS beam sets (S_q0>2). The first BFD RS beam set (e.g., with the lowest set ID/index) could contain at least one BFD RS and is used by the UE for detecting and/or triggering the full cell-specific BFR. The remaining (S_q0−1) BFD RS beam sets each containing at least one BFD RS could be used by the UE for detecting and/or triggering the TRP-specific/partial BFR in a multi-TRP system. The configuration of the remaining (S_q0−1) BFD RS beam sets, and therefore, the association between the remaining (S_q0−1) BFD RS beam sets and the coordinating TRPs or the TRP-specific index/ID values in the multi-TRP system, could follow those specified in Option-1.A, Option-1.B, Option-1.0 or Option-1.D.

The UE could be first higher layer configured by the network (e.g., via higher layer RRC signaling) a set/list/pool of Ntot_q0 BFD RSs (and therefore, the corresponding Ntot_q0 SSB indexes or periodic 1-port CSI-RS resource configuration indexes). The UE could receive from the network one or more MAC CE activation/subselection commands/bitmaps to update one or more BFD RSs (or equivalently, one or more SSB indexes or one or more periodic 1-port CSI-RS resource configuration indexes) for one or more BFD RS beam sets.

For example, the UE could receive from the network a MAC CE activation/subselection command/bitmap to update one or more BFD RSs for BFD RS beam set k, where k∈{0, 1, . . . , S_q0−1}. The MAC CE activation/subselection command or bitmap could have Ntot_q0 entries/bit positions with each entry/bit position corresponding to a BFD RS in the set/list/pool of Ntot_q0 BFD RSs. If an entry/bit position in the MAC CE activation/subselection command or bitmap is set to ‘1’, the corresponding BFD RS (and therefore, the corresponding SSB index or periodic 1-port CSI-RS resource configuration index) in the set/list/pool of Ntot_q0 BFD RSs could be included/incorporated in the BFD RS beam set k.

The MAC CE activation/subselection command/bitmap could include/contain/incorporate/comprise/indicate the set index/ID of the BFD RS beam set k, a TRP-specific index/ID value such as PCI, CORESETPoolIndex, CORESET ID/index, CORESET group index/ID, and etc. associated with the BFD RS beam set k. Alternatively, the MAC CE activation/subselection command/bitmap could include/contain/incorporate/comprise/indicate a one-bit flag/indicator for S_q0=2 BFD RS beam sets. For example, if the one-bit flag/indicator is set to ‘1’/‘on’/‘enabled’, the MAC CE activation/subselection command/bitmap is for the BFD RS beam set q0-0; otherwise, e.g., the one-bit flag/indicator is set to ‘O’/‘off’/‘disabled’, the MAC CE activation/subselection command/bitmap is for the BFD RS beam set q0-1.

Any combinations of at least two of the above described design options (Option-0.A, Option-0.B, Option-0.C, Option-0.D, Option-1.A, Option-1.B, Option-1.C, Option-1.D and Option-2) or any other variations of the above described design options (Option-0.A, Option-0.B, Option-0.C, Option-0.D, Option-1.A, Option-1.B, Option-1.C, Option-1.D and Option-2) can be used for full cell-specific and/or TRP-specific beam failure(s) detection.

For example, the UE could be configured/indicated by the network (via RRC or/and MAC CE or/and DCI based signaling) a single list/BFD RS beam set (S_q0=1) containing at least three (N_q0≥3) BFD RSs; the BFD RSs in the configured list/BFD RS beam set could be used for both cell-specific and TRP-specific beam failure(s) detection. For another example, the UE could be configured/indicated by the network (via RRC or/and MAC CE or/and DCI based signaling) at least three lists/BFD RS beam sets (S_q0≥3) each containing at least one (N_q0=1) BFD RS; the configured BFD RS beam sets could be used for both cell-specific and TRP-specific beam failure(s) detection. For Option-1.A, Option-1.B, Option-1.0 and Option-1.D, the BFD RSs in the S_q0 lists of BFD RSs/BFD RS beam sets could be mutually exclusive. For Option-2, the BFD RS(s) in the first list of BFD RS(s)/BFD RS beam set used for detecting/triggering the full cell-specific BFR could be a superset of those configured in the remaining (S_q0−1) list(s) of BFD RS(s)/BFD RS beam set(s) used for detecting/triggering the TRP-specific/partial BFR in the multi-TRP system.

The UE could start to monitor the (TRP-specific) BFD RSs explicitly configured following Option-0 or/and Option-1 or/and Option-2 for detecting/triggering the TRP-specific/partial BFR in a multi-TRP system as soon as they are configured by the network, e.g., via higher layer (RRC) or/and MAC CE or/and DCI based signaling. Optionally, the MAC CE activation/subselection command/bitmap could include/contain/incorporate/comprise/indicate the set index/ID of the NBI RS beam set associated with the BFD RS beam set k. Alternatively, the UE could start to monitor the (TRP-specific) BFD RSs explicitly configured following Option-0 or/and Option-1 or/and Option-2 for detecting/triggering the TRP-specific/partial BFR in a multi-TRP system as soon as the multi-TRP operation is activated by the network, e.g., via higher layer (RRC) or/and MAC CE or/and DCI based signaling.

Furthermore, the UE could be indicated/configured by the network to stop monitoring the (TRP-specific) BFD RSs explicitly configured by the network following Option-0 or/and Option-1 or/and Option-2 for detecting/triggering the TRP-specific/partial BFR in a multi-TRP system. If the multi-TRP operation is deactivated by the network, e.g., via higher layer (RRC) or/and MAC CE or/and DCI based signaling, the UE could also stop monitoring the (TRP-specific) BFD RSs explicitly configured by the network following Option-0 or/and Option-1 or/and Option-2 for detecting/triggering the TRP-specific/partial BFR in a multi-TRP system.

In one embodiment, various implicit TRP-specific/per TRP BFD RS configuration methods are provided.

If the UE is not configured by the network any BFD RS(s) via the above discussed explicit BFD RS configuration method(s)/option(s), the UE could determine a periodic 1-port CSI-RS resource configuration index or SSB index indicated/configured as a QCL-TypeD (i.e., spatial quasi-co-location) source RS in an active TCI state for respective PDCCH reception as a BFD RS in a BFD RS beam set, e.g., q0. This is also known as implicit BFD RS configuration. The UE could measure the radio link qualities of the BFD RSs in the BFD RS beam set q0, and if the radio link qualities of the BFD RSs in the BFD RS beam set q0 fall below a configured threshold for a given period of time, the hypothetical BLERs of the corresponding PDCCHs could be beyond an out-of-sync BLER threshold. In this case, the UE could declare a beam failure.

For the multi-TRP operation, if the UE is not configured by the network any BFD RS(s) via the above discussed explicit BFD RS configuration method(s)/option(s), the UE could determine G_q0 (1≤G_q0≤maxG_q0) BFD RS beam sets (q0-0 and q0-1 for G_q0=2) each containing M_q0 (1≤M_q0≤maxM_q0) BFD RSs determined as periodic 1-port CSI-RS resource configuration indexes or SSB indexes with same values as the QCL-TypeD source RS indexes indicated in active TCI states for PDCCH reception in respective CORESETs that the UE uses for monitoring the PDCCH(s), where maxG_q0 is the maximum number of BFD RS beam sets (e.g., maxG_q0=2 per BWP), which could be indicated/configured by the network to the UE via RRC or/and MAC CE or/and DCI based signaling or autonomously determined by the UE and reported to the network as a UE feature/capability signaling or both, and maxM_q0 is the maximum number of BFD RSs per BFD RS beam set (e.g., maxM_q0=3), which could be indicated/configured by the network to the UE via RRC or/and MAC CE or/and DCI based signaling or autonomously determined by the UE and reported to the network as a UE feature/capability signaling or both; M_q0 could be the same or different across the G_q0 BFD RS beam sets.

The G_q0 BFD RS beam sets and/or the M_q0 BFD RSs configured in each BFD RS beam set could be associated with/linked to different CORESETs configured with different higher layer signaling indices (such as the higher layer parameter CORESETPoolIndex) or associated with/linked to different coordinating TRPs or different TRP-specific index/ID values such as PCIs in the multi-TRP system. In one example, the UE could use/determine a single BFD RS beam set (G_q0=1) q0 containing two BFD RSs (M_q0=2), denoted by BFD-RS-A and BFD-RS-B. The first BFD RS in the BFD RS beam set, i.e., BFD-RS-A, could be a periodic 1-port CSI-RS resource configuration index or SSB index indicated/configured as the QCL-typeD source RS in an active TCI state for PDCCH reception in a CORESET configured/associated with ‘CORESETPoolIndex=0’, and the second BFD RS in the list/BFD RS beam set, i.e., BFD-RS-B, could be a periodic 1-port CSI-RS resource configuration index or SSB index configured/indicated as a QCL-typeD source RS in an active TCI state for PDCCH reception in a CORESET configured/associated with ‘CORESETPoolIndex=1’.

Alternatively, the UE could be explicitly indicated by the network (e.g., via RRC or/and MAC CE or/and DCI based signaling) the association rule/mapping relationship between the determined BFD RS beam set(s)/BFD RS(s) and the CORESETs/coordinating TRPs/TRP-specific index/ID values such as PCIs. Optionally, the UE could autonomously determine the association rule/mapping relationship between the determined BFD RS beam set(s)/BFD RS(s) and the CORESETs/coordinating TRPs/TRP-specific index/ID values such as PCIs, and indicate to the network their determined association rule/mapping relationship. The mapping between the G_q0 BFD RS beam set(s) and/or the M_q0 BFD RS(s) in a BFD RS beam set and the CORESETs/TRPs/TRP-specific index/ID values such as PCIs could be fixed/deterministic per RRC configuration. Various means of UE determining the BFD RSs/BFD RS beam sets and associating them with the CORESETs, TRPs or TRP-specific index/ID values in the multi-TRP system are presented as follows.

The UE could use/determine a single BFD RS beam set (G_q0=1) containing/including at least two (M_q0≥2) BFD RSs, which could respectively correspond to two periodic 1-port CSI-RS resource configuration indexes or SSB indexes indicated/configured as QCL-typeD (i.e., spatial quasi-co-location) source RSs in the active TCI states for PDCCH reception in different CORESETs associated with different values of CORESETPoolIndex the UE uses for monitoring the PDCCHs.

In one example of Option-3.A, the first BFD RS or the BFD RS with the lowest resource index/ID value in the BFD RS beam set could correspond to a 1-port periodic CSI-RS resource configuration index or SSB index indicated/configured as the QCL-typeD source RS in the active TCI state for PDCCH reception in one or more CORESETs configured/associated with the lowest value of CORESETPoolIndex that the UE uses for monitoring the PDCCH(s), the second BFD RS or the BFD RS with the second lowest resource index/ID value in the BFD RS beam set could correspond to a 1-port periodic CSI-RS resource configuration index or SSB index indicated/configured as the QCL-typeD source RS in the active TCI state for PDCCH reception in one or more CORESETs associated with the second lowest value of CORESETPoolIndex that the UE uses for monitoring the PDCCH(s), and so on, and the last BFD RS or the BFD RS with the highest resource index/ID value in the BFD RS beam set could correspond to a 1-port periodic CSI-RS resource configuration index and SSB index indicated/configured as the QCL-typeD source RS in the active TCI state for PDCCH reception in one or more CORESETs associated with the highest value of CORESETPoolIndex that the UE uses for monitoring the PDCCH(s).

Specifically, for M_q0=2, the first BFD RS or the BFD RS with the lower resource index/ID value in the BFD RS beam set could correspond to a 1-port periodic CSI-RS resource configuration index or SSB index indicated/configured as the QCL-typeD source RS in the active TCI state for PDCCH reception in one or more CORESETs configured/associated with ‘CORESETPoolIndex=0’, and the second BFD RS or the BFD RS with the higher resource index/ID value in the BFD RS beam set could correspond to a 1-port periodic CSI-RS resource configuration index or SSB index indicated/configured as the QCL-typeD source RS in the active TCI state for PDCCH reception in one or more CORESETs configured/associated with ‘CORESETPoolIndex=1’. Other association rules/mapping relationships between the M_q0 BFD RSs in the UE determined BFD RS beam set and the CORESETs associated with different values of CORESETPoolIndex are also possible.

The UE could use/determine a single BFD RS beam set (G_q0=1) containing/including at least two (M_q0≥2) BFD RSs, which could respectively correspond to two periodic 1-port CSI-RS resource configuration indexes or SSB indexes indicated/configured as the QCL-typeD (i.e., spatial quasi-co-location) source RSs in the active TCI states for PDCCH reception in different CORESETs configured/associated with different values of a higher layer signaling index, defined as/denoted by CORESETGroupIndex, that the UE uses for monitoring the PDCCHs.

In one example of Option-3.B, the potential values for CORESETGroupIndex could be 0, 1, . . . , Nc−1, where Nc≥2, and the UE could be configured by the network the CORESETGroupIndex value(s) in the higher layer parameter configuring the corresponding CORESET(s)—e.g., in the higher layer parameter PDCCH-Config or ControlResourceSet.

In one example, the first BFD RS or the BFD RS with the lowest resource index/ID value in the BFD RS beam set could correspond to a periodic 1-port CSI-RS resource configuration index or SSB index indicated/configured as the QCL-typeD source RS in the active TCI state for PDCCH reception in one or more CORESETs configured/associated with the lowest value of CORESETGroupIndex, the second BFD RS or the BFD RS with the second lowest resource index/ID value in the BFD RS beam set could correspond to a periodic 1-port CSI-RS resource configuration index or SSB index indicated/configured as the QCL-typeD source RS in the active TCI state for PDCCH reception in one or more CORESETs configured/associated with the second lowest value of CORESETGroupIndex, and so on, and the last BFD RS or the BFD RS with the highest resource index/ID value in the BFD RS beam set could correspond to a periodic 1-port CSI-RS resource configuration index or SSB index indicated/configured as the QCL-typeD source RS in the active TCI state for PDCCH reception in one or more CORESETs configured/associated with the highest value of CORESETGroupIndex.

For instance, for M_q0=2, the first BFD RS or the BFD RS with the lower resource index/ID value in the BFD RS beam set could correspond to a periodic 1-port CSI-RS resource configuration index or SSB index indicated/configured as the QCL-typeD source RS in the active TCI state for PDCCH reception in one or more CORESETs configured/associated with ‘CORESETGroupIndex=0’, and the second BFD RS or the BFD RS with the higher resource index/ID value in the BFD RS beam set could correspond to a periodic 1-port CSI-RS resource configuration index or SSB index indicated/configured as the QCL-typeD source RS in the active TCI state for PDCCH reception in one or more CORESETs configured/associated with ‘CORESETGroupIndex=1’. Other association rules/mapping relationships between the M_q0 BFD RSs in the UE determined BFD RS beam set and the CORESETs associated with different values of CORESETGroupIndex are also possible.

The UE could use/determine at least two BFD RS beam sets (G_q0≥2) each containing/including at least one (M_q0≥1) BFD RS to monitor/detect potential beam failure(s). The BFD RS(s) included in the same BFD RS beam set could correspond to one or more periodic 1-port CSI-RS resource configuration indexes or SSB indexes indicated/configured as the QCL-typeD (i.e., spatial quasi-co-location) source RS(s) in the active TCI state(s) for PDCCH reception in one or more CORESETs configured/associated with the same value of CORESETPoolIndex that the UE uses for monitoring the PDCCH(s), and the BFD RSs included in different BFD RS beam sets could correspond to periodic 1-port CSI-RS resource configuration indexes or SSB indexes indicated/configured as the QCL-typeD (i.e., spatial quasi-co-location) source RSs in the active TCI states for PDCCH reception in different CORESETs associated with different values of CORESETPoolIndex.

In one example of Option-4.A, the BFD RS(s) included in the first BFD RS beam set or the BFD RS beam set with the lowest set ID/index could correspond to one or more periodic 1-port CSI-RS resource configuration indexes or SSB indexes indicated/configured as the QCL-typeD source RS(s) in the active TCI state(s) for PDCCH reception in one or more CORESETs configured/associated with the lowest value of CORESETPoolIndex that the UE uses for monitoring the PDCCH(s), the BFD RS(s) included in the second BFD RS beam set or the BFD RS beam set with the second lowest set ID/index could correspond to one or more periodic 1-port CSI-RS resource configuration indexes or SSB indexes indicated/configured as the QCL-typeD source RS(s) in the active TCI state(s) for PDCCH reception in one or more CORESETs configured/associated with the second lowest value of CORESETPoolIndex that the UE uses for monitoring the PDCCH(s), and so on, and the BFD RS(s) included in the last BFD RS beam set or the BFD RS beam set with the highest set ID/index could correspond to one or more periodic 1-port CSI-RS resource configuration indexes or SSB indexes indicated/configured as the QCL-typeD source RS(s) in the active TCI state(s) for PDCCH reception in one or more CORESETs configured/associated with the highest value of CORESETPoolIndex that the UE uses for monitoring the PDCCH(s).

That is, the BFD RS(s) included in the k-th BFD RS beam set or BFD RS beam set k or the BFD RS beam set with the k-th lowest (or highest) set index/ID could correspond to one or more periodic 1-port CSI-RS resource configuration indexes or SSB indexes indicated/configured as the QCL-TypeD source RS(s) in the active TCI state(s) for PDCCH reception in one or more CORESETs configured/associated with CORESETPoolIndex value k that the UE uses for monitoring the PDCCH, where k=0, 1, . . . , G_q0-1.

Specifically, for G_q0=2, the BFD RS(s) included in the first BFD RS beam set q0-0 or the BFD RS beam set q0-0 with the lower set ID/index could correspond to one or more periodic 1-port CSI-RS resource configuration indexes or SSB indexes indicated/configured as the QCL-typeD source RS(s) in the active TCI state(s) for PDCCH reception in one or more CORESETs configured/associated with ‘CORESETPoolIndex=0’ that the UE uses for monitoring the PDCCH(s), and the BFD RS(s) included in the second BFD RS beam set q0-1 or the BFD RS beam set q0-1 with the higher set ID/index could correspond to one or more periodic 1-port CSI-RS resource configuration indexes or SSB indexes indicated/configured as the QCL-typeD source RS(s) in the active TCI state(s) for PDCCH reception in one or more CORESETs configured/associated with ‘CORESETPoolIndex=1’ that the UE uses for monitoring the PDCCH(s).

That is, BFD RS(s) included in the same BFD RS beam set could correspond to periodic 1-port CSI-RS resource configuration index(es) or SSB index(es) configured/indicated as QCL source RS(s) in active TCI state(s) for PDCCH reception in the CORESET(s) configured with the same CORESETPoolIndex value. Other association rules/mapping relationships between the UE determined G_q0 BFD RS beam sets (and therefore, the BFD RSs included therein) and the CORESETs associated with different values of CORESETPoolIndex are also possible.

In one example of Option-4.B, the UE could use/determine two BFD RS beam sets (G_q0=2), denoted by q0-0 and q0-1. The first BFD RS beam set q0-0 or the BFD RS beam set q0-0 with the lower set index/ID could contain/include at least one BFD RS and is used by the UE for detecting and/or triggering the full cell-specific BFR; the BFD RSs included in q0-0 could correspond to periodic 1-port CSI-RS resource configuration indexes or SSB indexes indicated/configured as the QCL-typeD (i.e., spatial quasi-co-location) source RSs in the active TCI states for PDCCH reception in one or more CORESETs configured/associated with either the same value of CORESETPoolIndex or different values of CORESETPoolIndex that the UE uses for monitoring the PDCCHs. The second BFD RS beam set q0-1 or the BFD RS beam set q0-1 with the higher set index/ID could contain/include at least two BFD RSs and is used by the UE for detecting and/or triggering the TRP-specific/partial BFR in a multi-TRP system. The configuration of the BFD RSs in the BFD RS beam set q0-1, and therefore, the association between the BFD RSs in the BFD RS beam set q0-1 and different CORESETs associated with different values of CORESETPoolIndex, could follow those specified in Option-4.A.

In another example, the UE could identify and use more than two BFD RS beam sets (G_q0>2). The first BFD RS beam set (e.g., with the lowest set ID/index) could contain/include at least one BFD RS and is used by the UE for detecting and/or triggering the full cell-specific BFR; the BFD RSs included in the first BFD RS beam set could correspond to periodic 1-port CSI-RS resource configuration indexes or SSB indexes indicated/configured as the QCL-typeD (i.e., spatial quasi-co-location) source RSs in the active TCI states for PDCCH reception in one or more CORESETs configured/associated with either the same value of CORESETPoolIndex or different values of CORESETPoolIndex that the UE uses for monitoring the PDCCHs. The remaining (G_q0-1) BFD RS beam sets each containing at least one BFD RS could be used by the UE for detecting and/or triggering the TRP-specific/partial BFR in a multi-TRP system. The configuration of the remaining (G_q0-1) BFD RS beam sets, and therefore, the association between the remaining (G_q0-1) BFD RS beam sets and different CORESETs associated with different values of CORESETPoolIndex, could follow those specified in Option-4.A.

The UE could use/determine at least two BFD RS beam sets (G_q0≥2) each containing/including at least one (M_q0≥1) BFD RS to monitor/detect potential beam failure(s). The BFD RS(s) included in the same BFD RS beam set could correspond to one or more periodic 1-port CSI-RS resource configuration indexes or SSB indexes indicated/configured as the QCL-typeD (i.e., spatial quasi-co-location) source RS(s) in the active TCI state(s) for PDCCH reception in one or more CORESETs configured/associated with the same value of a higher layer signaling index, defined as/denoted by CORESETGroupIndex, that the UE uses for monitoring the PDCCH(s), and the BFD RSs included in different BFD RS beam sets could correspond to periodic 1-port CSI-RS resource configuration indexes or SSB indexes indicated/configured as the QCL-typeD (i.e., spatial quasi-co-location) source RSs in the active TCI states for PDCCH reception in different CORESETs associated with different values of CORESETGroupIndex.

In one example of Option-5.A, the potential values for CORESETGroupIndex could be 0, 1, . . . , Nc−1, where Nc≥2, and the UE could be configured by the network the CORESETGroupIndex value(s) in the higher layer parameter configuring the corresponding CORESET(s)—e.g., in the higher layer parameter PDCCH-Config or ControlResourceSet.

In one example, the BFD RS(s) included in the first BFD RS beam set or the BFD RS beam set with the lowest set ID/index could correspond to one or more periodic 1-port CSI-RS resource configuration indexes or SSB indexes indicated/configured as the QCL-typeD source RS(s) in the active TCI state(s) for PDCCH reception in one or more CORESETs configured/associated with the lowest value of CORESETGroupIndex that the UE uses for monitoring the PDCCH(s), the BFD RS(s) included in the second BFD RS beam set or the BFD RS beam set with the second lowest set ID/index could correspond to one or more periodic 1-port CSI-RS resource configuration indexes or SSB indexes indicated/configured as the QCL-typeD source RS(s) in the active TCI state(s) for PDCCH reception in one or more CORESETs configured/associated with the second lowest value of CORESETGroupIndex that the UE uses for monitoring the PDCCH(s), and so on, and the BFD RS(s) included in the last BFD RS beam set or the BFD RS beam set with the highest set ID/index could correspond to one or more periodic 1-port CSI-RS resource configuration indexes or SSB indexes indicated/configured as the QCL-typeD source RS(s) in the active TCI state(s) for PDCCH reception in one or more CORESETs configured/associated with the highest value of CORESETGroupIndex that the UE uses for monitoring the PDCCH(s).

That is, the BFD RS(s) included in the k-th BFD RS beam set or BFD RS beam set k or the BFD RS beam set with the k-th lowest (or highest) set index/ID could correspond to one or more periodic 1-port CSI-RS resource configuration indexes or SSB indexes indicated/configured as the QCL-TypeD source RS(s) in the active TCI state(s) for PDCCH reception in one or more CORESETs configured/associated with CORESETGroupIndex value k that the UE uses for monitoring the PDCCH, where k=0, 1, . . . , G_q0-1.

Specifically, for G_q0=2, the BFD RS(s) included in the first BFD RS beam set q0-0 or the BFD RS beam set q0-0 with the lower set ID/index could correspond to one or more periodic 1-port CSI-RS resource configuration indexes or SSB indexes indicated/configured as the QCL-typeD source RS(s) in the active TCI state(s) for PDCCH reception in one or more CORESETs configured/associated with ‘CORESETGroupIndex=0’ that the UE uses for monitoring the PDCCH(s), and the BFD RS(s) included in the second BFD RS beam set q0-1 or the BFD RS beam set q0-1 with the higher set ID/index could correspond to one or more periodic 1-port CSI-RS resource configuration indexes or SSB indexes indicated/configured as the QCL-typeD source RS(s) in the active TCI state(s) for PDCCH reception in one or more CORESETs configured/associated with ‘CORESETGroupIndex=1’ that the UE uses for monitoring the PDCCH(s).

That is, BFD RS(s) included in the same BFD RS beam set could correspond to periodic 1-port CSI-RS resource configuration index(es) or SSB index(es) configured/indicated as QCL source RS(s) in active TCI state(s) for PDCCH reception in the CORESET(s) configured with the same CORESETGroupIndex value. Other association rules/mapping relationships between the UE determined G_q0 BFD RS beam sets (and therefore, the BFD RSs included therein) and the CORESETs associated with different values of CORESETGroupIndex are also possible.

In one example of Option-5.B, the UE could use/determine two BFD RS beam sets (G_q0=2), denoted by q0-0 and q0-1. The first BFD RS beam set q0-0 or the BFD RS beam set q0-0 with the lower set index/ID could contain/include at least one BFD RS and is used by the UE for detecting and/or triggering the full cell-specific BFR; the BFD RSs included in q0-0 could correspond to periodic 1-port CSI-RS resource configuration indexes or SSB indexes indicated/configured as the QCL-typeD (i.e., spatial quasi-co-location) source RSs in the active TCI states for PDCCH reception in one or more CORESETs configured/associated with either the same value of CORESETGroupIndex or different values of CORESETGroupIndex that the UE uses for monitoring the PDCCHs. The second BFD RS beam set q0-1 or the BFD RS beam set q0-1 with the higher set index/ID could contain/include at least two BFD RSs and is used by the UE for detecting and/or triggering the TRP-specific/partial BFR in a multi-TRP system. The configuration of the BFD RSs in the BFD RS beam set q0-1, and therefore, the association between the BFD RSs in the BFD RS beam set q0-1 and different CORESETs associated with different values of CORESETGroupIndex, could follow those specified in Option-5.A.

In another example, the UE could use more than two BFD RS beam sets (G_q0>2). The first BFD RS beam set (e.g., with the lowest set ID/index) could contain/include at least one BFD RS and is used by the UE for detecting and/or triggering the full cell-specific BFR; the BFD RSs included in the first BFD RS beam set could correspond to periodic 1-port CSI-RS resource configuration indexes or SSB indexes indicated/configured as the QCL-typeD (i.e., spatial quasi-co-location) source RSs in the active TCI states for PDCCH reception in one or more CORESETs configured/associated with either the same value of CORESETGroupIndex or different values of CORESETGroupIndex that the UE uses for monitoring the PDCCHs.

The remaining (G_q0-1) BFD RS beam sets each containing at least one BFD RS could be used by the UE for detecting and/or triggering the TRP-specific/partial BFR in a multi-TRP system. The configuration of the remaining (G_q0-1) BFD RS beam sets, and therefore, the association between the remaining (G_q0-1) BFD RS beam sets and different CORESETs associated with different values of CORESETGroupIndex, could follow those specified in Option-5.A.

There could be various means to associate a CORESET and a CORESETGroupIndex.

In one example, the UE could be higher layer configured (e.g., via higher layer RRC signaling) the association(s)/mapping(s) between one or more CORESETs (e.g., through the corresponding CORESET ID(s)) and the CORESETGroupIndex value(s). For instance, consider N_core≥1 CORESETs with CORESET IDs #1, . . . , #n, #n+1, . . . , #N_core, and two CORESETGroupIndex values 0 and 1. The UE could be higher layer configured by the network that CORESETs with CORESET IDs #1, . . . , #n are configured/associated with ‘CORESETGroupIndex=0’, while CORESETs with CORESET IDs #n+1, . . . , #N_core are configured/associated with ‘CORESETGroupIndex=1’.

In another example, the UE could be first higher layer configured (e.g., via higher layer RRC signaling) by the network the associations/mappings between one or more CORESETs (e.g., through the corresponding CORESET ID(s)) and the CORESETGroupIndex value(s). The UE could also receive from the network a MAC CE command activating one or more CORESETs associated with the CORESETGroupIndex values for the implicit BFD RS configuration discussed, e.g., in Option-3.B, Option-5.A and Option-5.B in the present disclosure.

In yet another example, the UE could be first higher layer configured (e.g., via higher layer RRC signaling) by the network the associations/mappings between one or more CORESETs (e.g., through the corresponding CORESET ID(s)) and the CORESETGroupIndex value(s). The UE could also be configured by the network a bitmap with ‘1’s in the bitmap indicating that the corresponding CORESETs associated with the CORESETGroupIndex values are used for the implicit BFD RS configuration discussed, e.g., in Option-3.B, Option-5.A and Option-5.B in the present disclosure.

In yet another example, the UE could be configured by the network the CORESETGroupIndex value(s) in the higher layer parameter(s) configuring the corresponding CORESET(s), e.g., in the higher layer parameter PDCCH-Config or ControlResourceSet. A snippet of the higher layer parameter ControlResourceSet incorporating/including/comprising/indicating the CORESETGroupIndex is provided below in TABLE 1. In this example, two CORESETGroupIndex values 0 and 1 are used.

TABLE 1
An example of higher layer parameter ControlResourceSet
indicating CORESETGroupIndex

```
-- ASN1START
-- TAG-CONTROLRESOURCESET-START
ControlResourceSet ::= SEQUENCE {
  controlResourceSetId ControlResourceSetId,
    coresetGroupIndex INTEGER (0..1) OPTIONAL, -- Need S
    ...
    ...
}
-- TAG-CONTROLRESOURCESET-STOP
-- ASN1STOP
```

Any combinations of at least two of the above described design options (Option-3.A, Option-3.B, Option-4.A, Option-4.B, Option-5.A and Option-5B) or any other variations of the above described design options (Option-3.A, Option-3.B, Option-4.A, Option-4.B, Option-5.A and Option-5B) can be used for full cell-specific and/or TRP-specific beam failure(s) detection.

For example, the UE could use/determine a single BFD RS beam set (G_q0=1) containing at least three (M_q0≥3) BFD RSs, which could correspond to at least three periodic 1-port CSI-RS resource configuration indexes or SSB indexes indicated/configured as the QCL-typeD (i.e., spatial quasi-co-location) source RSs in the active TCI states for PDCCH reception in different CORESETs associated with different values of CORESETPoolIndex or CORESETGroupIndex; the BFD RSs included in the single BFD RS beam set could be used for both cell-specific and TRP-specific beam failure(s) detection. The UE could be indicated/configured by the network to start monitoring the (TRP-specific) BFD RSs implicitly determined following Option-3 or/and Option-4 or/and Option-5 for detecting/triggering the TRP-specific/partial BFR in a multi-TRP system; this indication could be via higher layer (RRC) or/and MAC CE or/and DCI based signaling.

Alternatively, the UE could start to monitor the (TRP-specific) BFD RSs implicitly determined following Option-3 or/and Option-4 or/and Option-5 for detecting/triggering the TRP-specific/partial BFR in a multi-TRP system as soon as the multi-TRP operation is activated by the network, e.g., via higher layer (RRC) or/and MAC CE or/and DCI based signaling.

Furthermore, the UE could be indicated/configured by the network to stop monitoring the (TRP-specific) BFD RSs implicitly determined following Option-3 or/and Option-4 or/and Option-5 for detecting/triggering the TRP-specific/partial BFR in a multi-TRP system. If the multi-TRP operation is deactivated by the network, e.g., via higher layer (RRC) or/and MAC CE or/and DCI based signaling, the UE could also stop monitoring the (TRP-specific) BFD RSs implicitly determined following Option-3 or/and Option-4 or/and Option-5 for detecting/triggering the TRP-specific/partial BFR in a multi-TRP system.

In one embodiment, various methods of measuring explicitly/implicitly configured TRP-specific/per TRP BFD RS(s) are provided.

The physical layer in the UE assesses the radio link quality of the BFD RSs corresponding to the SSBs on the PCell or the PSCell or periodic 1-port CSI-RS resource configurations that are quasi co-located with the DM-RS of PDCCH receptions monitored by the UE. As aforementioned, if the UE is not provided by the network any BFD RS(s) via the explicit BFD RS configuration method(s)/option(s), the UE could implicitly determine the BFD RS(s) and assess the radio link quality of the BFD RS(s) for potential beam failure declaration/detection.

Alternatively, regardless whether the UE is provided by the network BFD RS(s) via the explicit BFD RS configuration method(s)/option(s) or not, the UE could still implicitly determine the BFD RS(s) based on the above discussed design method(s)/option(s). In this case, the UE could assess the ratio link quality of the explicitly configured BFD RS(s) or the implicitly determined BFD RS(s) based on network configuration or a UE's capability/feature signaling. Various means of measuring the explicitly or implicitly configured BFD RSs and assessing their corresponding radio link quality are presented as follows.

The UE could be configured/indicated by the network to measure the explicitly configured BFD RSs (configured via, e.g., Option-0, Option-1 or/and Option-2), or the implicitly configured BFD RSs (configured via, e.g., Option-3, Option-4 or/and Option-5), or both of the explicitly and implicitly configured BFD RSs, for potential beam failure(s) detection; this indication could be via higher layer (RRC) or/and MAC CE or/and DCI based signaling; this indication could be via a separate (dedicated) parameter or joint with another parameter.

In one example, the UE could be configured/indicated by the network to measure only the explicitly configured BFD RSs; the explicit BFD RS configuration could follow one or more of Option-0.A, Option-0.B, Option-0.C, Option-0.D, Option-1.A, Option-1.B, Option-1.C, Option-1.D and Option-2, or one or more combinations of at least two of Option-0.A, Option-0.B, Option-0.C, Option-0.D, Option-1.A, Option-1.B, Option-1.C, Option-1.D and Option-2, or variation(s) of Option-0.A, Option-0.B, Option-0.C, Option-0.D, Option-1.A, Option-1.B, Option-1.C, Option-1.D and/or Option-2.

In another example, the UE could be configured/indicated by the network to measure only the implicitly configured BFD RSs; the implicit BFD RS configuration could follow one or more of Option-3.A, Option-3.B, Option-4.A, Option-4.B, Option-5.A and Option-5.B, or one or more combinations of at least two of Option-3.A, Option-3.B, Option-4.A, Option-4.B, Option-5.A and Option-5.B, or variation(s) of Option-3.A, Option-3.B, Option-4.A, Option-4.B, Option-5.A and Option-5.B.

In yet another example, the UE could be configured/indicated by the network to measure both the explicitly configured and the implicitly configured BFD RSs; the explicit BFD RS configuration could follow one or more of Option-0.A, Option-0.B, Option-0.C, Option-0.D, Option-1.A, Option-1.B, Option-1.C, Option-1.D and Option-2, or one or more combinations of at least two of Option-0.A, Option-0.B, Option-0.C, Option-0.D, Option-1.A, Option-1.B, Option-1.C, Option-1.D and Option-2, or variation(s) of Option-0.A, Option-0.B, Option-0.C, Option-0.D, Option-1.A, Option-1.B, Option-1.C, Option-1.D and/or Option-2; the implicit BFD RS configuration could follow one or more of Option-3.A, Option-3.B, Option-4.A, Option-4.B, Option-5.A and Option-5.B, or one or more combinations of at least two of Option-3.A, Option-3.B, Option-4.A, Option-4.B, Option-5.A and Option-5.B, or variation(s) of Option-3.A, Option-3.B, Option-4.A, Option-4.B, Option-5.A and Option-5.B.

The UE could also send to the network indication(s) regarding how they would like to measure the explicitly configured BFD RSs and/or the implicitly configured BFD RSs for potential beam failure(s) detection in a multi-TRP system.

In one example, the UE could indicate to the network that the UE would like to measure only the explicitly configured BFD RSs (e.g., via Option-0.A, Option-0.B, Option-0.C, Option-0.D, Option-1.A, Option-1.B, Option-1.C, Option-1.D and/or Option-2) for potential beam failure(s) detection.

In another example, the UE could indicate to the network that the UE would like to measure only the implicitly configured BFD RSs (e.g., via Option-3.A, Option-3.B, Option-4.A, Option-4.B, Option-5.A and/or Option-5.B) for potential beam failure(s) detection.

In yet another example, the UE could indicate to the network that the UE could measure both the explicitly configured BFD RSs (e.g., via Option-0.A, Option-0.B, Option-0.C, Option-0.D, Option-1.A, Option-1.B, Option-1.C, Option-1.D and/or Option-2) and the implicitly configured BFD RSs (e.g., via Option-3.A, Option-3.B, Option-4.A, Option-4.B, Option-5.A and/or Option-5.B) for potential beam failure(s) detection.

In yet another example, the UE could indicate to the network their preferred explicit BFD RS configuration method(s) (e.g., from Option-0.A, Option-0.B, Option-0.C, Option-0.D, Option-1.A, Option-1.B, Option-1.C, Option-1.D and Option-2).

In yet another example, the UE could indicate to the network their preferred implicit BFD RS configuration method(s) (e.g., from via Option-3.A, Option-3.B, Option-4.A, Option-4.B, Option-5.A and/or Option-5.B).

In yet another example, the UE could send to the network an indication to trigger the explicit configuration(s) of the BFD RS(s); the UE could also send to the network indication(s) about increasing or reducing the time-frequency resource density (e.g., the periodicity) of the explicitly configured BFD RS(s).

In one embodiment, various TRP-specific/per TRP beam failure declaration methods for multi-TRP BFR are provided.

The physical layer in the UE periodically (e.g., every BFD RS monitoring occasion) assesses the radio link quality for one or more BFD RSs (or equivalently one or more corresponding resource configurations) in a BFD RS beam set against a BFD threshold. As aforementioned, in a BFD RS beam set, the physical layer in the UE could only assess the radio link quality according to SSB(s) on the PCell or PSCell or periodic CSI-RS resource configuration(s) that are quasi-co-located with the DM-RS of PDCCH receptions in one or more CORESETs (associated with the BFD RS beam set) monitored by the UE. The UE could be higher layer configured by the network (e.g., via higher layer RRC signaling) one or more BFD RS monitoring periods each including one or more BFD RS monitoring occasions.

Alternatively, the UE could autonomously determine the one or more BFD RS monitoring periods. For both network configured and UE determined design options, each BFD RS monitoring period could correspond to a BFD RS beam set that is associated with a set ID/index or a value of CORESETPoolIndex/CORESETGroupIndex, or a BFD RS in a BFD RS beam set that is associated with a resource ID/index in the BFD RS beam set or a value of CORESETPoolIndex/CORESETGroupIndex, or a TRP or TRP-specific index/ID value such as PCI in the multi-TRP system.

Furthermore, for both network configured and UE determined design options, different BFD RS monitoring periods could have different monitoring periodicities and could be configured with different monitoring period IDs/indices. For instance, the periodicity of a BFD RS monitoring period could be determined according to the shortest periodicity among one or more SSBs on the PCell or the PSCell and/or one or more periodic CSI-RS configurations in the BFD RS beam set that the UE uses to access the radio link quality.

In one example Example-1, for Option-0.A, Option-0.B, Option-0.C, Option-0.D, Option-3.A and Option-3.B, one BFD RS monitoring period could correspond/link to at least one BFD RS in the single BFD RS beam set. For example, for Option-0.A with N_q0=2, the first BFD RS monitoring period or the BFD RS monitoring period with the lower monitoring period ID/index (denoted by BFD-RS-monitoring-period-1) could correspond/link to the first BFD RS or the BFD RS with the lower resource index/ID in the BFD RS beam set associated with the lower TRP-specific index/ID value such as PCI value or CORESETPoolIndex value in the higher layer configured list/set/pool of TRP-specific index/ID values, and the second BFD RS monitoring period or the BFD RS monitoring period with the higher monitoring period ID/index (denoted by BFD-RS-monitoring-period-2) could correspond/link to the second BFD RS or the BFD RS with the higher resource index/ID in the BFD RS beam set associated with the higher TRP-specific index/ID value such as PCI value or CORESETPoolIndex value in the higher layer configured list/set/pool of TRP-specific index/ID values.

For another example, for Option-3.A with M_q0=2, the first BFD RS monitoring period or the BFD RS monitoring period with the lower monitoring period ID/index (denoted by BFD-RS-monitoring-period-1) could correspond/link to the first BFD RS or the BFD RS with the lower resource index/ID in the BFD RS beam set associated with ‘CORESETPoolIndex=0’, and the second BFD RS monitoring period or the BFD RS monitoring period with the higher monitoring period ID/index (denoted by BFD-RS-monitoring-period-2) could correspond to the second BFD RS or the BFD RS with the higher resource index/ID in the BFD RS beam set associated with ‘CORESETPoolIndex=1’.

For N_q0=2/M_q0=2, denote the periodicities of BFD-RS-monitoring-period-1 and BFD-RS-monitoring-period-2 by BFD-RS-monitoring-periodicity-1 and BFD-RS-monitoring-periodicity-2, which could be determined as BFD-RS-monitoring-periodicity-1=max{periodicity of the first BFD RS or the BFD RS with the lower resource index/ID in the BFD RS beam set, x_1 ms} and BFD-RS-monitoring-periodicity-2=max{periodicity of the second BFD RS or the BFD RS with the higher resource index/ID in the BFD RS beam set, x_2 ms}; the values of x_1 and x_2 could be: (1) fixed in the system specification(s), (2) configured by the network, or (3) determined by the UE and reported to the network as a UE capability/feature signaling. The values of x_1 and x_2 could be the same, e.g., x_1=x_2=2, or different. Based on the above discussions, BFD-RS-monitoring-periodicity-1 and BFD-RS-monitoring-periodicity-2 could be the same, i.e., BFD-RS-monitoring-periodicity-1=BFD-RS-monitoring-periodicity-2, or of different values.

Every BFD-RS-monitoring-periodicity-1, the physical layer in the UE could measure/assess the radio link quality of the BFD RS associated with BFD-RS-monitoring-period-1 (e.g., the first BFD RS or the BFD RS with the lower resource index/ID in the BFD RS beam set), and inform the higher layers (i) when the radio link quality is worse than a BFD threshold, and/or (ii) the resource index of the BFD RS (or equivalently, the SSB index or the periodic 1-port CSI-RS resource configuration index) corresponding to/associated with BFD-RS-monitoring-period-1 if the radio link quality is worse than the BFD threshold.

Every BFD-RS-monitoring-periodicity-2, the UE could measure/assess the radio link quality of the BFD RS associated with BFD-RS-monitoring-period-2 (e.g., the second BFD RS or the BFD RS with the higher resource index/ID in the BFD RS beam set), and inform the higher layers (i) when the radio link quality is worse than a BFD threshold, and/or (ii) the index/ID of the BFD RS (or equivalently, the corresponding SSB index or periodic 1-port CSI-RS resource configuration index) corresponding to/associated with BFD-RS-monitoring-period-2 if the radio link quality is worse than the BFD threshold.

The above described design examples for N_q0=2/M_q0=2 could be applied to more than two BFD RSs in a single BFD RS beam set (i.e., N_q0>2/M_q0>2), and other association rules/mapping relationships between the BFD RS monitoring periods and the BFD RSs in the single BFD RS beam set are also possible.

In one example Example-2, for Option-1.A, Option-1.B, Option-1.C, Option-1.D, Option-4.A, Option-4.B, Option-5.A and Option-5.B, one BFD RS monitoring period could correspond/link to at least one BFD RS beam set. For example, for Option-1.A with S_q0=2, the first BFD RS monitoring period or the BFD RS monitoring period with the lower monitoring period ID/index (denoted by BFD-RS-monitoring-period-1) could correspond/link to the first BFD RS beam set q0-0 or the BFD RS beam set q0-0 with the lower set ID/index associated with the lower TRP-specific index/ID value such as PCI value or CORESETPoolIndex value in the higher layer configured list/set/pool of TRP-specific index/ID values, and the second BFD RS monitoring period or the BFD RS monitoring period with the higher monitoring period ID/index (denoted by BFD-RS-monitoring-period-2) could correspond to the second BFD RS beam set q0-1 or the BFD RS beam set q0-1 with the higher set ID/index associated with the higher TRP-specific index/ID value such as PCI value or CORESETPoolIndex value in the higher layer configured list/set/pool of TRP-specific index/ID values.

For another example, for Option-4.A/5.A with G_q0=2, the first BFD RS monitoring period or the BFD RS monitoring period with the lower monitoring period ID/index (denoted by BFD-RS-monitoring-period-1) could correspond to the first BFD RS beam set q0-0 or the BFD RS beam set q0-0 with the lower set ID/index associated with ‘CORESETPoolIndex=0’/‘CORESETGroupIndex=0’, and the second BFD RS monitoring period or the BFD RS monitoring period with the higher monitoring period ID/index (denoted by BFD-RS-monitoring-period-2) could correspond to the second BFD RS beam set q0-1 or the BFD RS beam set q0-1 with the higher set ID/index associated with ‘CORESETPoolIndex=1’/‘CORESETGroupIndex=1’.

For S_q0=2/G_q0=2, denote the periodicities of BFD-RS-monitoring-period-1 and BFD-RS-monitoring-period-2 by BFD-RS-monitoring-periodicity-1 and BFD-RS-monitoring-periodicity-2, which could be determined as BFD-RS-monitoring-periodicity-1=max{minimal/shortest periodicities of the BFD RS(s) in the first BFD RS beam set q0-0 or the BFD RS beam set q0-0 with the lower set ID/index, x_1 ms} and BFD-RS-monitoring-periodicity-2=max{minimal/shortest periodicities of the BFD RS(s) in the second BFD RS beam set q0-1 or the BFD RS beam set q0-1 with the higher set ID/index, x_2 ms}; x_1 and x_2 could be deterministic/fixed values per RRC configuration; the values of x_1 and x_2 could be: (1) fixed in the system specification(s), (2) configured by the network, or (3) determined by the UE and reported to the network as a UE capability/feature signaling. The values of x_1 and x_2 could be the same, e.g., x_1=x_2=2, or different. Based on the above discussions, BFD-RS-monitoring-periodicity-1 and BFD-RS-monitoring-periodicity-2 could be the same, i.e., BFD-RS-monitoring-periodicity-1=BFD-RS-monitoring-periodicity-2, or of different values.

Every BFD-RS-monitoring-periodicity-1, the physical layer in the UE could measure/assess the radio link quality of all the BFD RS(s) in the BFD RS beam set associated with BFD-RS-monitoring-period-1 (e.g., the first BFD RS beam set q0-0 or the BFD RS beam set q0-0 with the lower set ID/index), and inform higher layers (i) when the radio link quality is worse than a BFD threshold, and/or (ii) the set index/ID of the BFD RS beam set q0-0—including/containing one or more BFD RSs corresponding to one or more periodic 1-port CSI-RS resource configuration indexes or SSB indexes—corresponding to/associated with BFD-RS-monitoring-period-1 if the radio link quality is worse than the BFD threshold.

Every BFD-RS-monitoring-periodicity-2, the UE could measure/assess the radio link quality of all the BFD RS(s) in the BFD RS beam set associated with BFD-RS-monitoring-period-2 (e.g., the second BFD RS beam set q0-1 or the BFD RS beam set q0-1 with the higher set ID/index), and inform the higher layers (i) when the radio link quality is worse than a BFD threshold, and/or (ii) the set index/ID of the BFD RS beam set q0-1—including/containing one or more BFD RSs corresponding to one or more periodic 1-port CSI-RS resource configuration indexes or SSB indexes—corresponding to/associated with BFD-RS-monitoring-period-2 if the radio link quality is worse than the BFD threshold.

The above described design examples for S_q0=2/G_q0=2 could be applied to more than two BFD RS beam sets (i.e., S_q0>2/G_q0>2), and other association rules/mapping relationships between the BFD RS monitoring periods and the BFD RS beam sets are also possible.

In one example Example-3, for Option-2, Option-4.B and Option-5.B, one BFD RS monitoring period could correspond to one or more BFD RSs in a single BFD RS beam set, or one or more BFD RS beam sets. For example, for S_q0=2/G_q0=2, one BFD RS monitoring period could correspond to the first BFD RS beam set q0-0 (e.g., with the lower set ID/index); the detailed association rule(s)/mapping relationship(s) between the BFD RS monitoring period and the BFD RS beam set, and the corresponding beam failure detection criteria could follow those discussed in Example-2. Furthermore, at least two BFD RS monitoring periods could correspond/link to the BFD RSs in the second BFD RS beam set q0-1 (e.g., with the higher set ID/index); the detailed association rule(s)/mapping relationship(s) between the BFD RS monitoring periods and the BFD RSs in the second BFD RS beam set q0-1, and the corresponding beam failure detection criteria could follow those discussed in Example-1.

The physical layer in the UE could evaluate/assess the radio link quality for one or more BFD RSs (or equivalently, one or more SSBs on the PCell or the PSCell or one or more periodic 1-port CSI-RS resource configurations) configured/included in one or more BFD RS beam sets against one or more BFD thresholds. The value(s) of the BFD threshold(s) could be: (1) fixed in the system specifications, (2) based on network's configuration, e.g., the UE could be higher layer RRC configured by the network one or more TRP-specific/per TRP BFD thresholds, and (3) autonomously determined by the UE and reported to the network as a UE capability/feature signaling.

In one example, the physical layer in the UE could assess the radio link quality for one or more BFD RSs (or equivalently, one or more SSBs on the PCell or the PSCell or one or more periodic 1-port CSI-RS resource configurations) configured/included in one or more BFD RS beam sets against a common BFD threshold. For Option-0.A, Option-0.B, Option-0.C, Option-0.D, Option-3.A and Option-3.B in the present disclosure, the radio link quality is evaluated/assessed by the physical layer in the UE for at least one BFD RS in the BFD RS beam set. For Option-1.A, Option-1.B, Option-1.C, Option-1.D, Option-2, Option-4.A, Option-4.B, Option-5.A and Option-5.B in the present disclosure, the radio link quality is evaluated/assessed by the physical layer in the UE for all the BFD RSs in a BFD RS beam set.

In another example, the physical layer in the UE could assess the radio link quality for one or more BFD RSs (or equivalently, one or more SSBs on the PCell or the PSCell or one or more periodic 1-port CSI-RS resource configurations) configured/included in one or more BFD RS beam sets against different BFD thresholds.

For Option-0.A, Option-0.B, Option-0.C, Option-0.D, Option-3.A and Option-3.B in the present disclosure, the radio link quality is evaluated/assessed by the physical layer in the UE for at least one BFD RS in the BFD RS beam set. Specifically, for Option-0.A, Option-0.B, Option-0.0 and Option-0.D, the UE could assess the radio link qualities for the N_q0 BFD RSs in the single BFD RS beam set against N_q0 separate BFD thresholds Qout-n's, where n=0, 1, . . . , N_q0−1. Furthermore, for Option-3.A and Option-3.B, the UE could assess the radio link qualities for the M_q0 BFD RSs in the single BFD RS beam set against M_q0 separate BFD thresholds Qout-m's, where m=0, 1, . . . , N_q0−1. Different BFD thresholds could be all equal, i.e., correspond to a common value.

For Option-1.A, Option-1.B, Option-1.C, Option-1.D, Option-2, Option-4.A, Option-4.B, Option-5.A and Option-5.B in the present disclosure, the radio link quality is evaluated/assessed by the physical layer in the UE for all the BFD RSs in a BFD RS beam set. Specifically, for Option-1.A, Option-1.B, Option-1.C, Option-1.D and Option-2, the UE could assess the ratio link quality for the k-th BFD RS beam set or BFD RS beam set k or the BFD RS beam set with the k-th lowest (or highest) set index/ID value against BFD threshold Qout-k, where k=0, 1, . . . , S_q0−1.

Furthermore, for Option-4.A, Option-4.B, Option-5.A and Option-5.B, the UE could assess the radio link quality for the 1-th BFD RS beam set or BFD RS beam set 1 or the BFD RS beam set with the 1-th lowest (or highest) set index/ID value against BFD threshold Qout-1, where 1=0, 1, . . . , G_q0−1. For instance, for S_q0/G_q0=2, the physical layer in the UE could evaluate/assess the radio link quality for all the BFD RSs (or equivalently, all the corresponding SSBs on the PCell or the PSCell or all the corresponding periodic 1-port CSI-RS resource configurations) configured/included in the BFD RS beam set q0-0 against the BFD threshold Qout-0, and the radio link quality for all the BFD RSs (or equivalently, all the corresponding SSBs on the PCell or the PSCell or all the corresponding periodic 1-port CSI-RS resource configurations) configured/included in the BFD RS beam set q0-1 against the BFD threshold Qout-1. Different BFD thresholds could be all equal. For instance, Qout-0 could be equal to Qout-1 (i.e., Qout-0=Qout-1) for S_q0/G_q0=2.

In the present disclosure, a radio link quality could correspond to a L1 based beam metric/measurement such as a L1-RSRP measurement or a L1-SINR measurement. A BFD threshold could correspond to the default value of rlmInSyncOutOfSyncThreshold for Qout, and/or to the value provided by the higher layer parameter rsrp-ThresholdSSB.

The higher layers of the UE could maintain one or more BFI counters; each BFI counter could correspond to a BFD RS beam set that is associated with a set ID/index or a value of CORESETPoolIndex/CORESETGroupIndex, or a BFD RS in a BFD RS beam set that is associated with a resource ID/index in the BFD RS beam set or a value of CORESETPoolIndex/CORESETGroupIndex, or a TRP or TRP-specific index/ID value such as PCI in the multi-TRP system. For example, for S_q0/G_q0=2 in Option-1.A, Option-1.B, Option-1.C, Option-1.D and Option-2, Option-4.A, Option-4.B, Option-5.A and Option-5.B in the present disclosure, the UE could maintain two separate BFI counters, denoted by BFI_COUNTER-0 and BFI_COUNTER-1, respectively corresponding to the two BFD RS beam sets q0-0 and q0-1.

As discussed above, the physical layer in the UE could measure/assess the radio link quality of all the BFD RS(s) (or equivalently, all the corresponding SSB(s) on the PCell or the PSCell or all the corresponding periodic 1-port CSI-RS resource configurations) in the BFD RS beam set q0-0, and inform higher layers when the radio link quality is worse than the BFD threshold Qout-0; if the higher layers in the UE are informed that the radio link quality for the BFD RS beam set q0-0 is worse than the BFD threshold Qout-0, the higher layers in the UE could increment the BFI count for the BFD RS beam set q0-0 (i.e., BFI_COUNTER-0).

Similarly, the physical layer in the UE could measure/assess the radio link quality of all the BFD RS(s) (or equivalently, all the corresponding SSB(s) on the PCell or the PSCell or all the corresponding periodic 1-port CSI-RS resource configurations) in the BFD RS beam set q0-1, and inform higher layers when the radio link quality is worse than the BFD threshold Qout-1; if the higher layers in the UE are informed that the radio link quality for the BFD RS beam set q0-1 is worse than the BFD threshold Qout-1, the higher layers in the UE could increment the BFI count for the BFD RS beam set q0-1 (i.e., BFI_COUNTER-1).

The UE could declare beam failure if a maximum number of BFI count is achieved before a BFD timer expires. The UE could be higher layer configured by the network (e.g., via higher layer RRC signaling) one or more maximum numbers of BFI count and one or more BFD timers. Alternatively, the UE could autonomously determine one or more maximum numbers of BFI count and one or more BFD timers. For both network configured and UE determined design options, each maximum number of BFI count/BFD timer could correspond to a BFD RS beam set that is associated with a set ID/index or a value of CORESETPoolIndex/CORESETGroupIndex, or a BFD RS in a BFD RS beam set that is associated with a resource ID/index in the BFD RS beam set or a value of CORESETPoolIndex/CORESETGroupIndex, or a TRP or TRP-specific index/ID value such as PCI in the multi-TRP system.

Furthermore, the maximum numbers of BFI count associated with different BFD RSs in a BFD RS beam set or different BFD RS beam sets could correspond to a same value or different values, and the BFD thresholds associated with different BFD RSs in a BFD RS beam set or different BFD RS beam sets could correspond to a same value or different values. Specifically, for S_q0/G_q0=2 in Option-1.A, Option-1.B, Option-1.C, Option-1.D and Option-2, Option-4.A, Option-4.B, Option-5.A and Option-5.B in the present disclosure, the maximum numbers of BFI count for the BFD RS beam sets q0-0 and q0-1 are denoted by maxBFIcount-0 and maxBFIcount-1, respectively, and the BFD timers associated with the BFD RS beam sets q0-0 and q0-1 are denoted by BFDtimer-0 and BFDtimer-1, respectively.

According to the above discussions, maxBFIcount-0 and maxBFIcount-1 could be the same (i.e., maxBFIcount-0=maxBFIcount-1) or different, and BFDtimer-0 and BFDtimer-1 could be the same (i.e., BFDtimer-0=BFDtimer-1) or different. The UE or the higher layers of the UE could declare a beam failure for the BFD RS beam set q0-0 (or q0-1) if the BFI count for the BFD RS beam set q0-0 (or q0-1) reaches maxBFIcount-1 (or maxBFIcount-2) before the expiration of BFDtimer-1 (or BFDtimer-2). Otherwise, if BFDtimer-1 (or BFDtimer-2) expires before the BFI count for the BFD RS beam set q0-0 (or q0-1) reaches maxBFIcount-1 (or maxBFIcount-2), the UE would not declare any beam failure for the BFD RS beam set q0-0 (q0-1), and reset the BFI count for the BFD RS beam set q0-0 (or q0-1).

Based on the above discussions, new MAC entities for the TRP-specific/per TRP BFI count need to be defined and specified. In Table 2, an illustrative example of the new MAC entity specified for a given BFD RS beam set (using the BFD RS beam set q0-1 as the example) is presented. Optionally, the UE could declare a cell-specific or cell-level beam failure, e.g., by initiating a random access procedure, if the BFI count for the BFD RS beam set q0-0 reaches maxBFIcount-0 and the BFI count for the BFD RS beam set q0-1 reaches maxBFIcount-1 within a time window (denoted by tw-BFR). The value/setting of the time window tw-BFR could be: (1) fixed in the system specification(s), (2) configured by the network, and/or (3) determined by the UE and/or reported to the network as a UE capability/feature signaling.

TABLE 2
An example of MAC entity for TRP-specific/per TRP beam failure declaration

```
The MAC entity corresponding to BFD RS beam set q0-1 shall:
1 > if beam failure instance indication has been received from lower layers:
  2 > start or restart the beamFailureDetectionTimer for BFD RS beam set q0-1, i.e.,
  BFDtimer-1
  2 > increment BFI_COUNTER for BFD RS beam set q0-1, i.e., BFI_COUNTER-1, by 1
  2 > if BFI_COUNTER-1 >= beamFailureInstanceMaxCount for BFD RS beam set q0-1,
  i.e., maxBFIcount-1:
    3 > initiate a Random Access procedure
1 > if the beamFailureDetectionTimer for BFD RS beam set q0-1, i.e., BFDtimer-1, expires;
or
1 > if beamFailureDetectionTimer for BFD RS beam set q0-1 (BFDtimer-1),
beamFailureInstanceMaxCount for BFD RS beam set q0-1 (maxBFIcount-1), or any of the
reference signals used for beam failure detection is reconfigured by upper layers:
  2 > set BFI_COUNTER-1 to 0.
1 > if the Random Access procedure is successfully completed
  2 > set BFI_COUNTER-1 to 0;
  2 > stop the beamFailureRecovery Timer for BFD RS beam set q0-1 , i.e., BFRtimer-1, if
  configured;
  2 > consider the Beam Failure Recovery procedure successfully completed.
```

In one embodiment, various TRP-specific/per TRP NBI RS configuration methods for multi-TRP BFR are provided.

The UE could measure one or more NBI RSs configured/included in one or more NBI RS beam sets. The physical layer in the UE could assess the radio link quality for one or more NBI RSs configured/included in one or more NBI RS beam sets against one or more BFR thresholds. A NBI RS could correspond to a SSB on the PCell or the PSCell or a periodic 1-port or 2-port CSI-RS resource configuration with frequency density equal to 1 or 3 REs per RB.

In one embodiment, various explicit TRP-specific/per TRP NBI RS configuration methods are provided.

For the single-TRP operation, the UE could be explicitly configured by the network (e.g., via higher layer RRC signaling) a single list/set of NBI RSs, e.g., via higher layer parameter candidateBeamRSList or candidateBeamRSListExt or candidateBeamRSSCellList. In the present disclosure, the list/set of the NBI RSs can also be referred to as a NBI RS beam set denoted by q1. As aforementioned, the NBI RSs in the NBI RS beam set q1 could be periodic 1-port or 2-port CSI-RS resource configuration indexes (the corresponding resource configurations are with frequency density equal to 1 or 3 REs per RB) or SSB indexes or other types of SSBs/CSI-RSs. The UE would keep monitoring the radio link qualities of the NBI RSs in q1, and could identify at least one NBI RS (or equivalently, the corresponding CSI-RS resource configuration index or SSB index in q1) with corresponding L1-RSRP measurements that are larger than or equal to a BFR threshold.

For the multi-TRP system, the UE could also be explicitly configured by the network (e.g., via higher layer RRC signaling) S_q1 (1×S_q1≤maxS_q1) NBI RS beam sets each containing N_q1 (1≤N_q1≤maxN_q1) NBI RSs, where maxS_q1 is the maximum number of NBI RS beam sets (e.g., maxS_q1=2 per BWP), which could be indicated/configured by the network to the UE via RRC or/and MAC CE or/and DCI based signaling or autonomously determined by the UE and reported to the network as a UE capability/feature signaling or both, and maxN_q1 is the maximum number of NBI RSs per NBI RS beam set (e.g., maxN_q1=2), which could be indicated/configured by the network to the UE via RRC or/and MAC CE or/and DCI based signaling or autonomously determined by the UE and reported to the network as a UE capability/feature signaling or both; the quantity N_q1 could be the same or different across the S_q1 NBI RS beam sets; each NBI RS could correspond to a 1-port or 2-port CSI-RS resource configuration index or a SSB index or other types of SSB/CSI-RS.

The S_q1 NBI RS beam sets and/or the N_q1 NBI RSs in each NBI RS beam set could be associated with different coordinating TRPs in the multi-TRP system. In one example, the UE could be configured by the network a single NBI RS beam set (S_q1=1) containing two NBI RSs (N_q1=2), denoted by NBI-RS-1 and NBI-RS-2 in q1, via higher layer RRC signaling. The first NBI RS in the NBI RS beam set, i.e., NBI-RS-1, could be associated with a first TRP associated with a lower PCI value/CORESETPoolIndex value/etc., e.g., TRP-1 in FIG. 10, and the second NBI RS in the NBI RS beam set, i.e., NBI-RS-2, could be associated with a second TRP associated with a higher PCI value/CORESETPoolIndex value/etc., e.g., TRP-2 in FIG. 10.

Alternatively, the UE could be explicitly indicated by the network the association rule/mapping relationship between the configured NBI RS(s)/NBI RS beam set(s) and the coordinating TRPs via RRC or/and MAC CE or/and DCI based signaling. Optionally, the UE could autonomously determine the association rule/mapping relationship between the configured NBI RS(s)/NBI RS beam set(s) and the coordinating TRPs, and indicate to the network their determined association rule/mapping relationship. Furthermore, the mapping between the S_q1 NBI RS beam set(s) and/or the N_q1 NBI RS(s) in a given NBI RS beam set q1 and the TRPs could be fixed/deterministic per RRC configuration.

Various means of explicitly configuring the NBI RSs/NBI RS beam sets and associating them with the TRPs or TRP-specific index/ID values in the multi-TRP system are presented as follows.

The UE could be first configured by the network (e.g., via higher layer RRC signaling) a list/set/pool of N_trp TRP-specific index/ID values. In the present disclosure, a TRP-specific index/ID could correspond to a PCI, a CORESETPoolIndex, a CORESET index/ID, a CORESET group index/ID, a TRP-specific RS ID, a TRP-specific index/ID or a TRP-specific higher layer signaling index. The UE could also receive from the network one or more MAC CE activation commands/bitmaps to activate/update one or more TRP-specific index/ID values in the higher layer configured list/set/pool of TRP-specific index/ID values.

The UE could be configured/indicated by the network (e.g., via RRC or/and MAC CE or/and DCI based signaling) a single NBI RS beam set (S_q1=1) containing at least two (N_q1≥2) NBI RSs. For instance, the UE could be configured by the network the single NBI RS beam set (S_q1=1) via a higher layer parameter candidateBeamRSList and the at least two NBI RSs (N_q1≥2) configured therein corresponding to periodic CSI-RS resource configuration indexes and/or SSB indexes via a higher layer parameter candidateBeamResources. One or more of the N_q1 NBI RSs in the configured NBI RS beam set could be associated with/linked to a TRP or a TRP-specific index/ID value such as PCI, CORESETPoolIndex or CORESET index/ID in the higher layer configured list/set/pool of TRP-specific index/ID values in the multi-TRP system, wherein the UE could be configured two CORESETPoolIndex values or is not provided CORESETPoolIndex value for a first CORESET but is provided CORESETPoolIndex value of 1 for a second CORESET.

In one example of Option-N.A, the first NBI RS or the NBI RS with the lowest resource index/ID in the configured NBI RS beam set could correspond/link to the lowest (or the highest) TRP-specific index/ID value such as PCI value or CORESETPoolIndex value in the higher layer configured list/set/pool of TRP-specific index/ID values, the second NBI RS or the NBI RS with the second lowest resource index/ID in the configured NBI RS beam set could correspond/link to the second lowest (or the second highest) TRP-specific index/ID value such as PCI value or CORESETPoolIndex value in the higher layer configured list/set/pool of TRP-specific index/ID values, and so on, and the last NBI RS or the NBI RS with the highest resource index/ID in the configured NBI RS beam set could correspond/link to the highest (or the lowest) TRP-specific index/ID value such as PCI value or CORESETPoolIndex value in the higher layer configured list/set/pool of TRP-specific index/ID values.

That is, the k-th NBI RS or NBI RS k or the NBI RS with the k-th lowest resource index/ID in the configured NBI RS beam set could correspond/link to the k-th lowest (or highest) TRP-specific index/ID value such as PCI value, CORESET index/ID value, CORESET group index/ID value or CORESETPoolIndex value in the higher layer configured list/set/pool of TRP-specific index/ID values, where k=0, 1, . . . , N_q1−1.

In another one example, for N_q1=2, the first NBI RS in the configured NBI RS beam set could be a target RS of a TCI state associated with CORESETPoolIndex=0, and the second NBI RS configured in the NBI RS beam set could be a target RS of a TCI state associated with CORESETPoolIndex=1. In yet another example, the k-th NBI RS or NBI RS k or the NBI RS with the k-th lowest (or highest) resource index/ID in the configured NBI RS beam set could link to/correspond to/be associated with CORESETPoolIndex value k, where k=0, 1.

In yet another example, the first NBI RS or the NBI RS with the lowest resource index/ID in the configured NBI RS beam set could correspond/link to the first entry in the higher layer configured list/set/pool of TRP-specific index/ID values, the second NBI RS or the NBI RS with the second lowest resource index/ID in the configured NBI RS beam set could correspond/link to the second entry in the higher layer configured list/set/pool of TRP-specific index/ID values, and so on, and the last NBI RS or the NBI RS with the highest resource index/ID in the configured NBI RS beam set could correspond/link to the last entry in the higher layer configured list/set/pool of TRP-specific index/ID values. That is, the k-th NBI RS or NBI RS k or the NBI RS with the k-th lowest resource index/ID in the configured NBI RS beam set could correspond/link to the k-th entry in the higher layer configured list/set/pool of TRP-specific index/ID values, where k=0, 1, . . . , N_q1−1.

As aforementioned, in the present disclosure, a TRP-specific index/ID could correspond to a PCI, a CORESETPoolIndex, a CORESET index/ID, a CORESET group index/ID, a TRP-specific RS ID, a TRP-specific index/ID or a TRP-specific higher layer signaling index. Other association rules/mapping relationships between the N_q1 NBI RSs in the configured NBI RS beam set and the coordinating TRPs or the TRP-specific index/ID values in the multi-TRP system are also possible.

In one example of Option-N.B, the UE could be explicitly indicated by the network the association rule(s)/mapping relationship(s) between the N_q1 NBI RSs in the configured NBI RS beam set and the coordinating TRPs or the TRP-specific index/ID values in the multi-TRP system. For instance, the UE could be indicated by the network that the i-th NBI RS or NBI RS i or the NBI RS with the i-th lowest index/ID value in the configured NBI RS beam set (i∈{0, 1, . . . , N_q1−1}) is associated with/linked to the j-th lowest (or highest) TRP-specific index/ID value such as PCI or CORESETPoolIndex or the j-th entry in the higher layer configured list/set/pool of TRP-specific index/ID values (j∈{0, 1, . . . , N_trp−1}), where i could be different from j; further, this indication could be via higher layer (RRC) or/and MAC CE or/and DCI based signaling; this indication could be via a separate (dedicated) parameter or joint with another parameter. Other methods to indicate/configure the explicit association rule(s)/mapping relationship(s) between the N_q1 NBI RSs in the configured NBI RS beam set and the coordinating TRPs or the higher layer configured TRP-specific index/ID values in the multi-TRP system are also possible.

In one example of Option-N.C, the UE could only be indicated by the network that the N_q1 NBI RSs configured in the NBI RS beam set are for different coordinating TRPs or different TRP-specific index/ID values in the multi-TRP system, and are used for detecting and/or triggering the TRP-specific/partial BFR; the UE could also be indicated by the network which NBI RS(s) is associated with the same TRP or the same TRP-specific index/ID value such as PCI or CORESETPoolIndex; this indication could be via higher layer (RRC) or/and MAC CE or/and DCI based signaling; this indication could be via a separate (dedicated) parameter or joint with another parameter.

In one example of Option-N.D, the UE could be indicated by the network one or more TRP-specific index/ID values such as PCIs, CORESET index/ID values, CORESET group index/ID values or CORESETPoolIndex values along with the configuration of the NBI RSs/NBI RS beam set; this indication could be via higher layer (RRC) or/and MAC CE or/and DCI based signaling; this indication could be via a separate (dedicated) parameter or joint with another parameter. For instance, a list/set of N_q1 TRP-specific index/ID values could be indicated in the parameter configuring the NBI RS beam set, e.g., in the higher layer parameter candidateBeamRSList. The association/mapping between the N_q1 NBI RSs configured in the NBI RS beam set and the N_q1 TRP-specific index/ID values indicated in the parameter configuring the NBI RS beam set could follow those specified in Option-N.A, Option-N.B or Option-N.C. For instance, the k-th NBI RS or NBI RS k or the NBI RS with the k-th lowest resource index/ID in the configured NBI RS beam set could correspond/link to the k-th lowest (or highest) TRP-specific index/ID value such as PCI value or CORESETPoolIndex value or the k-th entry in the list/set of N_q1 TRP-specific index/ID values indicated in the parameter configuring the NBI RS beam set, where k=0, 1, . . . , N_q1−1.

The UE could be configured/indicated by the network (e.g., via RRC or/and MAC CE or/and DCI based signaling) at least two NBI RS beam sets (S_q1≥2) each containing at least one (N_q1≥1) NBI RS. For instance, the UE could be configured by the network two NBI RS beam sets (S_q1=2) q1-0 and q1-1, e.g., via higher layer parameters candidateBeamRSList0 and candidateBeamRSList1, respectively. Each NBI RS beam set, i.e., q1-0 or q1-1 for S_q1=2, could contain/comprise/include one or more NBI RSs (N_q1≥1) corresponding to one or more periodic CSI-RS resource configuration indexes and/or SSB indexes configured via a higher layer parameter candidateBeamResources. One or more of the configured S_q1 NBI RS beam sets could be associated with/linked to a TRP or a TRP-specific index/ID value such as PCI or CORESETPoolIndex in the higher layer configured list/set/pool of TRP-specific index/ID values in the multi-TRP system, wherein the UE could be configured two CORESETPoolIndex values or is not provided CORESETPoolIndex value for a first CORESET but is provided CORESETPoolIndex value of 1 for a second CORESET.

In one example of Option-I.A, the first NBI RS beam set or the NBI RS beam set with the lowest set ID/index could correspond/link to the lowest (or the highest) TRP-specific index/ID value such as PCI value or CORESETPoolIndex value in the higher layer configured list/set/pool of TRP-specific index/ID values, the second NBI RS beam set or the NBI RS beam set with the second lowest set ID/index could correspond/link to the second lowest (or the second highest) TRP-specific index/ID value such as PCI value or CORESETPoolIndex value in the higher layer configured list/set/pool of TRP-specific index/ID values, and so on, and the last NBI RS beam set or the NBI RS beam set with the highest set ID/index could correspond/link to the highest (or the lowest) TRP-specific index/ID value such as PCI value or CORESETPoolIndex value in the higher layer configured list/set/pool of TRP-specific index/ID values.

That is, the k-th NBI RS beam set or NBI RS beam set k or the NBI RS beam set with the k-th lowest set index/ID could correspond/link to the k-th lowest (or highest) TRP-specific index/ID value such as PCI value, CORESET index/ID value, CORESET group index/ID value or CORESETPoolIndex value in the higher layer configured list/set/pool of TRP-specific index/ID values, where k=0, 1, . . . , N_q1−1. For instance, the k-th NBI RS beam set or NBI RS beam set k or the NBI RS beam set with the k-th lowest set index/ID could correspond/link to CORESETPoolIndex value k, where k=0,1. In another example, for S_q1=2, the NBI RS(s) in the first NBI RS beam set (q1-0) could be the target RS(s) of the TCI state(s) associated with CORESETPoolIndex=0, and the NBI RS(s) in the second NBI RS beam set (denoted by q1-1) could be the target RS(s) of the TCI state(s) associated with CORESETPoolIndex=1.

In yet another example, the first NBI RS beam set or the NBI RS beam set with the lowest set index/ID could correspond/link to the first entry in the higher layer configured list/set/pool of TRP-specific index/ID values, the second NBI RS beam set or the NBI RS beam set with the second lowest set index/ID could correspond/link to the second entry in the higher layer configured list/set/pool of TRP-specific index/ID values, and so on, and the last NBI RS beam set or the NBI RS beam set with the highest set index/ID could correspond/link to the last entry in the higher layer configured list/set/pool of TRP-specific index/ID values. That is, the k-th NBI RS beam set or NBI RS beam set k or the NBI RS beam set with the k-th lowest set index/ID could correspond/link to the k-th entry in the higher layer configured list/set/pool of TRP-specific index/ID values, where k=0, 1, . . . , N_q1−1.

As aforementioned, in the present disclosure, a TRP-specific index/ID could correspond to a PCI, a CORESETPoolIndex, a CORESET index/ID, a CORESET group index/ID, a TRP-specific RS ID, a TRP-specific index/ID or a TRP-specific higher layer signaling index. Other association rules/mapping relationships between the S_q1 NBI RS beam sets (and therefore, the NBI RSs configured therein) and the coordinating TRPs or the TRP-specific index/ID values in the multi-TRP system are also possible.

In one example of Option-I.B, the UE could be explicitly configured/indicated by the network the association rule(s)/mapping relationship(s) between the S_q1 NBI RS beam sets and the coordinating TRPs or the TRP-specific index/ID values in the multi-TRP system. For instance, the UE could be indicated by the network that the i-th NBI RS beam set or NBI RS beam set i or the NBI RS beam set with the i-th lowest set index/ID value (i∈{0, 1, . . . , S_q1−1}) is associated with/linked to the j-th lowest (or highest) TRP-specific index/ID value such as PCI or CORESETPoolIndex or the j-th entry in the higher layer configured list/set/pool of TRP-specific index/ID values (j∈{0, 1, . . . , N_trp−1}), where i could be different from j; further, this indication could be via higher layer (RRC) or/and MAC CE or/and DCI based signaling; this indication could be via a separate (dedicated) parameter or joint with another parameter. Other methods to indicate/configure the explicit association rule(s)/mapping relationship(s) between the S_q1 NBI RS beam sets and the coordinating TRPs or the higher layer configured TRP-specific index/ID values in the multi-TRP system are also possible.

In one example of Option-I.C, the UE could only be indicated by the network that the S_q1 NBI RS beam sets (and therefore, the NBI RSs configured therein) are for different coordinating TRPs or different TRP-specific index/ID values in the multi-TRP system, and are used for identifying one or more new beams for the TRP-specific/partial BFR; the UE could also be indicated by the network which NBI RS beam set(s) is associated with the same TRP or the same TRP-specific index/ID value; this indication could be via higher layer (RRC) or/and MAC CE or/and DCI based signaling; this indication could be via a separate (dedicated) parameter or joint with another parameter.

In one example of Option-I.D, the UE could be indicated by the network one or more TRP-specific index/ID values such as PCIs, CORESET index/ID values, CORESET group index/ID values or CORESETPoolIndex values along with the configuration of the NBI RS beam sets; this indication could be via higher layer (RRC) or/and MAC CE or/and DCI based signaling; this indication could be via a separate (dedicated) parameter or joint with another parameter. For instance, a TRP-specific index/ID value could be indicated in the parameter configuring NBI RS beam set. For S_q1=2, a first TRP-specific index/ID value such as PCI, CORESETPoolIndex, CORESET group index/ID or CORESET index/ID could be indicated in the parameter configuring q1-0, e.g., in the higher layer parameter candidateBeamRSList0, and a second TRP-specific index/ID value such as PCI, CORESET index/ID, CORESET group index/ID or CORESETPoolIndex could be indicated in the parameter configuring q1-1, e.g., in the higher layer parameter candidateBeamRSList1. For instance, for S_q1=2, CORESETPoolIndex value 0 could be indicated in the parameter configuring q1-0, e.g., in the higher layer parameter candidateBeamRSList0, and CORESETPoolIndex value 1 could be indicated in the parameter configuring q1-1, e.g., in the higher layer parameter candidateBeamRSList1. A NBI RS beam set is therefore associated with/linked to the TRP-specific index/ID value indicated in the parameter configuring the NBI RS beam set.

In one example of Option-II, the UE could be configured/indicated by the network two lists/NBI RS beam sets (S_q1=2), denoted by q1-0 and q1-1. The first NBI RS beam set q1-0 could contain at least one NBI RS and is used by the UE for identifying one or more new beams for the full cell-specific BFR. The second NBI RS beam set q1-1 could contain at least two NBI RSs and is used by the UE for identifying one or more new beams for the TRP-specific/partial BFR in a multi-TRP system. The configuration of the NBI RSs in the second NBI RS beam set q1-1, and therefore, the association between the NBI RSs in the second NBI RS beam set q1-1 and the coordinating TRPs or the TRP-specific index/ID values in the multi-TRP system, could follow those specified in Option-N.A, Option-N.B, Option-N.C or Option-N.D.

In another example, the UE could be configured/indicated by the network more than two lists/NBI RS beam sets (S_q1≥2). The first NBI RS beam set (e.g., with the lowest set ID/index) could contain at least one NBI RS and is used by the UE for identifying one or more new beams for the full cell-specific BFR. The remaining (S_q1−1) NBI RS beam sets each containing at least one NBI RS could be used by the UE for identifying one or more new beams for the TRP-specific/partial BFR in a multi-TRP system. The configuration of the remaining (S_q1−1) NBI RS beam sets, and therefore, the association between the remaining (S_q1−1) NBI RS beam sets and the coordinating TRPs or the TRP-specific index/ID values in the multi-TRP system, could follow those specified in Option-I.A, Option-I.B, Option-I.C or Option-I.D.

The UE could be first higher layer configured by the network (e.g., via higher layer RRC signaling) a set/list/pool of Ntot_q1 NBI RSs (and therefore, the corresponding Ntot_q1 SSB indexes or periodic 1-port or 2-port CSI-RS resource configuration indexes). The UE could receive from the network one or more MAC CE activation/subselection commands/bitmaps to update one or more NBI RSs (or equivalently, one or more SSB indexes or one or more periodic 1-port or 2-port CSI-RS resource configuration indexes) for one or more NBI RS beam sets.

For example, the UE could receive from the network a MAC CE activation/subselection command/bitmap to update one or more NBI RSs for NBI RS beam set k, where k∈{0, 1, . . . , S_q1−1}. The MAC CE activation/subselection command or bitmap could have Ntot_q1 entries/bit positions with each entry/bit position corresponding to a NBI RS in the set/list/pool of Ntot_q1 NBI RSs. If an entry/bit position in the MAC CE activation/subselection command or bitmap is set to ‘1’, the corresponding NBI RS (and therefore, the corresponding SSB index or periodic 1-port or 2-port CSI-RS resource configuration index) in the set/list/pool of Ntot_q1 NBI RSs could be included/incorporated in the NBI RS beam set k.

The MAC CE activation/subselection command/bitmap could include/contain/incorporate/comprise/indicate the set index/ID of the NBI RS beam set k, a TRP-specific index/ID value such as PCI, CORESETPoolIndex, CORESET ID/index, CORESETGroupIndex, and etc. associated with the NBI RS beam set k. Optionally, the MAC CE activation/subselection command/bitmap could include/contain/incorporate/comprise/indicate the set index/ID of the BFD RS beam set associated with the NBI RS beam set k. Alternatively, the MAC CE activation/subselection command/bitmap could include/contain/incorporate/comprise/indicate a one-bit flag/indicator for S_q1=2 NBI RS beam sets. For example, if the one-bit flag/indicator is set to ‘1’/‘on’/‘enabled’, the MAC CE activation/subselection command/bitmap is for the NBI RS beam set q1-0; otherwise, e.g., the one-bit flag/indicator is set to ‘0’/‘off’/‘disabled’, the MAC CE activation/subselection command/bitmap is for the NBI RS beam set q1-1. The MAC CE activation/subselection command/bitmap for updating the NBI RS(s) could the same as that for updating the BFD RS(s) as discussed above.

Any combinations of at least two of the above described design options (Option-N.A, Option-N.B, Option-N.C, Option-N.D, Option-I.A, Option-LB, Option-I.C, Option-I.D, and Option-II) or any other variations of the above described design options (Option-N.A, Option-N.B, Option-N.C, Option-N.D, Option-I.A, Option-I.B, Option-I.C, Option-I.D and Option-II) can be used for identifying one or more new beams for the cell (e.g., a PCell or a SpCell) and/or the failed TRP(s).

For example, the UE could be configured/indicated by the network a single NBI RS beam set (S_q1=1) containing at least three (N_q1≥3) NBI RSs via RRC or/and MAC CE or/and DCI based signaling; the NBI RSs in the configured NBI RS beam set could be used for identifying the new beam(s) for both the cell (e.g., a PCell or a SpCell) and the failed TRP(s). For another example, the UE could be configured/indicated by the network at least three NBI RS beam sets (S_q1≥3) each containing at least one (N_q1=1) NBI RS via RRC or/and MAC CE or/and DCI based signaling; the configured NBI RS beam sets could be used for identifying the new beam(s) for both the cell (e.g., a PCell or a SpCell) and the failed TRP(s).

For Option-I.A, Option-I.B, Option-I.C and Option-I.D, the NBI RSs in the S_q1 lists of NBI RSs/NBI RS beam sets could be mutually exclusive. For Option-II, the NBI RS(s) in the first list of NBI RS(s)/NBI RS beam set used for identifying the new beam(s) for the cell (e.g., a PCell or a SpCell) could be a superset of those configured in the remaining (S_q1−1) list(s) of NBI RS(s)/NBI RS beam set(s) used for identifying the new beam(s) for the failed TRP(s).

The UE could start to monitor the (TRP-specific) NBI RSs explicitly configured following Option-N or/and Option-I or/and Option-II as soon as they are configured by the network, e.g., via higher layer (RRC) or/and MAC CE or/and DCI based signaling. Alternatively, the UE could start to monitor the (TRP-specific) NBI RSs explicitly configured following Option-N or/and Option-I or/and Option-II as soon as the multi-TRP operation is activated by the network, e.g., via higher layer (RRC) or/and MAC CE or/and DCI based signaling. The UE could also start to monitor the (TRP-specific) NBI RSs explicitly configured following Option-N or/and Option-I or/and Option-II after the UE has sent to the network BFRQ(s) for one or more failed TRPs or/and the UE has received from the network the response to the BFRQ(s) or/and the UE has received from the network an indication to start monitoring the explicitly configured NBI RSs.

Furthermore, the UE could be indicated/configured by the network to stop monitoring the (TRP-specific) NBI RSs explicitly configured by the network following Option-N or/and Option-I or/and Option-II. If the multi-TRP operation is deactivated by the network, e.g., via higher layer (RRC) or/and MAC CE or/and DCI based signaling, the UE could also stop monitoring the (TRP-specific) NBI RSs explicitly configured by the network following Option-N or/and Option-I or/and Option-II. Alternatively, the UE could stop monitoring the (TRP-specific) NBI RSs explicitly configured by the network following Option-N or/and Option-I or/and Option-II after the UE has sent to the network the new beam information or/and the UE has received from the network the BFRR.

In one embodiment, various implicit TRP-specific/per TRP NBI RS configuration methods are provided.

If the UE is not configured by the network any NBI RS(s) via the above discussed explicit NBI RS configuration method(s)/option(s), the UE could determine a periodic 1-port or 2-port CSI-RS resource configuration index or SSB index indicated/configured as a QCL-TypeD (i.e., spatial quasi-co-location) source RS in an active TCI state for respective PDCCH reception as a NBI RS in a NBI RS beam set, e.g., q1. This is also known as implicit NBI RS configuration. The UE could measure the radio link qualities of the NBI RSs in the NBI RS beam set q1, and identify one or more new beams if the received signaling qualities are beyond a threshold.

For the multi-TRP operation, if the UE is not configured by the network any NBI RS(s) via the above discussed explicit NBI RS configuration method(s)/option(s), the UE could determine G_q1 (1≤G_q1≤maxG_q1) NBI RS beam sets (q1-0 and q1-1 for G_q1=2) each containing M_q1 (1≤M_q1≤maxM_q1) NBI RSs determined as periodic 1-port or 2-port CSI-RS resource configuration indexes or SSB indexes with same values as the QCL-TypeD source RS indexes indicated in active TCI states for PDCCH reception in respective CORESETs that the UE uses for monitoring the PDCCH(s), where maxG_q1 is the maximum number of NBI RS beam sets (e.g., maxG_q1=2 per BWP), which could be indicated/configured by the network to the UE via RRC or/and MAC CE or/and DCI based signaling or autonomously determined by the UE and reported to the network as a UE feature/capability signaling or both, and maxM_q1 is the maximum number of NBI RSs per NBI RS beam set (e.g., maxM_q1=3), which could be indicated/configured by the network to the UE via RRC or/and MAC CE or/and DCI based signaling or autonomously determined by the UE and reported to the network as a UE feature/capability signaling or both; M_q1 could be the same or different across the G_q1 NBI RS beam sets.

The G_q1 NBI RS beam sets and/or the M_q1 NBI RSs configured in each NBI RS beam set could be associated with/linked to different CORESETs configured with different higher layer signaling indices (such as the higher layer parameter CORESETPoolIndex) or associated with/linked to different coordinating TRPs or different TRP-specific index/ID values such as PCIs in the multi-TRP system.

In one example, the UE could use/determine a single NBI RS beam set (G_q1=1) q1 containing two NBI RSs (M_q1=2), denoted by NBI-RS-A and NBI-RS-B. The first NBI RS in the NBI RS beam set, i.e., NBI-RS-A, could be a periodic 1-port or 2-port CSI-RS resource configuration index or SSB index indicated/configured as the QCL-typeD source RS in an active TCI state for PDCCH reception in one CORESET configured/associated with ‘CORESETPoolIndex=0’, and the second NBI RS in the list/NBI RS beam set, i.e., NBI-RS-B, could be a periodic 1-port or 2-port CSI-RS resource configuration index or SSB index configured/indicated as a QCL-typeD source RS in an active TCI state for PDCCH reception in a CORESET configured/associated with ‘CORESETPoolIndex=1’.

Alternatively, the UE could be explicitly indicated by the network (e.g., via RRC or/and MAC CE or/and DCI based signaling) the association rule/mapping relationship between the determined NBI RS beam set(s)/NBI RS(s) and the CORESETs/coordinating TRPs/TRP-specific index/ID values such as PCIs. Optionally, the UE could autonomously determine the association rule/mapping relationship between the determined NBI RS beam set(s)/NBI RS(s) and the CORESETs/coordinating TRPs/TRP-specific index/ID values such as PCIs, and indicate to the network their determined association rule/mapping relationship. The mapping between the G_q1 NBI RS beam set(s) and/or the M_q1 NBI RS(s) in a configured NBI RS beam set and the CORESETs/TRPs/TRP-specific index/ID values such as PCIs could be fixed/deterministic per RRC configuration.

Various means of UE determining the NBI RSs/NBI RS beam sets and associating them with the CORESETs, TRPs or TRP-specific index/ID values in the multi-TRP system are presented as follows.

The UE could be explicitly indicated by the network about the association rule/mapping relationship between the employed NBI RS beam(s)/NBI RS(s) and the CORESETs/coordinating TRPs via RRC or/and MAC CE or/and DCI based signaling. Alternatively, the UE could autonomously determine the association rule/mapping relationship between the employed NBI RS beam(s)/NBI RS(s) and the CORESETs/coordinating TRPs, and indicate to the network their determined association rule/mapping relationship. The mapping between the G_q1 NBI RS beam set(s) and/or the M_q1 NBI RS(s) in a given NBI RS beam set and the CORESETs/TRPs could be fixed/deterministic per RRC configuration.

The UE could use/determine a single NBI RS beam set (G_q1=1) containing/including at least two (M_q1≥2) NBI RSs, which could respectively correspond to two periodic 1-port or 2-port CSI-RS resource configuration indexes or SSB indexes indicated/configured as QCL-typeD (i.e., spatial quasi-co-location) source RSs in the active TCI states for PDCCH reception in different CORESETs associated with different values of CORESETPoolIndex the UE uses for monitoring the PDCCHs.

In one example of Option-III.A, the first NBI RS or the NBI RS with the lowest resource index/ID value in the NBI RS beam set could correspond to a 1-port or 2-port periodic CSI-RS resource configuration index or SSB index indicated/configured as the QCL-typeD source RS in the active TCI state for PDCCH reception in one or more CORESETs configured/associated with the lowest value of CORESETPoolIndex that the UE uses for monitoring the PDCCH(s), the second NBI RS or the NBI RS with the second lowest resource index/ID value in the NBI RS beam set could correspond to a 1-port or 2-port periodic CSI-RS resource configuration index or SSB index indicated/configured as the QCL-typeD source RS in the active TCI state for PDCCH reception in one or more CORESETs associated with the second lowest value of CORESETPoolIndex that the UE uses for monitoring the PDCCH(s), and so on, and the last NBI RS or the NBI RS with the highest resource index/ID value in the NBI RS beam set could correspond to a 1-port or 2-port periodic CSI-RS resource configuration index and SSB index indicated/configured as the QCL-typeD source RS in the active TCI state for PDCCH reception in one or more CORESETs associated with the highest value of CORESETPoolIndex that the UE uses for monitoring the PDCCH(s).

Specifically, for M_q1=2, the first NBI RS or the NBI RS with the lower resource index/ID value in the NBI RS beam set could correspond to a 1-port or 2-port periodic CSI-RS resource configuration index or SSB index indicated/configured as the QCL-typeD source RS in the active TCI state for PDCCH reception in one or more CORESETs configured/associated with ‘CORESETPoolIndex=0’, and the second NBI RS or the NBI RS with the higher resource index/ID value in the NBI RS beam set could correspond to a 1-port or 2-port periodic CSI-RS resource configuration index or SSB index indicated/configured as the QCL-typeD source RS in the active TCI state for PDCCH reception in one or more CORESETs configured/associated with ‘CORESETPoolIndex=1’. Other association rules/mapping relationships between the M_q1 NBI RSs in the UE determined NBI RS beam set and the CORESETs associated with different values of CORESETPoolIndex are also possible.

The UE could use/determine a single NBI RS beam set (G_q1=1) containing/including at least two (M_q1≥2) NBI RSs, which could respectively correspond to two periodic 1-port or 2-port CSI-RS resource configuration indexes or SSB indexes indicated/configured as the QCL-typeD (i.e., spatial quasi-co-location) source RSs in the active TCI states for PDCCH reception in different CORESETs configured/associated with different values of a higher layer signaling index, defined as/denoted by CORESETGroupIndex, that the UE uses for monitoring the PDCCHs.

In one example of Option-III.B, the potential values for CORESETGroupIndex could be 0, 1, . . . , Nc−1, where Nc≥2, and the UE could be configured by the network the CORESETGroupIndex value(s) in the higher layer parameter configuring the corresponding CORESET(s)—e.g., in the higher layer parameter PDCCH-Config or ControlResourceSet.

In one example, the first NBI RS or the NBI RS with the lowest resource index/ID value in the NBI RS beam set could correspond to a periodic 1-port or 2-port CSI-RS resource configuration index or SSB index indicated/configured as the QCL-typeD source RS in the active TCI state for PDCCH reception in one or more CORESETs configured/associated with the lowest value of CORESETGroupIndex, the second NBI RS or the NBI RS with the second lowest resource index/ID value in the NBI RS beam set could correspond to a periodic 1-port or 2-port CSI-RS resource configuration index or SSB index indicated/configured as the QCL-typeD source RS in the active TCI state for PDCCH reception in one or more CORESETs configured/associated with the second lowest value of CORESETGroupIndex, and so on, and the last NBI RS or the NBI RS with the highest resource index/ID value in the NBI RS beam set could correspond to a periodic 1-port or 2-port CSI-RS resource configuration index or SSB index indicated/configured as the QCL-typeD source RS in the active TCI state for PDCCH reception in one or more CORESETs configured/associated with the highest value of CORESETGroupIndex.

For instance, for M_q1=2, the first NBI RS or the NBI RS with the lower resource index/ID value in the NBI RS beam set could correspond to a periodic 1-port or 2-port CSI-RS resource configuration index or SSB index indicated/configured as the QCL-typeD source RS in the active TCI state for PDCCH reception in one or more CORESETs configured/associated with ‘CORESETGroupIndex=0’, and the second NBI RS or the NBI RS with the higher resource index/ID value in the NBI RS beam set could correspond to a periodic 1-port or 2-port CSI-RS resource configuration index or SSB index indicated/configured as the QCL-typeD source RS in the active TCI state for PDCCH reception in one or more CORESETs configured/associated with ‘CORESETGroupIndex=1’. Other association rules/mapping relationships between the M_q1 NBI RSs in the UE determined NBI RS beam set and the CORESETs associated with different values of CORESETGroupIndex are also possible.

The UE could use/determine at least two NBI RS beam sets (G_q1≥2) each containing/including at least one (M_q1≥1) NBI RS to identify potential new beam(s). The NBI RS(s) included in the same NBI RS beam set could correspond to one or more periodic 1-port or 2-port CSI-RS resource configuration indexes or SSB indexes indicated/configured as the QCL-typeD (i.e., spatial quasi-co-location) source RS(s) in the active TCI state(s) for PDCCH reception in one or more CORESETs configured/associated with the same value of CORESETPoolIndex that the UE uses for monitoring the PDCCH(s), and the NBI RSs included in different NBI RS beam sets could correspond to periodic 1-port or 2-port CSI-RS resource configuration indexes or SSB indexes indicated/configured as the QCL-typeD (i.e., spatial quasi-co-location) source RSs in the active TCI states for PDCCH reception in different CORESETs associated with different values of CORESETPoolIndex.

In one example of Option-IV.A, the NBI RS(s) included in the first NBI RS beam set or the NBI RS beam set with the lowest set ID/index could correspond to one or more periodic 1-port or 2-port CSI-RS resource configuration indexes or SSB indexes indicated/configured as the QCL-typeD source RS(s) in the active TCI state(s) for PDCCH reception in one or more CORESETs configured/associated with the lowest value of CORESETPoolIndex that the UE uses for monitoring the PDCCH(s), the NBI RS(s) included in the second NBI RS beam set or the NBI RS beam set with the second lowest set ID/index could correspond to one or more periodic 1-port or 2-port CSI-RS resource configuration indexes or SSB indexes indicated/configured as the QCL-typeD source RS(s) in the active TCI state(s) for PDCCH reception in one or more CORESETs configured/associated with the second lowest value of CORESETPoolIndex that the UE uses for monitoring the PDCCH(s), and so on, and the NBI RS(s) included in the last NBI RS beam set or the NBI RS beam set with the highest set ID/index could correspond to one or more periodic 1-port or 2-port CSI-RS resource configuration indexes or SSB indexes indicated/configured as the QCL-typeD source RS(s) in the active TCI state(s) for PDCCH reception in one or more CORESETs configured/associated with the highest value of CORESETPoolIndex that the UE uses for monitoring the PDCCH(s).

That is, the NBI RS(s) included in the k-th NBI RS beam set or NBI RS beam set k or the NBI RS beam set with the k-th lowest (or highest) set index/ID could correspond to one or more periodic 1-port or 2-port CSI-RS resource configuration indexes or SSB indexes indicated/configured as the QCL-TypeD source RS(s) in the active TCI state(s) for PDCCH reception in one or more CORESETs configured/associated with CORESETPoolIndex value k that the UE uses for monitoring the PDCCH, where k=0, 1, . . . , G_q1−1.

Specifically, for G_q1=2, the NBI RS(s) included in the first NBI RS beam set q1-0 or the NBI RS beam set q1-0 with the lower set ID/index could correspond to one or more periodic 1-port or 2-port CSI-RS resource configuration indexes or SSB indexes indicated/configured as the QCL-typeD source RS(s) in the active TCI state(s) for PDCCH reception in one or more CORESETs configured/associated with ‘CORESETPoolIndex=0’ that the UE uses for monitoring the PDCCH(s), and the NBI RS(s) included in the second NBI RS beam set q1-1 or the NBI RS beam set q1-1 with the higher set ID/index could correspond to one or more periodic 1-port or 2-port CSI-RS resource configuration indexes or SSB indexes indicated/configured as the QCL-typeD source RS(s) in the active TCI state(s) for PDCCH reception in one or more CORESETs configured/associated with ‘CORESETPoolIndex=1’ that the UE uses for monitoring the PDCCH(s). Other association rules/mapping relationships between the UE determined G_q1 NBI RS beam sets (and therefore, the NBI RSs included therein) and the CORESETs associated with different values of CORESETPoolIndex are also possible.

In one example of Option-IV.B, the UE could use/determine two NBI RS beam sets (G_q1=2), denoted by q1-0 and q1-1. The first NBI RS beam set q1-0 or the NBI RS beam set q1-0 with the lower set index/ID could contain/include at least one NBI RS and is used by the UE for identifying one or more new beams for the full cell-specific BFR; the NBI RSs included in q1-0 could correspond to periodic 1-port or 2-port CSI-RS resource configuration indexes or SSB indexes indicated/configured as the QCL-typeD (i.e., spatial quasi-co-location) source RSs in the active TCI states for PDCCH reception in one or more CORESETs configured/associated with either the same value of CORESETPoolIndex or different values of CORESETPoolIndex that the UE uses for monitoring the PDCCHs.

The second NBI RS beam set q1-1 or the NBI RS beam set q1-1 with the higher set index/ID could contain/include at least two NBI RSs and is used by the UE for identifying one or more new beams for the TRP-specific/partial BFR in a multi-TRP system. The configuration of the NBI RSs in the NBI RS beam set q1-1, and therefore, the association between the NBI RSs in the NBI RS beam set q1-1 and different CORESETs associated with different values of CORESETPoolIndex, could follow those specified in Option-IV.A.

In another example, the UE could use more than two NBI RS beam sets (G_q1>2). The first NBI RS beam set (e.g., with the lowest set ID/index) could contain/include at least one NBI RS and is used by the UE for identifying one or more new beams for the full cell-specific BFR; the NBI RSs included in the first NBI RS beam set could correspond to periodic 1-port or 2-port CSI-RS resource configuration indexes or SSB indexes indicated/configured as the QCL-typeD (i.e., spatial quasi-co-location) source RSs in the active TCI states for PDCCH reception in one or more CORESETs configured/associated with either the same value of CORESETPoolIndex or different values of CORESETPoolIndex that the UE uses for monitoring the PDCCHs. The remaining (G_q1−1) NBI RS beam sets each containing at least one NBI RS could be used by the UE for identifying one or more new beams for the TRP-specific/partial BFR in a multi-TRP system. The configuration of the remaining (G_q1−1) NBI RS beam sets, and therefore, the association between the remaining (G_q1−1) NBI RS beam sets and different CORESETs associated with different values of CORESETPoolIndex, could follow those specified in Option-IV.A.

The UE could use/determine at least two NBI RS beam sets (G_q1≥2) each containing/including at least one (M_q1≥1) NBI RS to identify one or more new beams for beam failure recovery. The NBI RS(s) included in the same NBI RS beam set could correspond to one or more periodic 1-port or 2-port CSI-RS resource configuration indexes or SSB indexes indicated/configured as the QCL-typeD (i.e., spatial quasi-co-location) source RS(s) in the active TCI state(s) for PDCCH reception in one or more CORESETs configured/associated with the same value of a higher layer signaling index, defined as/denoted by CORESETGroupIndex, that the UE uses for monitoring the PDCCH(s), and the NBI RSs included in different NBI RS beam sets could correspond to periodic 1-port or 2-port CSI-RS resource configuration indexes or SSB indexes indicated/configured as the QCL-typeD (i.e., spatial quasi-co-location) source RSs in the active TCI states for PDCCH reception in different CORESETs associated with different values of CORESETGroupIndex.

In one example of Option-V.A, the potential values for CORESETGroupIndex could be 0, 1, . . . , Nc−1, where Nc≥2, and the UE could be configured by the network the CORESETGroupIndex value(s) in the higher layer parameter configuring the corresponding CORESET(s)—e.g., in the higher layer parameter PDCCH-Config or ControlResourceSet.

In one example, the NBI RS(s) included in the first NBI RS beam set or the NBI RS beam set with the lowest set ID/index could correspond to one or more periodic 1-port or 2-port CSI-RS resource configuration indexes or SSB indexes indicated/configured as the QCL-typeD source RS(s) in the active TCI state(s) for PDCCH reception in one or more CORESETs configured/associated with the lowest value of CORESETGroupIndex that the UE uses for monitoring the PDCCH(s), the NBI RS(s) included in the second NBI RS beam set or the NBI RS beam set with the second lowest set ID/index could correspond to one or more periodic 1-port or 2-port CSI-RS resource configuration indexes or SSB indexes indicated/configured as the QCL-typeD source RS(s) in the active TCI state(s) for PDCCH reception in one or more CORESETs configured/associated with the second lowest value of CORESETGroupIndex that the UE uses for monitoring the PDCCH(s), and so on, and the NBI RS(s) included in the last NBI RS beam set or the NBI RS beam set with the highest set ID/index could correspond to one or more periodic 1-port or 2-port CSI-RS resource configuration indexes or SSB indexes indicated/configured as the QCL-typeD source RS(s) in the active TCI state(s) for PDCCH reception in one or more CORESETs configured/associated with the highest value of CORESETGroupIndex that the UE uses for monitoring the PDCCH(s).

That is, the NBI RS(s) included in the k-th NBI RS beam set or NBI RS beam set k or the NBI RS beam set with the k-th lowest (or highest) set index/ID could correspond to one or more periodic 1-port or 2-port CSI-RS resource configuration indexes or SSB indexes indicated/configured as the QCL-TypeD source RS(s) in the active TCI state(s) for PDCCH reception in one or more CORESETs configured/associated with CORESETGroupIndex value k that the UE uses for monitoring the PDCCH, where k=0, 1, . . . , G_q1−1.

Specifically, for G_q1=2, the NBI RS(s) included in the first NBI RS beam set q1-0 or the NBI RS beam set q1-0 with the lower set ID/index could correspond to one or more periodic 1-port or 2-port CSI-RS resource configuration indexes or SSB indexes indicated/configured as the QCL-typeD source RS(s) in the active TCI state(s) for PDCCH reception in one or more CORESETs configured/associated with ‘CORESETGroupIndex=0’ that the UE uses for monitoring the PDCCH(s), and the NBI RS(s) included in the second NBI RS beam set q1-1 or the NBI RS beam set q1-1 with the higher set ID/index could correspond to one or more periodic 1-port or 2-port CSI-RS resource configuration indexes or SSB indexes indicated/configured as the QCL-typeD source RS(s) in the active TCI state(s) for PDCCH reception in one or more CORESETs configured/associated with ‘CORESETGroupIndex=1’ that the UE uses for monitoring the PDCCH(s). Other association rules/mapping relationships between the UE determined G_q1 NBI RS beam sets (and therefore, the NBI RSs included therein) and the CORESETs associated with different values of CORESETGroupIndex are also possible.

In one example of Option-V.B, the UE could use/determine two NBI RS beam sets (G_q1=2), denoted by q1-0 and q1-1. The first NBI RS beam set q1-0 or the NBI RS beam set q1-0 with the lower set index/ID could contain/include at least one NBI RS and is used by the UE for identifying one or more new beams for the full cell-specific BFR; the NBI RSs included in q1-0 could correspond to periodic 1-port or 2-port CSI-RS resource configuration indexes or SSB indexes indicated/configured as the QCL-typeD (i.e., spatial quasi-co-location) source RSs in the active TCI states for PDCCH reception in one or more CORESETs configured/associated with either the same value of CORESETGroupIndex or different values of CORESETGroupIndex that the UE uses for monitoring the PDCCHs.

The second NBI RS beam set q1-1 or the NBI RS beam set q1-1 with the higher set index/ID could contain/include at least two NBI RSs and is used by the UE for identifying one or more new beams for the TRP-specific/partial BFR in a multi-TRP system. The configuration of the NBI RSs in the NBI RS beam set q1-1, and therefore, the association between the NBI RSs in the NBI RS beam set q1-1 and different CORESETs associated with different values of CORESETGroupIndex, could follow those specified in Option-V.A.

In another example, the UE could use more than two NBI RS beam sets (G_q1>2). The first NBI RS beam set (e.g., with the lowest set ID/index) could contain/include at least one NBI RS and is used by the UE for identifying one or more new beams for the full cell-specific BFR; the NBI RSs included in the first NBI RS beam set could correspond to periodic 1-port or 2-port CSI-RS resource configuration indexes or SSB indexes indicated/configured as the QCL-typeD (i.e., spatial quasi-co-location) source RSs in the active TCI states for PDCCH reception in one or more CORESETs configured/associated with either the same value of CORESETGroupIndex or different values of CORESETGroupIndex that the UE uses for monitoring the PDCCHs. The remaining (G_q1−1) NBI RS beam sets each containing at least one NBI RS could be used by the UE for identifying one or more new beams for the TRP-specific/partial BFR in a multi-TRP system. The configuration of the remaining (G_q1−1) NBI RS beam sets, and therefore, the association between the remaining (G_q1−1) NBI RS beam sets and different CORESETs associated with different values of CORESETGroupIndex, could follow those specified in Option-V.A.

In one embodiment, various methods of measuring explicitly/implicitly configured TRP-specific/per TRP NBI RS(s) are provided.

The physical layer in the UE assesses the radio link quality of the NBI RSs corresponding to the SSBs on the PCell or the PSCell or periodic 1-port or 2-port CSI-RS resource configurations. As aforementioned, if the UE is not provided by the network any NBI RS(s) via the explicit NBI RS configuration method(s)/option(s), the UE could implicitly determine the NBI RS(s) and assess the radio link quality of the NBI RS(s) for new beam(s) identification. Alternatively, regardless whether the UE is provided by the network NBI RS(s) via the explicit NBI RS configuration method(s)/option(s) or not, the UE could still implicitly determine the NBI RS(s) based on the above discussed design method(s)/option(s). In this case, the UE could assess the ratio link quality of the explicitly configured NBI RS(s) or the implicitly determined NBI RS(s) based on network configuration or a UE's capability/feature signaling. Various means of measuring the explicitly or implicitly configured NBI RSs and assessing their corresponding radio link quality are presented as follows.

The UE could be configured/indicated by the network to measure the explicitly configured NBI RSs (configured via, e.g., Option-N, Option-I or/and Option-II), or the implicitly configured NBI RSs (configured via, e.g., Option-III, Option-IV or/and Option-V), or both of the explicitly and implicitly configured NBI RSs, for new beam(s) identification; this indication could be via higher layer (RRC) or/and MAC CE or/and DCI based signaling; this indication could be via a separate (dedicated) parameter or joint with another parameter.

In one example, the UE could be configured/indicated by the network to measure only the explicitly configured NBI RSs; the explicit NBI RS configuration could follow one or more of Option-N.A, Option-N.B, Option-N.C, Option-I.A, Option-I.B, Option-I.C and Option-II, or one or more combinations of at least two of Option-N.A, Option-N.B, Option-N.C, Option-N.D, Option-I.A, Option-I.B, Option-I.C, Option-I.D and Option-II, or variation(s) of Option-N.A, Option-N.B, Option-N.C, Option-N.D, Option-I.A, Option-LB, Option-I.C, Option-I.D and/or Option-II.

In another example, the UE could be configured/indicated by the network to measure only the implicitly configured NBI RSs; the implicit NBI RS configuration could follow one or more of Option-III.A, Option-III.B, Option-IV.A, Option-IV.B, Option-V.A and Option-V.B, or one or more combinations of at least two of Option-III.A, Option-III.B, Option-IV.A, Option-IV.B, Option-V.A and Option-V.B, or variation(s) of Option-III.A, Option-III.B, Option-IV.A, Option-IV.B, Option-V.A and Option-V.B.

In yet another example, the UE could be configured/indicated by the network to measure both the explicitly configured and the implicitly configured NBI RSs; the explicit NBI RS configuration could follow one or more of Option-N.A, Option-N.B, Option-N.C, Option-N.D, Option-I.A, Option-I.B, Option-I.C, Option-I.D and Option-II, or one or more combinations of at least two of Option-N.A, Option-N.B, Option-N.C, Option-N.D, Option-I.A, Option-I.B, Option-I.C, Option-I.D and Option-II, or variation(s) of Option-N.A, Option-N.B, Option-N.C, Option-N.D, Option-I.A, Option-I.B, Option-I.C, Option-I.D and/or Option-II; the implicit NBI RS configuration could follow one or more of Option-III.A, Option-III.B, Option-IV.A, Option-IV.B, Option-V.A and Option-V.B, or one or more combinations of at least two of Option-III.A, Option-III.B, Option-IV.A, Option-IV.B, Option-V.A and Option-V.B, or variation(s) of Option-III.A, Option-III.B, Option-IV.A, Option-IV.B, Option-V.A and Option-V.B.

The UE could also send to the network indication(s) regarding how they would like to measure the explicitly configured NBI RSs and/or the implicitly configured NBI RSs for potential beam failure(s) detection in a multi-TRP system.

In one example, the UE could indicate to the network that the UE would like to measure only the explicitly configured NBI RSs (e.g., via Option-N.A, Option-N.B, Option-N.C, Option-N.D, Option-I.A, Option-LB, Option-I.C, Option-I.D and/or Option-II) for potential beam failure(s) detection.

In another example, the UE could indicate to the network that the UE would like to measure only the implicitly configured NBI RSs (e.g., via Option-III.A, Option-III.B, Option-IV.A, Option-IV.B, Option-V.A and/or Option-V.B) for potential beam failure(s) detection.

In yet another example, the UE could indicate to the network that the UE could measure both the explicitly configured NBI RSs (e.g., via Option-N.A, Option-N.B, Option-N.C, Option-N.D, Option-LA, Option-LB, Option-LC, Option-LD and/or Option-II) and the implicitly configured NBI RSs (e.g., via Option-III.A, Option-III.B, Option-IV.A, Option-IV.B, Option-V.A and/or Option-V.B) for potential beam failure(s) detection.

In yet another example, the UE could indicate to the network their preferred explicit NBI RS configuration method(s) (e.g., from Option-N.A, Option-N.B, Option-N.C, Option-N.D, Option-I.A, Option-LB, Option-LC, Option-LD and Option-II).

In yet another example, the UE could indicate to the network their preferred implicit NBI RS configuration method(s) (e.g., from via Option-III.A, Option-III.B, Option-IV.A, Option-IV.B, Option-V.A and/or Option-V.B).

In yet another example, the UE could send to the network an indication to trigger the explicit configuration(s) of the NBI RS(s); the UE could also send to the network indication(s) about increasing or reducing the time-frequency resource density (e.g., the periodicity) of the explicitly configured NBI RS(s).

In one embodiment, various methods of association/mapping between TRP-specific/per TRP BFD RS(s)/BFD RS beam set(s) and TRP-specific/per TRP NBI RS(s)/NBI RS beam set(s) are provided.

The UE may need to know the mapping relationship(s)/association rule(s) between the TRP-specific/per TRP BFD RS(s)/BFD RS beam set(s) and the TRP-specific/per TRP NBI RS(s)/NBI RS beam set(s) so that after the UE has declared beam failure(s) for one or more BFD RSs/BFD RS beam sets, the UE could measure the corresponding/associated NBI RSs/NBI RS beam sets to identify one or more new beams for the failed TRP(s). The UE could be explicitly indicated by the network the mapping relationship(s)/association rule(s) between the TRP-specific/per TRP BFD RS(s)/BFD RS beam set(s) and the TRP-specific/per TRP NBI RS(s)/NBI RS beam set(s); this indication could be via higher layer (RRC) or/and MAC CE or/and DCI based signaling; this indication could be via a separate (dedicated) parameter or joint with another parameter.

In one example, the UE could be indicated by the network that a NBI RS with resource ID/index #p in a NBI RS beam set (p∈{0, 1, . . . , N_q1−1}) is associated with/mapped to a BFD RS with resource ID/index #q in a BFD RS beam set (q∈{0, 1, . . . , N_q0−1}), where N_q1 represents the total number of NBI RSs in the NBI RS beam set and N_q0 is the total number of BFD RSs in the BFD RS beam set.

In another example, the UE could be indicated by the network that a NBI RS beam set (and therefore, the NBI RS(s) included/configured therein) with set ID/index #p (p∈{0, 1, . . . , S_q1−1}) is associated with/mapped to a BFD RS beam set (and therefore, the BFD RS(s) included/configured therein) with set ID/index #q (q∈{0, 1, . . . , S_q0−1}), where S_q1 represents the total number of NBI RS beam sets and S_q0 is the total number of BFD RS beam sets.

Alternatively, the mapping relationship(s)/association rule(s) between the TRP-specific/per TRP BFD RS(s)/BFD RS beam set(s) and the TRP-specific/per TRP NBI RS(s)/NBI RS beam set(s) could be fixed (e.g., in the system specifications) and/or known to the UE in an implicit manner.

In one example, a NBI RS in a NBI RS beam set is one-to-one mapped to/associated with a BFD RS in a BFD RS beam set if they have the same resource ID/index in the set. For example, a NBI RS with resource ID/index #p in a NBI RS beam set (p∈{0, 1, . . . , N_q1−1}) is associated with/mapped to a BFD RS with resource ID/index #p in a BFD RS beam set (p∈{0, 1, . . . , N_q0−1}), where N_q1 represents the total number of NBI RSs in the NBI RS beam set and N_q0 is the total number of BFD RSs in the BFD RS beam set. For N_q1=N_q0=2, the first NBI RS or the NBI RS with resource ID/index 1 in the NBI RS beam set is associated with/mapped to the first BFD RS or the BFD RS with resource ID/index 1 in the BFD RS beam set, and the second NBI RS or the NBI RS with resource ID/index 2 in the NBI RS beam set is associated with/mapped to the second BFD RS or the BFD RS with resource ID/index 2 in the BFD RS beam set.

In another example, a NBI RS in a NBI RS beam set is one-to-one mapped to/associated with a BFD RS in a BFD RS beam set if they are associated with the same TRP-specific index/ID value such as PCI, TRP ID and etc.; the association between the NBI RS(s) and the TRP-specific index/ID value(s) such as PCI, TRP ID and etc. could follow those described in Option-N.A; the association between the BFD RS(s) and the TRP-specific index/ID value(s) such as PCI, TRP ID and etc. could follow those described in Option-0.A.

In yet another example, a NBI RS in a NBI RS beam set is one-to-one mapped to/associated with a BFD RS in a BFD RS beam set if they are associated with the same value of CORESETPoolIndex/CORESETGroupIndex; the association between the NBI RS(s) and the CORESETPoolIndex/CORESETGroupIndex value(s) could follow those described in Option-III.A and Option-III.B; the association between the BFD RS and the CORESETPoolIndex/CORESETGroupIndex value(s) could follow those described in Option-3.A and Option-3.B.

In yet another example, a NBI RS beam set (and therefore, the NBI RS(s) configured/included therein) is one-to-one mapped to/associated with a BFD RS beam set (and therefore, the BFD RS(s) configured/included therein) if they have the same set ID/index. For example, a NBI RS beam set with set ID/index #p (p∈{0, 1, . . . , S_q1−1}) is associated with/mapped to a BFD RS beam set with set ID/index #p (p∈{0, 1, . . . , S_q0−1}), where S_q1 represents the total number of NBI RS beam sets and S_q0 is the total number of BFD RS beam sets. For S_q1=S_q0=2, the first NBI RS beam set q1-0 or the NBI RS beam set q1-0 with set ID/index 1 is associated with/mapped to the first BFD RS beam set q0-0 or the BFD RS beam set q0-0 with set ID/index 1, and the second NBI RS beam set q1-1 or the NBI RS beam set q1-1 with set ID/index 2 is associated with/mapped to the second BFD RS beam set q0-1 or the BFD RS beam set q0-1 with set ID/index 2.

In yet another example, a NBI RS beam set (and therefore, the NBI RS(s) included/configured therein) is one-to-one mapped to/associated with a BFD RS beam set (and therefore, the BFD RS(s) included/configured therein) if they are associated with the same TRP-specific index/ID value such as PCI, TRP ID and etc.; the association between the NBI RS beam set(s) and TRP-specific index/ID value(s) such as PCI, TRP ID and etc. could follow those described in Option-I.A; the association between the BFD RS beam set(s) and the TRP-specific index/ID value(s) such as PCI, TRP ID and etc. could follow those described in Option-1.A.

In yet another example, a NBI RS beam set (and therefore, the NBI RS(s) configured/included therein) is one-to-one mapped to/associated with a BFD RS beam set (and therefore, the BFD RS(s) configured/included therein) if they are associated with the same value of CORESETPoolIndex/CORESETGroupIndex; the association between the NBI RS beam set(s) and the CORESETPoolIndex/CORESETGroupIndex value(s) could follow those described in Option-IV.A and Option-IV.B; the association between the BFD RS beam set(s) and the CORESETPoolIndex/CORESETGroupIndex value(s) could follow those described in Option-IV.A and Option-IV.B. For instance, for S_q0=S_q1=2, the NBI RS beam set q1-0 associated with CORESETPoolIndex value of 0 is one-to-one mapped to/associated with the BFD RS beam set q0-0 associated with CORESETPoolIndex value of 0, and the NBI RS beam set q1-1 associated with CORESETPoolIndex value of 1 is one-to-one mapped to/associated with the BFD RS beam set q0-1 associated with CORESETPoolIndex value of 1.

In yet another example, the parameter configuring a BFD RS beam set could include/indicate a NBI RS beam set index/ID. For instance, the higher layer parameter beamFailureDetectionResourceList0 configuring the BFD RS beam set q0-0 could include/indicate a NBI RS beam set index/ID, e.g., set index/ID of the NBI RS beam set q1-0, and/or the higher layer parameter beamFailureDetectionResourceList1 configuring the BFD RS beam set q0-1 could also include/indicate a NBI RS beam set index/ID, e.g., set index/ID of the NBI RS beam set q1-1. A BFD RS beam set is one-to-one associated with/mapped to a NBI RS beam set if the set index/ID of the NBI RS beam set is indicated/included in the parameter configuring the BFD RS beam set.

In yet another example, the parameter configuring a NBI RS beam set could include/indicate a BFD RS beam set index/ID. For instance, the higher layer parameter candidateBeamRSList0 configuring the NBI RS beam set q1-0 could include/indicate a BFD RS beam set index/ID, e.g., set index/ID of the BFD RS beam set q0-0, and/or the higher layer parameter candidateBeamRSList1 configuring the NBI RS beam set q1-1 could also include/indicate a BFD RS beam set index/ID, e.g., set index/ID of the BFD RS beam set q0-1. A NBI RS beam set is one-to-one associated with/mapped to a BFD RS beam set if the set index/ID of the BFD RS beam set is indicated/included in the parameter configuring the NBI RS beam set.

In one embodiment, various TRP-specific/per TRP new beam identification methods for multi-TRP BFR are provided.

If the UE declares beam failure for the BFD RS beam set k (e.g., k∈{0, 1, . . . , S_q0−1})—the maximum number of BFI count associated with/corresponding to the BFD RS beam set k is reached before the BFD timer associated with/corresponding to the BFD RS beam set k expires, the physical layer in the UE could evaluate/assess the radio link quality for one or more NBI RSs (or equivalently, one or more SSBs on the PCell or the PSCell or one or more periodic 1-port or 2-port CSI-RS resource configurations) configured/included in the NBI RS beam set associated with/corresponding to the BFD RS beam set k (e.g., the NBI RS beam set k) against a BFR threshold. The value(s) of the BFR threshold(s) could be: (1) fixed in the system specifications, (2) based on network's configuration, e.g., the UE could be higher layer RRC configured by the network one or more TRP-specific/per TRP BFR thresholds, and (3) autonomously determined by the UE and reported to the network as a UE capability/feature signaling.

In one example, the physical layer in the UE could assess the radio link quality for one or more NBI RSs (or equivalently, one or more SSBs on the PCell or the PSCell or one or more periodic 1-port or 2-port CSI-RS resource configurations) configured/included in a NBI RS beam set (e.g., the NBI RS beam set k associated with/corresponding to the failed BFD RS beam set k) against a common BFR threshold. For Option-N.A, Option-N.B, Option-N.C, Option-N.D, Option-III.A and Option-III.B in the present disclosure, the radio link quality is evaluated/assessed by the physical layer in the UE for at least one NBI RS in the NBI RS beam set. For Option-I.A, Option-I.B, Option-I.C, Option-I.D, Option-II, Option-IV.A, Option-IV.B, Option-V.A and Option-V.B in the present disclosure, the radio link quality is evaluated/assessed by the physical layer in the UE for all the NBI RSs in the NBI RS beam set.

In another example, the physical layer in the UE could assess the radio link quality for one or more NBI RSs (or equivalently, one or more SSBs on the PCell or the PSCell or one or more periodic 1-port or 2-port CSI-RS resource configurations) configured/included in a NBI RS beam set (e.g., the NBI RS beam set k associated with/corresponding to the failed BFD RS beam set k) against a BFR threshold associated with/corresponding to the NBI RS beam set.

For Option-N.A, Option-N.B, Option-N.C, Option-N.D, Option-III.A and Option-III.B in the present disclosure, the radio link quality is evaluated/assessed by the physical layer in the UE for at least one NBI RS in the NBI RS beam set. Specifically, for Option-N.A, Option-N.B, Option-N.C and Option-N.D, the UE could assess the radio link quality for the n-th NBI RS or NBI RS n or the NBI RS with the n-th lowest (or highest) resource index/ID in the single NBI RS beam set against the BFR threshold Qin-n, where n∈{0, 1, . . . , N_q1−1}. Furthermore, for Option-III.A and Option-III.B, the UE could assess the radio link quality for the m-th NBI RS or NBI RS m or the NBI RS with the m-th lowest (or highest) resource index/ID in the single NBI RS beam set against the BFR threshold Qin-m, where m∈{0, 1, . . . , N_q1−1}. Different BFR thresholds could be all equal, i.e., correspond to a common value.

For Option-I.A, Option-LB, Option-I.C, Option-I.D, Option-II, Option-IV.A, Option-IV.B, Option-V.A and Option-V.B in the present disclosure, the radio link quality is evaluated/assessed by the physical layer in the UE for one or more of the NBI RSs in a NBI RS beam set. Specifically, for Option-I.A, Option-I.B, Option-I.C, Option-I.D and Option-II, the UE could assess the ratio link quality for one or more of the NBI RSs included/configured in the k-th NBI RS beam set or NBI RS beam set k or the NBI RS beam set with the k-th lowest (or highest) set index/ID value against BFR threshold Qin-k, where k∈{0, 1, . . . , S_q1−1}.

Furthermore, for Option-IV.A, Option-IV.B, Option-V.A and Option-V.B, the UE could assess the radio link quality for one or more of the NBI RSs configured/included in the 1-th NB RS beam set or NBI RS beam set 1 or the NBI RS beam set with the 1-th lowest (or highest) set index/ID value against the BFR threshold Qin-1, where l∈{0, 1, . . . , G_q1−1}. For instance, for S_q1/G_q1=2, the physical layer in the UE could evaluate/assess the radio link quality for one or more of the NBI RSs (or equivalently, the corresponding SSBs on the PCell or the PSCell or the corresponding periodic 1-port or 2-port CSI-RS resource configurations) configured/included in the NBI RS beam set q1-0 against the BFD threshold Qin-0, or the radio link quality for one or more of the NBI RSs (or equivalently, the corresponding SSBs on the PCell or the PSCell or the corresponding periodic 1-port or 2-port CSI-RS resource configurations) configured/included in the NBI RS beam set q1-1 against the BFR threshold Qin-1. Different BFR thresholds could be all equal. For instance, Qin-0 could be equal to Qin-1 (i.e., Qin-0=Qin-1) for S_q1/G_q1=2.

In the present disclosure, the radio link quality for a NBI RS corresponding to a SSB could correspond to a L1 based beam metric/measurement such as a L1-RSRP measurement or a L1-SINR measurement. The radio link quality for a NBI RS corresponding to a periodic 1-port or 2-port CSI-RS resource configuration could correspond to a L1 based beam metric/measurement such as a L1-RSRP measurement or a L1-SINR measurement after scaling a respective CSI-RS reception power with a value provided by the higher layer parameter powerControlOffsetSS. A BFR threshold could correspond to the default value of rlmInSyncOutOfSyncThreshold for Qout, and/or to the value provided by the higher layer parameter rsrp-ThresholdBFR.

Upon request from higher layers, the UE could indicate to higher layers whether there is at least one NBI RS corresponding to periodic CSI-RS resource configuration index or SSB index from a NBI RS beam set—associated with/corresponding to a BFD RS beam set indicated from higher layers whose associated maximum number of BFI count is reached before the associated BFD timer expires—with corresponding radio link qualities (such as L1-RSRP measurements) that are larger than or equal to a BFR threshold, and provide to higher layers the resource indexes/IDs of the NBI RSs corresponding to periodic CSI-RS resource configuration indexes or SSB indexes from the NBI RS beam set and the corresponding radio link qualities (such as L1-RSRP measurements) that are larger than or equal to the BFR threshold (if any), and optionally provide to higher layers the set index/ID of the NBI RS beam set.

For example, for S_q1/G_q1=2 in Option-I.A, Option-I.B, Option-I.C, Option-I.D and Option-II, Option-IV.A, Option-IV.B, Option-V.A and Option-V.B in the present disclosure, if physical layer in the UE is indicated by the higher layers that the BFD RS beam set q0-0 (or q0-1) is failed meaning that the maximum number of BFI count associated with q0-0 (or q0-1) is reached before the BFD timer associated with q0-0 (or q0-1) expires, the UE could indicate to higher layers whether there is at least one NBI RS corresponding to periodic CSI-RS resource configuration index or SSB index from the NBI RS beam set q1-0 (or q1-1)—associated with/corresponding to the failed BFD RS beam set q0-0 (or q0-1) indicated from higher layers via the set index/ID—with corresponding radio link qualities (such as L1-RSRP measurements) that are larger than or equal to the BFR threshold Qin-0 (or Qin-1), and provide to higher layers the resource indexes/IDs of the NBI RSs corresponding to periodic CSI-RS resource configuration indexes or SSB indexes from the NBI RS beam set q1-0 (or q1-1) and the corresponding radio link qualities (such as L1-RSRP measurements) that are larger than or equal to the BFR threshold Qin-0 (or Qin-1)—if any, and optionally provide to higher layers the set index/ID of the NBI RS beam set q1-0 (or q1-1).

As aforementioned, the resource index/ID of a NBI RS could correspond to the periodic CSI-RS resource configuration index or SSB index from the corresponding NBI RS beam set. That is, the resource index/ID of a NBI RS is determined based on/according to all the CSI-RS resource configuration indexes or SSB indexes configured/included in the corresponding NBI RS beam set. For instance, the resource index/ID of the m-th NBI RS or NBI RS m in NBI RS beam set k (e.g., k∈{0, 1, . . . , S_q1−1}) comprising a total of N_q1 NBI RSs corresponding to N_q1 periodic CSI-RS resource configuration indexes or SSB indexes is m∈{0, 1, . . . , N_q1−1}.

Alternatively, the resource index/ID of a NBI RS could be determined based on/according to all the NBI RSs (and therefore, all the corresponding periodic CSI-RS resource configuration indexes or SSB indexes) configured/included in all S_q1 NBI RS beam sets each comprising a total of N_q1 NBI RSs corresponding to N_q1 periodic CSI-RS resource configuration indexes or SSB indexes. For instance, the resource index/ID of the m-th NBI RS or NBI RS m in NBI RS beam set k (e.g., k∈{0, 1, . . . , S_q1−1}) is (k−1)N_q1+m, where m∈{0, 1, . . . , N_q1−1}.

In TABLE 3, an example characterizing the configuration(s) of the TRP-specific/per TRP parameters such as BFD RS beam set, NBI RS beam set, BFD timer, BFD threshold and etc. for the multi-TRP BFR is presented. Two TRPs, TRP-1 and TRP-2, are assumed in this example, with each TRP corresponding to/associated with a separate set of parameters for potential beam failure(s) detection and new beam(s) identification.

TABLE 3
TRP-specific/per TRP BFD/BFR parameters

| | TRP-1 | TRP-2 |
|---|---|---|
| BFD RS beam set | q0-0 | q0-1 |
| NBI RS beam set | q1-0 | q1-1 |
| Maximum number | MaxBFIcount-0 | MaxBFIcount-1 |
| of BFI count | | |
| BFD timer | BFDtimer-0 | BFDtimer-1 |
| BFR timer | BFRtimer-0 | BFRtimer-1 |
| BFD threshold | Qout-0 | Qout-1 |
| BFR threshold | Qin-0 | Qin-1 |

In one embodiment, various methods of configuring and transmitting TRP-specific/per TRP beam failure recovery request for multi-TRP BFR are provided.

The UE could be higher layer configured by the network one or more (up to maxNpucch) PUCCH resources and one or more (up to maxNsri) spatial settings for a PUCCH (e.g., via the higher layer parameter PUCCH-SpatialRelationInfo) to transmit scheduling request (SR) for BFR. The UE could be higher layer configured by the network (e.g., via higher layer RRC signaling) the maximum number of PUCCH resources maxNpucch (e.g., maxNpucch=2) and/or the maximum number of spatial settings maxNsri (e.g., maxNsri=2) for sending the BFRQ.

The configured PUCCH resource(s) and/or the corresponding spatial setting(s) could be associated with one or more BFD RSs/BFD RS beam sets. For example, after the UE has declared beam failure(s) for one or more BFD RSs/BFD RS beam sets, the UE could employ/use the PUCCH resource(s) and/or the corresponding spatial setting(s) associated with the failed BFD RS(s)/BFD RS beam set(s) to send the BFRQ; for another example, after the UE has declared beam failure(s) for one or more BFD RSs/BFD RS beam sets, the UE could employ/use the PUCCH resource(s) and/or the corresponding spatial setting(s) associated with BFD RS(s)/BFD RS beam set(s) other than the failed BFD RS(s)/BFD RS beam set(s); alternatively, the UE could be indicated by the network which PUCCH resource(s) and/or spatial setting(s) to use to send the BFRQ. As aforementioned, a BFD RS or a BFD RS beam set is a failed BFD RS or a failed BFD RS beam set if their associated maximum number of BFI count is achieved/reached before their associated BFD timer expires.

In one embodiment, a single PUCCH resource is configured to transmit the SR for BFR.

The UE could be configured by the network a single PUCCH resource, e.g., by a single SR ID schedulingRequestID-BFR, to transmit the SR for BFR (PUCCH-SR-BFR). For the configured PUCCH resource, the UE could be configured by the network one or more spatial settings (e.g., via the higher layer parameter PUCCH-SpatialRelationInfo). The spatial setting(s) could be associated with one or more BFD RSs/BFD RS beam sets.

In one example of Configuration-1, the UE could be configured by the network a single PUCCH resource with a single spatial setting (e.g., via the layer parameter PUCCH-SpatialRelationInfo with a single value of PUCCH-SpatialRelationInfoId) to transmit the SR for BFR.

In one example of Configuration-2, the UE could be configured by the network a single PUCCH resource with more than one (Nsri>1) spatial settings (e.g., via the higher layer parameter PUCCH-SpatialRelationInfo with more than one values of PUCCH-SpatialRelationInfoId). Each spatial setting is associated with one or more BFD RSs in a BFD RS beam set. For example, the first spatial setting or the spatial setting with the lowest PUCCH-SpatialRelationInfoId value could be associated with the first BFD RS or the BFD RS with the lowest resource ID/index in the BFD RS beam set, the second spatial setting or the spatial setting with the second lowest PUCCH-SpatialRelationInfoId value could be associated with the second BFD RS or the BFD RS with the second lowest resource ID/index in the BFD RS beam set, and so on, and the last (Nsri-th) spatial setting or the spatial setting with the highest PUCCH-SpatialRelationInfoId value could be associated with the last BFD RS or the BFD RS with the highest resource ID/index in the BFD RS beam set. Other association rules/mapping relationships between the configured spatial settings for the PUCCH resource and the BFD RSs in the BFD RS beam set are also possible.

In one example of Configuration-3, the UE could be configured by the network a single PUCCH resource with more than one (Nsri>1) spatial settings (e.g., via the higher layer parameter PUCCH-SpatialRelationInfo with more than one values of PUCCH-SpatialRelationInfoId). Each spatial setting is associated with one or more BFD RS beam sets. For example, the first spatial setting or the spatial setting with the lowest PUCCH-SpatialRelationInfoId value could be associated with the first BFD RS beam set or the BFD RS beam set with the lowest set ID/index, the second spatial setting or the spatial setting with the second lowest PUCCH-SpatialRelationInfoId value could be associated with the second BFD RS beam set or the BFD RS beam set with the second lowest set ID/index, and so on, and the last (Nsri-th) spatial setting or the spatial setting with the highest PUCCH-SpatialRelationInfoId value could be associated with the last BFD RS beam set or the BFD RS beam set with the highest set ID/index.

For instance, for a total of two BFD RS beam sets (S_q0/G_q0=2) and Nsri=2, the first spatial setting or the spatial setting with the lower PUCCH-SpatialRelationInfoId could be associated with the first BFD RS beam set q0-0 or the BFD RS beam set q0-0 with the lower set index/ID, and the second spatial setting or the spatial setting with the higher PUCCH-SpatialRelationInfoId could be associated with the second BFD RS beam set q0-1 or the BFD RS beam set q0-1 with the higher set index/ID. Other association rules/mapping relationships between the configured spatial settings for the PUCCH resource and the BFD RS beam sets are also possible.

After the UE has declared beam failure(s) for one or more BFD RSs in the BFD RS beam set or one or more BFD RS beam sets, the UE could transmit the SR for BFR on the PUCCH resource with one or more spatial settings.

In one embodiment of Method-1 for Configuration-1, after the UE has declared beam failure(s) for one or more BFD RSs in the BFD RS beam set or one or more BFD RS beam sets, the UE could transmit the SR for BFR on the configured PUCCH resource with the configured spatial setting.

In one embodiment of Method-2 for Configuration-2, various design options of configuring and transmitting the SR for BFR after the UE has declared beam failure(s) for one or more BFD RSs in the BFD RS beam set are presented as follows.

In one example, the UE could be indicated by the network to transmit the SR for BFR on the configured PUCCH resource with the spatial setting associated with the (failed) BFD RS(s) in the BFD RS beam set; this indication could be via higher layer (RRC) or/and MAC CE or/and DCI based signaling; this indication could be via a separate (dedicated) parameter or joint with another parameter.

Alternatively, the UE could autonomously decide to transmit the SR for BFR on the configured PUCCH resource with the spatial setting associated with the (failed) BFD RS(s) in the BFD RS beam set; in this case, the UE could also indicate to the network their decision/preference. For instance, for Nsri=2, assume that the first spatial setting or the spatial setting with the lower ID value is associated with the (failed) BFD RS(s) in the BFD RS beam set. Based on the network's indication, the UE could transmit the SR for BFR on the configured PUCCH resource with the first spatial setting or the spatial setting with the lower ID value.

In another example, the UE could be indicated by the network to transmit the SR for BFR on the configured PUCCH resource with a spatial setting different from the spatial setting associated with the (failed) BFD RS(s) in the BFD RS beam set; the UE could also be indicated by the network which spatial setting to use; these indications could be via higher layer (RRC) or/and MAC CE or/and DCI based signaling; these indications could be via separate (dedicated) parameters or joint with another parameter. Alternatively, the UE could autonomously decide to transmit the SR for BFR on the configured PUCCH resource with a spatial setting different from the spatial setting associated with the (failed) BFD RS(s) in the BFD RS beam set; the UE could also autonomously decide which spatial setting to use; in this case, the UE could indicate to the network their decision/preference. For instance, for Nsri=2, assume that the first spatial setting or the spatial setting with the lower ID value is associated with the (failed) BFD RS(s) in the BFD RS beam set. Based on the network's indication, the UE could transmit the SR for BFR on the configured PUCCH resource with the second spatial setting or the spatial setting with the higher ID value.

In yet another example, the UE could be indicated by the network which spatial setting(s) to use for sending the BFRQ on the configured PUCCH resource regardless how the spatial setting(s) is associated with the (failed) BFD RS(s) in the BFD RS beam set; this indication could be via higher layer (RRC) or/and MAC CE or/and DCI based signaling; this indication could be via a separate (dedicated) parameter or joint with another parameter. Alternatively, the UE could autonomously select the spatial setting(s) to use for sending the BFRQ on the configured PUCCH resource regardless how the spatial setting(s) is associated with the (failed) BFD RS(s) in the BFD RS beam set; the UE could also indicate to the network their selection.

In one example of Method-3 for Configuration-3, after the UE has declared beam failure(s) for one or more BFD RS beam sets to the network, the UE could be indicated by the network which spatial setting(s) for the configured PUCCH resource to use to transmit the SR for BFR; this indication could be via higher layer (RRC) or/and MAC CE or/and DCI based signaling; this indication could be via a separate (dedicated) parameter or joint with another parameter. Alternatively, the UE could autonomously decide which spatial setting(s) for the configured PUCCH resource to use to transmit the SR for BFR; in this case, the UE could also indicate to the network their selected spatial setting(s).

In one example, the UE could be indicated by the network to transmit the SR for BFR on the configured PUCCH resource with the spatial setting associated with the (failed) BFD RS beam set(s); this indication could be via higher layer (RRC) or/and MAC CE or/and DCI based signaling; this indication could be via a separate (dedicated) parameter or joint with another parameter. Alternatively, the UE could autonomously decide to transmit the SR for BFR on the configured PUCCH resource with the spatial setting associated with the (failed) BFD RS beam set(s); in this case, the UE could also indicate to the network their selected spatial setting. For instance, for Nsri=2, assume that the first spatial setting or the spatial setting with the lower ID value is associated with the (failed) BFD RS beam set(s). Based on the network's indication, the UE could transmit the SR for BFR on the configured PUCCH resource with the first spatial setting or the spatial setting with the lower ID value.

In another example, the UE could be indicated by the network to transmit the SR for BFR on the configured PUCCH resource with a spatial setting different from the spatial setting associated with the (failed) BFD RS beam set(s); the UE could also be indicated by the network which spatial setting to use; these indications could be via higher layer (RRC) or/and MAC CE or/and DCI based signaling; these indications could be via separate (dedicated) parameters or joint with another parameter. Alternatively, the UE could autonomously decide to transmit the SR for BFR on the configured PUCCH resource with a spatial setting different from the spatial setting associated with the (failed) BFD RS beam set(s); the UE could also autonomously decide which spatial setting to use; in this case, the UE could indicate to the network their decision/preference. For instance, for Nsri=2, assume that the first spatial setting or the spatial setting with the lower ID value is associated with the (failed) BFD RS beam set(s). Based on the network's indication, the UE could transmit the SR for BFR on the configured PUCCH resource with the second spatial setting or the spatial setting with the higher ID value.

In yet another example, the UE could be indicated by the network which spatial setting(s) to use for sending the BFRQ on the configured PUCCH resource regardless how the spatial setting(s) is associated with the (failed) BFD RS beam set(s); this indication could be via higher layer (RRC) or/and MAC CE or/and DCI based signaling; this indication could be via a separate (dedicated) parameter or joint with another parameter. Alternatively, the UE could autonomously select the spatial setting(s) to use for sending the BFRQ on the configured PUCCH resource regardless how the spatial setting(s) is associated with the (failed) BFD RS beam set(s); the UE could also indicate to the network their selection.

In one embodiment, multiple PUCCH resources are configured to transmit the SR for BFR.

The UE could be configured by the network more than one (Npucch>1) PUCCH resources in a single scheduling request (SR) configuration, e.g., provided by a single higher layer parameter SchedulingRequestConfig with a single SR ID schedulingRequestID for BFR, to transmit the SR for BFR (PUCCH-SR-BFR). For each configured PUCCH resource, the UE could be configured by the network one or more spatial settings (e.g., via the higher layer parameter PUCCH-SpatialRelationInfo). The configured PUCCH resources and/or the corresponding spatial setting(s) could be associated with one or more BFD RSs/BFD RS beam sets.

In one example of Configuration-I.A, the UE could be configured by the network Npucch>1 PUCCH resources with a single (Nsri=1) spatial setting for the PUCCH (e.g., via the higher layer parameter PUCCH-SpatialRelationInfo with a single value of PUCCH-SpatialRelationInfoId) or more than one (Nsri>1) spatial settings for the PUCCH (e.g., via the higher layer parameter PUCCH-SpatialRelationInfo with Nsri>1 values of PUCCH-SpatialRelationInfoId). Each PUCCH resource is associated with one or more BFD RSs in a BFD RS beam set. For example, the first PUCCH resource or the PUCCH resource with the lowest PUCCH-ResourceId value could be associated with the first BFD RS or the BFD RS with the lowest resource ID/index in the BFD RS beam set, the second PUCCH resource or the PUCCH resource with the second lowest PUCCH-ResourceId value could be associated with the second BFD RS or the BFD RS with the second lowest resource ID/index in the BFD RS beam set, and so on, and the last (Npucch-th) PUCCH resource or the PUCCH resource with the highest PUCCH-ResourceId value could be associated with the last BFD RS or the BFD RS with the highest resource ID/index in the BFD RS beam set. Other association rules/mapping relationships between the configured Npucch PUCCH resources and the BFD RSs in the BFD RS beam set are also possible.

In one example of Configuration-I.B, the UE could be configured by the network Npucch>1 PUCCH resources and Nsri>1 spatial settings for the PUCCH (e.g., via the higher layer parameter PUCCH-SpatialRelationInfo with Nsri>1 values of PUCCH-SpatialRelationInfoId). Each spatial setting is associated with one or more BFD RSs in a BFD RS beam set. For example, the first spatial setting or the spatial setting with the lowest PUCCH-SpatialRelationInfoId value could be associated with the first BFD RS or the BFD RS with the lowest resource ID/index in the BFD RS beam set, the second spatial setting or the spatial setting with the second lowest PUCCH-SpatialRelationInfoId value could be associated with the second BFD RS or the BFD RS with the second lowest resource ID/index in the BFD RS beam set, and so on, and the last (Nsri-th) spatial setting or the spatial setting with the highest PUCCH-SpatialRelationInfoId value could be associated with the last BFD RS or the BFD RS with the highest resource ID/index in the BFD RS beam set. Other association rules/mapping relationships between the configured spatial settings for the PUCCH resource and the BFD RSs in the BFD RS beam set are also possible.

In one example of Configuration-I.C, the UE could be configured by the network Npucch>1 PUCCH resources and Nsri>1 spatial settings for the PUCCH (e.g., via the higher layer parameter PUCCH-SpatialRelationInfo with Nsri>1 values of PUCCH-SpatialRelationInfoId). Each PUCCH resource is associated with one or more BFD RSs in a BFD RS beam set following those described in Configuration-I.A, and each spatial setting is associated with one or more BFD RSs in a BFD RS beam set following those described in Configuration-I.B.

In one example of Configuration-II.A, the UE could be configured by the network Npucch>1 PUCCH resources with a single (Nsri=1) spatial setting for the PUCCH (e.g., via the higher layer parameter PUCCH-SpatialRelationInfo with a single value of PUCCH-SpatialRelationInfoId) or more than one (Nsri>1) spatial settings for the PUCCH (e.g., via the higher layer parameter PUCCH-SpatialRelationInfo with Nsri>1 values of PUCCH-SpatialRelationInfoId). Each PUCCH resource is associated with one or more BFD RS beam sets. For example, the first PUCCH resource or the PUCCH resource with the lowest PUCCH-ResourceId value could be associated with the first BFD RS beam set or the BFD RS beam set with the lowest set ID/index, the second PUCCH resource or the PUCCH resource with the second lowest PUCCH-ResourceId value could be associated with the second BFD RS beam set or the BFD RS beam set with the second lowest set ID/index, and so on, and the last (Npucch-th) PUCCH resource or the PUCCH resource with the highest PUCCH-ResourceId value could be associated with the last BFD RS beam set or the BFD RS beam set with the highest set ID/index.

For a total of two BFD RS beam sets (S_q0/G_q0=2) and Npucch=2, the first PUCCH resource or the PUCCH resource with the lower PUCCH-ResourceId value is associated with the first BFD RS beam set q0-0 and or BFD RS beam set q0-0 with the lower set ID/index, and the second PUCCH resource or the PUCCH resource with the higher PUCCH-ResourceId value is associated with the second BFD RS beam set q0-1 and the BFD RS beam set q0-1 with the higher set ID/index. Other association rules/mapping relationships between the configured Npucch PUCCH resources and the BFD RS beam sets are also possible.

In one example of Configuration-II.B, the UE could be configured by the network Npucch>1 PUCCH resources and Nsri>1 spatial settings for the PUCCH (e.g., via the higher layer parameter PUCCH-SpatialRelationInfo with Nsri>1 values of PUCCH-SpatialRelationInfoId). Each spatial setting is associated with one or more BFD RS beam sets. For example, the first spatial setting or the spatial setting with the lowest PUCCH-SpatialRelationInfoId value could be associated with the first BFD RS beam set or the BFD RS beam set with the lowest set ID/index, the second spatial setting or the spatial setting with the second lowest PUCCH-SpatialRelationInfoId value could be associated with the second BFD RS beam set or the BFD RS beam set with the second lowest set ID/index, and so on, and the last (Nsri-th) spatial setting or the spatial setting with the highest PUCCH-SpatialRelationInfoId value could be associated with the last BFD RS beam set or the BFD RS beam set with the highest set ID/index. Other association rules/mapping relationships between the configured spatial settings for the PUCCH resource and the BFD RS beam sets are also possible.

In one example of Configuration-II.C, the UE could be configured by the network Npucch>1 PUCCH resources and Nsri>1 spatial settings for the PUCCH (e.g., via the higher layer parameter PUCCH-SpatialRelationInfo with Nsri>1 values of PUCCH-SpatialRelationInfoId). Each PUCCH resource is associated with one or more BFD RS beam sets following those described in Configuration-II.A, and each spatial setting is associated with one or more BFD RS beam sets following those described in Configuration-II.B.

In one example of Configuration-II.D, the UE could be configured by the network Npucch>1 PUCCH resources to transmit the SR for BFR (PUCCH-SR-BFR) each associated with a BFD RS beam set.

In one example, parameter configuring a PUCCH resource could include/indicate/comprise a BFD RS beam set index/ID. For instance, a BFD RS beam set index/ID could be indicated/included in the higher layer parameter PUCCH-Resource. For a total of two BFD RS beam sets (S_q0/G_q0=2) and Npucch=2, the higher layer parameter PUCCH-Resource configuring the first PUCCH resource or PUCCH resource with the lower PUCCH-ResourceId could indicate/include/comprise the set index/ID of the BFD RS beam set q0-0, and the higher layer parameter PUCCH-Resource configuring the second PUCCH resource or PUCCH resource with the higher PUCCH-ResourceId could indicate/include/comprise the set index/ID of the BFD RS beam set q0-1. A PUCCH resource is associated with a BFD RS beam set indicated/included in the parameter configuring the PUCCH resource.

In another example, parameter configuring a BFD RS beam set could include/indicate/comprise a PUCCH resource ID (e.g., PUCCH-ResourceId) or a PUCCH resource set ID (e.g., PUCCH-ResourceSetID) or a PUCCH resource setting ID. For instance, a PUCCH resource ID or a PUCCH resource set ID or a PUCCH resource setting ID could be indicated/included in the higher layer parameter beamFailureDetectionResourceList.

For a total of two BFD RS beam sets (S_q0/G_q0=2) and Npucch=2, the higher layer parameter beamFailureDetectionResourceList0 configuring the first BFD RS beam set q0-0 or the BFD RS beam set q0-0 with the lower set index/ID value could indicate/include/comprise the resource ID of the first PUCCH resource or the resource set index/ID of the PUCCH resource set configuring the first PUCCH resource or the resource setting index/ID of the PUCCH resource setting configuring the first PUCCH resource, and the higher layer parameter beamFailureDetectionResourceList 1 configuring the second BFD RS beam set q0-1 or the BFD RS beam set q0-1 with the lower set index/ID value could indicate/include/comprise the resource ID of the second PUCCH resource or the resource set index/ID of the PUCCH resource set configuring the second PUCCH resource or the resource setting index/ID of the PUCCH resource setting configuring the second PUCCH resource. A BFD RS beam set is associated with a PUCCH resource indicated/included in the parameter configuring the BFD RS beam set.

In yet another example, a PUCCH resource set configuring more than one of the Npucch PUCCH resources, e.g., via the higher layer parameter PUCCH-ResourceSet, could include/indicate/comprise one or more BFD RS beam set indexes/IDs. For instance, a PUCCH resource set provided by the higher layer parameter PUCCH-ResourceSet configuring Npucch PUCCH resources could include/indicate/comprise S_q0/G_q0 BFD RS beam set indexes/IDs. In this case, the first PUCCH resource or the PUCCH resource with the lowest PUCCH-ResourceId value configured in the PUCCH resource set (e.g., via the higher layer parameter PUCCH-ResourceSet) could be associated with the first BFD RS beam set or the BFD RS beam set with the lowest set ID/index configured in the PUCCH resource set (e.g., via the higher layer parameter PUCCH-ResourceSet), the second PUCCH resource or the PUCCH resource with the second lowest PUCCH-ResourceId value configured in the PUCCH resource set (e.g., via the higher layer parameter PUCCH-ResourceSet) could be associated with the second BFD RS beam set or the BFD RS beam set with the second lowest set ID/index configured in the PUCCH resource set (e.g., via the higher layer parameter PUCCH-ResourceSet), and so on, and the last (Npucch-th) PUCCH resource or the PUCCH resource with the highest PUCCH-ResourceId value configured in the PUCCH resource set (e.g., via the higher layer parameter PUCCH-ResourceSet) could be associated with the last BFD RS beam set or the BFD RS beam set with the highest set ID/index configured in the PUCCH resource set (e.g., via the higher layer parameter PUCCH-ResourceSet).

For a total of two BFD RS beam sets (S_q0/G_q0=2) and Npucch=2, the first PUCCH resource or the PUCCH resource with the lower PUCCH-ResourceId value configured in the PUCCH resource set (e.g., via the higher layer parameter PUCCH-ResourceSet) is associated with the first BFD RS beam set q0-0 or the BFD RS beam set q0-0 with the lower set ID/index configured in the PUCCH resource set (e.g., via the higher layer parameter PUCCH-ResourceSet), and the second PUCCH resource or the PUCCH resource with the higher PUCCH-ResourceId value configured in the PUCCH resource set (e.g., via the higher layer parameter PUCCH-ResourceSet) is associated with the second BFD RS beam set q0-1 or the BFD RS beam set q0-1 with the higher set ID/index configured in the PUCCH resource set (e.g., via the higher layer parameter PUCCH-ResourceSet).

In yet another example, a PUCCH resource setting configuring more than one PUCCH resource sets, e.g., via the higher layer parameter PUCCH-Config, could include/indicate/comprise one or more BFD RS beam set indexes/IDs. Each PUCCH resource set could configure one or more of the Npucch PUCCH resources, e.g., via the higher layer parameter PUCCH-ResourceSet. For instance, a PUCCH resource setting provided by the higher layer parameter PUCCH-Config configuring Npucch PUCCH resource sets each configuring a PUCCH resource to transmit the SR for BFR could include/indicate/comprise S_q0/G_q0 BFD RS beam set indexes/IDs.

In this case, the PUCCH resource configured in the first PUCCH resource set or the PUCCH resource set with the lowest PUCCH-ResourceSetId value configured in the PUCCH resource setting (e.g., via the higher layer parameter PUCCH-Config) could be associated with the first BFD RS beam set or the BFD RS beam set with the lowest set ID/index configured in the PUCCH resource setting (e.g., via the higher layer parameter PUCCH-Config), the PUCCH resource configured in the second PUCCH resource set or the PUCCH resource set with the second lowest PUCCH-ResourceSetId value configured in the PUCCH resource setting (e.g., via the higher layer parameter PUCCH-Config) could be associated with the second BFD RS beam set or the BFD RS beam set with the second lowest set ID/index configured in the PUCCH resource setting (e.g., via the higher layer parameter PUCCH-Config), and so on, and the PUCCH resource configured in the last (Npucch-th) PUCCH resource set or the PUCCH resource set with the highest PUCCH-ResourceSetId value configured in the PUCCH resource setting (e.g., via the higher layer parameter PUCCH-Config) could be associated with the last BFD RS beam set or the BFD RS beam set with the highest set ID/index configured in the PUCCH resource setting (e.g., via the higher layer parameter PUCCH-Config).

For a total of two BFD RS beam sets (S_q0/G_q0=2) and Npucch=2, the PUCCH resource configured in the first PUCCH resource set or the PUCCH resource set with the lower PUCCH-ResourceSetId value configured in the PUCCH resource setting (e.g., via the higher layer parameter PUCCH-Config) is associated with the first BFD RS beam set q0-0 or the BFD RS beam set q0-0 with the lower set ID/index configured in the PUCCH resource setting (e.g., via the higher layer parameter PUCCH-Config), and the PUCCH resource configured in the second PUCCH resource set or the PUCCH resource set with the higher PUCCH-ResourceSetId value configured in the PUCCH resource setting (e.g., via the higher layer parameter PUCCH-Config) is associated with the second BFD RS beam set q0-1 or the BFD RS beam set q0-1 with the higher set ID/index configured in the PUCCH resource setting (e.g., via the higher layer parameter PUCCH-Config).

In yet another example, more than one PUCCH resource settings could be configured each configuring one or more PUCCH resource sets. Each PUCCH resource set could configure one or more of the Npucch PUCCH resources. Each PUCCH resource setting could include/indicate/comprise one or more BFD RS beam set indexes/IDs. For instance, Npucch PUCCH resource settings could be configured each configuring a PUCCH resource set configuring a PUCCH resource to transmit the SR for BFR. Each PUCCH resource setting could include/indicate/comprise a BFD RS beam set index/ID.

For instance, a BFD RS beam set index/ID could be indicated/included in the higher layer parameter PUCCH-Config. For a total of two BFD RS beam sets (S_q0/G_q0=2) and Npucch=2, the higher layer parameter PUCCH-Config configuring the first PUCCH resource setting or the PUCCH resource setting with the lower PUCCH resource setting ID could indicate/include/comprise the set index/ID of the BFD RS beam set q0-0 or the BFD RS beam set q0-0 with the lower set ID/index, and the higher layer parameter PUCCH-Config configuring the second PUCCH resource setting or the PUCCH resource setting with the higher PUCCH resource setting ID could indicate/include/comprise the set index/ID of the BFD RS beam set q0-1 or the BFD RS beam set q0-1 with the higher set ID/index. A PUCCH resource is associated with a BFD RS beam set indicated/included in the PUCCH resource setting configuring the PUCCH resource.

After the UE has declared beam failure(s) for one or more BFD RSs in the BFD RS beam set or one or more BFD RS beam sets, the UE could transmit the SR for BFR on one or more PUCCH resources with one or more spatial settings.

In one example of Method-LA for Configuration-I.A, various methods of configuring and transmitting the SR for BFR after the UE has declared beam failure(s) for one or more BFD RSs in the BFD RS beam set are presented as follows.

In one example, the UE could be indicated by the network to transmit the SR for BFR on the configured PUCCH resource associated with the (failed) BFD RS(s) in the BFD RS beam set; this indication could be via higher layer (RRC) or/and MAC CE or/and DCI based signaling; this indication could be via a separate (dedicated) parameter or joint with another parameter. Alternatively, the UE could autonomously decide to transmit the SR for BFR on the configured PUCCH resource associated with the (failed) BFD RS(s) in the BFD RS beam set; in this case, the UE could also indicate to the network their decision/preference.

For instance, for Npucch=2, assume that the first PUCCH resource or the PUCCH resource with the lower PUCCH-ResourceId value is associated with the (failed) BFD RS(s) in the BFD RS beam set. Based on the network's indication, the UE could transmit the SR for BFR on the first PUCCH resource or the PUCCH resource with the lower PUCCH-ResourceId value. The UE could also be indicated by the network which spatial setting(s) to use for sending the BFRQ on the PUCCH resource; alternatively, the UE could autonomously determine which spatial setting(s) to use for sending the BFRQ on the PUCCH resource.

In another example, the UE could be indicated by the network to transmit the SR for BFR on a PUCCH resource different from the PUCCH resource associated with the (failed) BFD RS(s) in the BFD RS beam set; the UE could also be indicated by the network which PUCCH resource to use; these indications could be via higher layer (RRC) or/and MAC CE or/and DCI based signaling; these indications could be via separate (dedicated) parameters or joint with another parameter. Alternatively, the UE could autonomously decide to transmit the SR for BFR on a PUCCH resource different from the PUCCH resource associated with the (failed) BFD RS(s) in the BFD RS beam set; the UE could also autonomously decide which PUCCH resource to use; in this case, the UE could indicate to the network their decision/preference.

For instance, for Npucch=2, assume that the first PUCCH resource or the PUCCH resource with the lower PUCCH-ResourceId value is associated with the (failed) BFD RS(s) in the BFD RS beam set. Based on the network's indication, the UE could transmit the SR for BFR on the second PUCCH resource or the PUCCH resource with the higher PUCCH-ResourceId value. The UE could also be indicated by the network which spatial setting(s) to use for sending the BFRQ on the PUCCH resource; alternatively, the UE could autonomously determine which spatial setting(s) to use for sending the BFRQ on the PUCCH resource.

In yet another example, the UE could be indicated by the network which PUCCH resource(s) to use for sending the BFRQ regardless how the PUCCH resource(s) is associated with the (failed) BFD RS(s) in the BFD RS beam set; this indication could be via higher layer (RRC) or/and MAC CE or/and DCI based signaling; this indication could be via a separate (dedicated) parameter or joint with another parameter. Alternatively, the UE could autonomously select the PUCCH resource(s) for sending the BFRQ regardless how the PUCCH resource(s) is associated with the (failed) BFD RS(s) in the BFD RS beam set; the UE could also indicate to the network their selection. The UE could also be indicated by the network which spatial setting(s) to use for sending the BFRQ on the PUCCH resource; alternatively, the UE could autonomously determine which spatial setting(s) to use for sending the BFRQ on the PUCCH resource.

In one example of Method-I.B for Configuration-I.B, various methods of configuring and transmitting the SR for BFR after the UE has declared beam failure(s) for one or more BFD RSs in the BFD RS beam set are presented as follows.

In one example, the UE could be first indicated by the network which PUCCH resource(s) to use for sending the BFRQ; alternatively, the UE could autonomously determine which PUCCH resource(s) to use for sending the BFRQ. The UE could then be indicated by the network to transmit the SR for BFR on the selected PUCCH resource(s) with the spatial setting associated with the (failed) BFD RS(s) in the BFD RS beam set; this indication could be via higher layer (RRC) or/and MAC CE or/and DCI based signaling; this indication could be via a separate (dedicated) parameter or joint with another parameter. Alternatively, the UE could autonomously decide to transmit the SR for BFR on the selected PUCCH resource(s) with the spatial setting associated with the (failed) BFD RS(s) in the BFD RS beam set; in this case, the UE could also indicate to the network their decision/preference. For instance, for Nsri=2, assume that the first spatial setting or the spatial setting with the lower ID value is associated with the (failed) BFD RS(s) in the BFD RS beam set. Based on the network's indication, the UE could transmit the SR for BFR on the selected PUCCH resource(s) with the first spatial setting or the spatial setting with the lower ID value.

In another example, the UE could be first indicated by the network which PUCCH resource(s) to use for sending the BFRQ; alternatively, the UE could autonomously determine which PUCCH resource(s) to use for sending the BFRQ. The UE could then be indicated by the network to transmit the SR for BFR on the selected PUCCH resource with a spatial setting different from the spatial setting associated with the (failed) BFD RS(s) in the BFD RS beam set; the UE could also be indicated by the network which spatial setting to use; these indications could be via higher layer (RRC) or/and MAC CE or/and DCI based signaling; these indications could be via separate (dedicated) parameters or joint with another parameter. Alternatively, the UE could autonomously decide to transmit the SR for BFR on the selected PUCCH resource(s) with a spatial setting different from the spatial setting associated with the (failed) BFD RS(s) in the BFD RS beam set; the UE could also autonomously decide which spatial setting to use; in this case, the UE could indicate to the network their decision/preference. For instance, for Nsri=2, assume that the first spatial setting or the spatial setting with the lower ID value is associated with the (failed) BFD RS(s) in the BFD RS beam set. Based on the network's indication, the UE could transmit the SR for BFR on the selected PUCCH resource with the second spatial setting or the spatial setting with the higher ID value.

In yet another example, the UE could be first indicated by the network which PUCCH resource(s) to use for sending the BFRQ; alternatively, the UE could autonomously determine which PUCCH resource(s) to use for sending the BFRQ. The UE could then be indicated by the network which spatial setting(s) to use for sending the BFRQ on the selected PUCCH resource(s) regardless how the spatial setting(s) is associated with the (failed) BFD RS(s) in the BFD RS beam set; this indication could be via higher layer (RRC) or/and MAC CE or/and DCI based signaling; this indication could be via a separate (dedicated) parameter or joint with another parameter. Alternatively, the UE could autonomously select the spatial setting(s) to use for sending the BFRQ on the selected PUCCH resource(s) regardless how the spatial setting(s) is associated with the (failed) BFD RS(s) in the BFD RS beam set; the UE could also indicate to the network their selection.

In one example of Method-I.C for Configuration-I.C, various methods of configuring and transmitting the SR for BFR after the UE has declared beam failure(s) for one or more BFD RSs in the BFD RS beam set are presented as follows.

In one example, the UE could first be indicated by the network to transmit the SR for BFR on the PUCCH resource associated with the (failed) BFD RS(s) in the BFD RS beam set; this indication could be via higher layer (RRC) or/and MAC CE or/and DCI based signaling; this indication could be via a separate (dedicated) parameter or joint with another parameter. The UE could also be indicated by the network to transmit the SR for BFR on the selected PUCCH resource with the spatial setting associated with the (failed) BFD RS(s) in the BFD RS beam set; this indication could be via higher layer (RRC) or/and MAC CE or/and DCI based signaling; this indication could be via a separate (dedicated) parameter or joint with another parameter. Alternatively, the UE could autonomously decide to transmit the SR for BFR on the PUCCH resource associated with the (failed) BFD RS(s) in the BFD RS beam set. The UE could also autonomously decide to transmit the SR for BFR on the selected PUCCH resource with the spatial setting associated with the (failed) BFD RS(s) in the BFD RS beam set.

In this case, the UE could also indicate to the network their decisions/preferences. For instance, for Nsri=2, assume that the first PUCCH resource or the PUCCH resource with the lower PUCCH-ResourceId value, and the first spatial setting or the spatial setting with the lower ID value, are associated with the (failed) BFD RS(s) in the BFD RS beam set. Based on the network's indication, the UE could transmit the SR for BFR on the first PUCCH resource or the PUCCH resource with the lower PUCCH-ResourceId value with the first spatial setting or the spatial setting with the lower ID value.

In another example, the UE could first be indicated by the network to transmit the SR for BFR on the PUCCH resource associated with the (failed) BFD RS(s) in the BFD RS beam set; this indication could be via higher layer (RRC) or/and MAC CE or/and DCI based signaling; this indication could be via a separate (dedicated) parameter or joint with another parameter. The UE could also be indicated by the network to transmit the SR for BFR on the selected PUCCH resource with a spatial setting different from the spatial setting associated with the (failed) BFD RS(s) in the BFD RS beam set; the UE could be indicated by the network which spatial setting to use; these indications could be via higher layer (RRC) or/and MAC CE or/and DCI based signaling; these indications could be via separate (dedicated) parameters or joint with another parameter.

Alternatively, the UE could autonomously decide to transmit the SR for BFR on the PUCCH resource associated with the (failed) BFD RS(s) in the BFD RS beam set. The UE could also autonomously decide to transmit the SR for BFR on the selected PUCCH resource with a spatial setting different from the spatial setting associated with the (failed) BFD RS(s) in the BFD RS beam set; the UE could autonomously decide which spatial setting to use. In this case, the UE could also indicate to the network their decisions/preferences. For instance, for Nsri=2, assume that the first PUCCH resource or the PUCCH resource with the lower PUCCH-ResourceId value, and the first spatial setting or the spatial setting with the lower ID value, are associated with the (failed) BFD RS(s) in the BFD RS beam set. Based on the network's indication, the UE could transmit the SR for BFR on the first PUCCH resource or the PUCCH resource with the lower PUCCH-ResourceId value with the second spatial setting or the spatial setting with the higher ID value.

In yet another example, the UE could first be indicated by the network to transmit the SR for BFR on a PUCCH resource different from the PUCCH resource associated with the (failed) BFD RS(s) in the BFD RS beam set; the UE could be indicated by the network which PUCCH resource to use; these indications could be via higher layer (RRC) or/and MAC CE or/and DCI based signaling; these indications could be via separate (dedicated) parameters or joint with another parameter. The UE could also be indicated by the network to transmit the SR for BFR on the selected PUCCH resource with the spatial setting associated with the (failed) BFD RS(s) in the BFD RS beam set; this indication could be via higher layer (RRC) or/and MAC CE or/and DCI based signaling; this indication could be via a separate (dedicated) parameter or joint with another parameter.

Alternatively, the UE could autonomously decide to transmit the SR for BFR on a PUCCH resource different from the PUCCH resource associated with the (failed) BFD RS(s) in the BFD RS beam set; the UE could autonomously decide which PUCCH resource to use. The UE could also autonomously decide to transmit the SR for BFR on the selected PUCCH resource with the spatial setting associated with the (failed) BFD RS(s) in the BFD RS beam set. In this case, the UE could also indicate to the network their decisions/preferences. For instance, for Nsri=2, assume that the first PUCCH resource or the PUCCH resource with the lower PUCCH-ResourceId value, and the first spatial setting or the spatial setting with the lower ID value, are associated with the (failed) BFD RS(s) in the BFD RS beam set. Based on the network's indication, the UE could transmit the SR for BFR on the second PUCCH resource or the PUCCH resource with the higher PUCCH-ResourceId value with the first spatial setting or the spatial setting with the lower ID value.

In yet another example, the UE could first be indicated by the network to transmit the SR for BFR on a PUCCH resource different from the PUCCH resource associated with the (failed) BFD RS(s) in the BFD RS beam set; the UE could be indicated by the network which PUCCH resource to use; these indications could be via higher layer (RRC) or/and MAC CE or/and DCI based signaling; these indications could be via separate (dedicated) parameters or joint with another parameter. The UE could also be indicated by the network to transmit the SR for BFR on the selected PUCCH resource with a spatial setting different from the spatial setting associated with the (failed) BFD RS(s) in the BFD RS beam set; the UE could be indicated by the network which spatial setting to use; these indications could be via higher layer (RRC) or/and MAC CE or/and DCI based signaling; these indications could be via separate (dedicated) parameters or joint with another parameter.

Alternatively, the UE could autonomously decide to transmit the SR for BFR on a PUCCH resource different from the PUCCH resource associated with the (failed) BFD RS(s) in the BFD RS beam set; the UE could autonomously decide which PUCCH resource to use. The UE could also autonomously decide to transmit the SR for BFR on the selected PUCCH resource with a spatial setting different from the spatial setting associated with the (failed) BFD RS(s) in the BFD RS beam set; the UE could autonomously decide which spatial setting to use. In this case, the UE could also indicate to the network their decisions/preferences. For instance, for Nsri=2, assume that the first PUCCH resource or the PUCCH resource with the lower PUCCH-ResourceId value, and the first spatial setting or the spatial setting with the lower ID value, are associated with the (failed) BFD RS(s) in the BFD RS beam set. Based on the network's indication, the UE could transmit the SR for BFR on the second PUCCH resource or the PUCCH resource with the higher PUCCH-ResourceId value with the second spatial setting or the spatial setting with the higher ID value.

In yet another example, the UE could be first indicated by the network which PUCCH resource(s) to use for sending the BFRQ regardless how the PUCCH resource(s) is associated with the (failed) BFD RSs in the BFD RS beam set; this indication could be via higher layer (RRC) or/and MAC CE or/and DCI based signaling; this indication could be via a separate (dedicated) parameter or joint with another parameter. The UE could also be indicated by the network which spatial setting(s) to use for sending the BFRQ on the selected PUCCH resource(s) regardless how the spatial setting(s) is associated with the (failed) BFD RS(s) in the BFD RS beam set; this indication could be via higher layer (RRC) or/and MAC CE or/and DCI based signaling; this indication could be via a separate (dedicated) parameter or joint with another parameter.

Alternatively, the UE could autonomously select the PUCCH resource(s) to use for sending the BFRQ regardless how the PUCCH resource(s) is associated with the (failed) BFD RSs in the BFD RS beam set. The UE could also autonomously select the spatial setting(s) to use for sending the BFRQ on the selected PUCCH resource(s) regardless how the spatial setting(s) is associated with the (failed) BFD RS(s) in the BFD RS beam set. The UE could also indicate to the network their selections.

In one example of Method-II.A for Configuration-II.A, various methods of configuring and transmitting the SR for BFR after the UE has declared beam failure(s) for one or more BFD RS beam sets are presented as follows.

In one example, the UE could be indicated by the network to transmit the SR for BFR on the configured PUCCH resource associated with the (failed) BFD RS beam set(s); this indication could be via higher layer (RRC) or/and MAC CE or/and DCI based signaling; this indication could be via a separate (dedicated) parameter or joint with another parameter. Alternatively, the UE could autonomously decide to transmit the SR for BFR on the configured PUCCH resource associated with the (failed) BFD RS beam set(s); in this case, the UE could also indicate to the network their decision/preference.

For instance, for Npucch=2, assume that the first PUCCH resource or the PUCCH resource with the lower PUCCH-ResourceId value is associated with the (failed) BFD RS beam set(s). Based on the network's indication, the UE could transmit the SR for BFR on the first PUCCH resource or the PUCCH resource with the lower PUCCH-ResourceId value. The UE could also be indicated by the network which spatial setting(s) to use for sending the BFRQ on the PUCCH resource; alternatively, the UE could autonomously determine which spatial setting(s) to use for sending the BFRQ on the PUCCH resource.

In another example, the UE could be indicated by the network to transmit the SR for BFR on a PUCCH resource different from the PUCCH resource associated with the (failed) BFD RS beam set(s); the UE could also be indicated by the network which PUCCH resource to use; these indications could be via higher layer (RRC) or/and MAC CE or/and DCI based signaling; these indications could be via separate (dedicated) parameters or joint with another parameter. Alternatively, the UE could autonomously decide to transmit the SR for BFR on a PUCCH resource different from the PUCCH resource associated with the (failed) BFD RS beam set(s); the UE could also autonomously decide which PUCCH resource to use; in this case, the UE could indicate to the network their decision/preference.

For instance, for Npucch=2, assume that the first PUCCH resource or the PUCCH resource with the lower PUCCH-ResourceId value is associated with the (failed) BFD RS beam set(s). Based on the network's indication, the UE could transmit the SR for BFR on the second PUCCH resource or the PUCCH resource with the higher PUCCH-ResourceId value. The UE could also be indicated by the network which spatial setting(s) to use for sending the BFRQ on the PUCCH resource; alternatively, the UE could autonomously determine which spatial setting(s) to use for sending the BFRQ on the PUCCH resource.

In yet another example, the UE could be indicated by the network which PUCCH resource(s) to use for sending the BFRQ regardless how the PUCCH resource(s) is associated with the (failed) BFD RS beam set(s); this indication could be via higher layer (RRC) or/and MAC CE or/and DCI based signaling; this indication could be via a separate (dedicated) parameter or joint with another parameter. Alternatively, the UE could autonomously select the PUCCH resource(s) for sending the BFRQ regardless how the PUCCH resource(s) is associated with the (failed) BFD RS beam set(s); the UE could also indicate to the network their selection. The UE could also be indicated by the network which spatial setting(s) to use for sending the BFRQ on the PUCCH resource; alternatively, the UE could autonomously determine which spatial setting(s) to use for sending the BFRQ on the PUCCH resource.

In one example of Method-II.B for Configuration-II.B, various methods of configuring and transmitting the SR for BFR after the UE has declared beam failure(s) for one or more BFD RS beam sets are presented as follows.

In one example, the UE could be first indicated by the network which PUCCH resource(s) to use for sending the BFRQ; alternatively, the UE could autonomously determine which PUCCH resource(s) to use for sending the BFRQ. The UE could then be indicated by the network to transmit the SR for BFR on the selected PUCCH resource(s) with the spatial setting associated with the (failed) BFD RS beam set(s); this indication could be via higher layer (RRC) or/and MAC CE or/and DCI based signaling; this indication could be via a separate (dedicated) parameter or joint with another parameter.

Alternatively, the UE could autonomously decide to transmit the SR for BFR on the selected PUCCH resource(s) with the spatial setting associated with the (failed) BFD RS beam set(s); in this case, the UE could also indicate to the network their decision/preference. For instance, for Nsri=2, assume that the first spatial setting or the spatial setting with the lower ID value is associated with the (failed) BFD RS beam set(s). Based on the network's indication, the UE could transmit the SR for BFR on the selected PUCCH resource(s) with the first spatial setting or the spatial setting with the lower ID value.

In another example, the UE could be first indicated by the network which PUCCH resource(s) to use for sending the BFRQ; alternatively, the UE could autonomously determine which PUCCH resource(s) to use for sending the BFRQ. The UE could then be indicated by the network to transmit the SR for BFR on the selected PUCCH resource with a spatial setting different from the spatial setting associated with the (failed) BFD RS beam set(s); the UE could also be indicated by the network which spatial setting to use; these indications could be via higher layer (RRC) or/and MAC CE or/and DCI based signaling; these indications could be via separate (dedicated) parameters or joint with another parameter.

Alternatively, the UE could autonomously decide to transmit the SR for BFR on the selected PUCCH resource(s) with a spatial setting different from the spatial setting associated with the (failed) BFD RS beam set(s); the UE could also autonomously decide which spatial setting to use; in this case, the UE could indicate to the network their decision/preference. For instance, for Nsri=2, assume that the first spatial setting or the spatial setting with the lower ID value is associated with the (failed) BFD RS beam set(s). Based on the network's indication, the UE could transmit the SR for BFR on the selected PUCCH resource with the second spatial setting or the spatial setting with the higher ID value.

In yet another example, the UE could be first indicated by the network which PUCCH resource(s) to use for sending the BFRQ; alternatively, the UE could autonomously determine which PUCCH resource(s) to use for sending the BFRQ. The UE could then be indicated by the network which spatial setting(s) to use for sending the BFRQ on the selected PUCCH resource(s) regardless how the spatial setting(s) is associated with the (failed) BFD RS beam set(s); this indication could be via higher layer (RRC) or/and MAC CE or/and DCI based signaling; this indication could be via a separate (dedicated) parameter or joint with another parameter. Alternatively, the UE could autonomously select the spatial setting(s) to use for sending the BFRQ on the selected PUCCH resource(s) regardless how the spatial setting(s) is associated with the (failed) BFD RS beam set(s); the UE could also indicate to the network their selection.

In one example of Method-II.C for Configuration-II.C, various methods of configuring and transmitting the SR for BFR after the UE has declared beam failure(s) for one or more BFD RS beam sets are presented as follows.

In one example, the UE could first be indicated by the network to transmit the SR for BFR on the PUCCH resource associated with the (failed) BFD RS beam set(s); this indication could be via higher layer (RRC) or/and MAC CE or/and DCI based signaling; this indication could be via a separate (dedicated) parameter or joint with another parameter. The UE could also be indicated by the network to transmit the SR for BFR on the selected PUCCH resource with the spatial setting associated with the (failed) BFD RS beam set(s); this indication could be via higher layer (RRC) or/and MAC CE or/and DCI based signaling; this indication could be via a separate (dedicated) parameter or joint with another parameter.

Alternatively, the UE could autonomously decide to transmit the SR for BFR on the PUCCH resource associated with the (failed) BFD RS beam set(s). The UE could also autonomously decide to transmit the SR for BFR on the selected PUCCH resource with the spatial setting associated with the (failed) BFD RS beam set(s). In this case, the UE could also indicate to the network their decisions/preferences. For instance, for Nsri=2, assume that the first PUCCH resource or the PUCCH resource with the lower PUCCH-ResourceId value, and the first spatial setting or the spatial setting with the lower ID value, are associated with the (failed) BFD RS beam set(s). Based on the network's indication, the UE could transmit the SR for BFR on the first PUCCH resource or the PUCCH resource with the lower PUCCH-ResourceId value with the first spatial setting or the spatial setting with the lower ID value.

In another example, the UE could first be indicated by the network to transmit the SR for BFR on the PUCCH resource associated with the (failed) BFD RS beam set(s); this indication could be via higher layer (RRC) or/and MAC CE or/and DCI based signaling; this indication could be via a separate (dedicated) parameter or joint with another parameter. The UE could also be indicated by the network to transmit the SR for BFR on the selected PUCCH resource with a spatial setting different from the spatial setting associated with the (failed) BFD RS beam set(s); the UE could be indicated by the network which spatial setting to use; these indications could be via higher layer (RRC) or/and MAC CE or/and DCI based signaling; these indications could be via separate (dedicated) parameters or joint with another parameter.

Alternatively, the UE could autonomously decide to transmit the SR for BFR on the PUCCH resource associated with the (failed) BFD RS beam set(s). The UE could also autonomously decide to transmit the SR for BFR on the selected PUCCH resource with a spatial setting different from the spatial setting associated with the (failed) BFD RS beam set(s); the UE could autonomously decide which spatial setting to use. In this case, the UE could also indicate to the network their decisions/preferences. For instance, for Nsri=2, assume that the first PUCCH resource or the PUCCH resource with the lower PUCCH-ResourceId value, and the first spatial setting or the spatial setting with the lower ID value, are associated with the (failed) BFD RS beam set(s). Based on the network's indication, the UE could transmit the SR for BFR on the first PUCCH resource or the PUCCH resource with the lower PUCCH-ResourceId value with the second spatial setting or the spatial setting with the higher ID value.

In yet another example, the UE could first be indicated by the network to transmit the SR for BFR on a PUCCH resource different from the PUCCH resource associated with the (failed) BFD RS beam set(s); the UE could be indicated by the network which PUCCH resource to use; these indications could be via higher layer (RRC) or/and MAC CE or/and DCI based signaling; these indications could be via separate (dedicated) parameters or joint with another parameter. The UE could also be indicated by the network to transmit the SR for BFR on the selected PUCCH resource with the spatial setting associated with the (failed) BFD RS beam set(s); this indication could be via higher layer (RRC) or/and MAC CE or/and DCI based signaling; this indication could be via a separate (dedicated) parameter or joint with another parameter.

Alternatively, the UE could autonomously decide to transmit the SR for BFR on a PUCCH resource different from the PUCCH resource associated with the (failed) BFD RS beam set(s); the UE could autonomously decide which PUCCH resource to use. The UE could also autonomously decide to transmit the SR for BFR on the selected PUCCH resource with the spatial setting associated with the (failed) BFD RS beam set(s). In this case, the UE could also indicate to the network their decisions/preferences. For instance, for Nsri=2, assume that the first PUCCH resource or the PUCCH resource with the lower PUCCH-ResourceId value, and the first spatial setting or the spatial setting with the lower ID value, are associated with the (failed) BFD RS beam set(s). Based on the network's indication, the UE could transmit the SR for BFR on the second PUCCH resource or the PUCCH resource with the higher PUCCH-ResourceId value with the first spatial setting or the spatial setting with the lower ID value.

In yet another example, the UE could first be indicated by the network to transmit the SR for BFR on a PUCCH resource different from the PUCCH resource associated with the (failed) BFD RS beam set(s); the UE could be indicated by the network which PUCCH resource to use; these indications could be via higher layer (RRC) or/and MAC CE or/and DCI based signaling; these indications could be via separate (dedicated) parameters or joint with another parameter. The UE could also be indicated by the network to transmit the SR for BFR on the selected PUCCH resource with a spatial setting different from the spatial setting associated with the (failed) BFD RS beam set(s); the UE could be indicated by the network which spatial setting to use; these indications could be via higher layer (RRC) or/and MAC CE or/and DCI based signaling; these indications could be via separate (dedicated) parameters or joint with another parameter.

Alternatively, the UE could autonomously decide to transmit the SR for BFR on a PUCCH resource different from the PUCCH resource associated with the (failed) BFD RS beam set(s); the UE could autonomously decide which PUCCH resource to use. The UE could also autonomously decide to transmit the SR for BFR on the selected PUCCH resource with a spatial setting different from the spatial setting associated with the (failed) BFD RS beam set(s); the UE could autonomously decide which spatial setting to use. In this case, the UE could also indicate to the network their decisions/preferences. For instance, for Nsri=2, assume that the first PUCCH resource or the PUCCH resource with the lower PUCCH-ResourceId value, and the first spatial setting or the spatial setting with the lower ID value, are associated with the (failed) BFD RS beam set(s). Based on the network's indication, the UE could transmit the SR for BFR on the second PUCCH resource or the PUCCH resource with the higher PUCCH-ResourceId value with the second spatial setting or the spatial setting with the higher ID value.

In yet another example, the UE could be first indicated by the network which PUCCH resource(s) to use for sending the BFRQ regardless how the PUCCH resource(s) is associated with the (failed) BFD RS beam set(s); this indication could be via higher layer (RRC) or/and MAC CE or/and

DCI based signaling; this indication could be via a separate (dedicated) parameter or joint with another parameter. The UE could also be indicated by the network which spatial setting(s) to use for sending the BFRQ on the selected PUCCH resource(s) regardless how the spatial setting(s) is associated with the (failed) BFD RS beam set(s); this indication could be via higher layer (RRC) or/and MAC CE or/and DCI based signaling; this indication could be via a separate (dedicated) parameter or joint with another parameter.

Alternatively, the UE could autonomously select the PUCCH resource(s) to use for sending the BFRQ regardless how the PUCCH resource(s) is associated with the (failed) BFD RS beam set(s). The UE could also autonomously select the spatial setting(s) to use for sending the BFRQ on the selected PUCCH resource(s) regardless how the spatial setting(s) is associated with the (failed) BFD RS beam set(s). The UE could also indicate to the network their selections.

Alternatively, the UE could be configured by the network more than one (Nsrconfig>1) SR configurations, e.g., provided by Nsrconfig higher layer parameters SchedulingRequestConfig's, each configuring at least one PUCCH resource to transmit the SR for BFR (PUCCH-SR-BFR). The configured Nsrconfig SR configurations could be associated with one or more BFD RSs/BFD RS beam sets.

In one example of Configuration-III.A, the UE could be configured by the network Nsrconfig>1 SR configurations, e.g., provided by Nsrconfig higher layer parameters SchedulingRequestConfig's. Each SR configuration is associated with one or more BFD RSs in a BFD RS beam set. For example, the first SR configuration or the SR configuration with the lowest SR ID value (provided by schedulingRequestID) could be associated with the first BFD RS or the BFD RS with the lowest resource ID/index in the BFD RS beam set, the second SR configuration or the SR configuration with the second lowest SR ID value (provided by schedulingRequestID) could be associated with the second BFD RS or the BFD RS with the second lowest resource ID/index in the BFD RS beam set, and so on, and the last (Nsrconfig-th) SR configuration or the SR configuration with the highest SR ID value (provided by schedulingRequestID) could be associated with the last BFD RS or the BFD RS with the highest resource ID/index in the BFD RS beam set. Other association rules/mapping relationships between the Nsrconfig SR configurations and the BFD RSs in the BFD RS beam set are also possible.

In one example of Configuration-IV.A, the UE could be configured by the network Nsrconfig>1 SR configurations. Each SR configuration is associated with one or more BFD RS beam sets. For example, the first SR configuration or the SR configuration with the lowest SR ID value (provided by schedulingRequestID) could be associated with the first BFD RS beam set or the BFD RS beam set with the lowest set ID/index, the second SR configuration or the SR configuration with the second lowest SR ID value (provided by schedulingRequestID) could be associated with the second BFD RS beam set or the BFD RS beam set with the second lowest set ID/index, and so on, and the last (Nsrconfig-th) SR configuration or the SR configuration with the highest SR ID value (provided by schedulingRequestID) could be associated with the last BFD RS beam set or the BFD RS beam set with the highest set ID/index.

For a total of two BFD RS beam sets (S_q0/G_q0=2) and Nsrconfig=2, the first SR configuration or the SR configuration with the lower SR ID value (provided by schedulingReqeustID) is associated with the first BFD RS beam set q0-0 and or BFD RS beam set q0-0 with the lower set ID/index, and the second SR configuration or the SR configuration with the higher SR ID value (provided by schedulingRequestID) is associated with the second BFD RS beam set q0-1 and the BFD RS beam set q0-1 with the higher set ID/index. Other association rules/mapping relationships between the Nsrconfig SR configurations and the BFD RS beam sets are also possible.

In one example of Configuration-IV.B, the UE could be configured by the network Nsrconfig>1 SR configurations each associated with a BFD RS beam set.

In one example, parameter configuring a SR configuration could include/indicate/comprise a BFD RS beam set index/ID. For instance, a BFD RS beam set index/ID could be indicated/included in the higher layer parameter SchedulingRequestConfig. For a total of two BFD RS beam sets (S_q0/G_q0=2) and Nsrconfig=2, the higher layer parameter SchedulingRequestConfig configuring the first SR configuration or the SR configuration with the lower SR ID value (provided by schedulingRequestID) could indicate/include/comprise the set index/ID of the BFD RS beam set q0-0, and the higher layer parameter SchedulingRequestConfig configuring the second SR configuration or the SR configuration with the higher SR ID value (provided by schedulingRequestID) could indicate/include/comprise the set index/ID of the BFD RS beam set q0-1. A SR configuration is associated with a BFD RS beam set indicated/included in the parameter configuring the SR configuration.

In another example, parameter configuring a BFD RS beam set could include/indicate/comprise a SR ID (e.g., schedulingRequestID). For instance, a SR ID could be indicated/included in the higher layer parameter beamFailureDetectionResourceList. For a total of two BFD RS beam sets (S_q0/G_q0=2) and Nsrconfig=2, the higher layer parameter beamFailureDetectionResourceList0 configuring the first BFD RS beam set q0-0 or the BFD RS beam set q0-0 with the lower set index/ID value could indicate/include/comprise the SR ID of the first SR configuration or the SR configuration with the lower SR ID value (provided by schedulingRequestID), and the higher layer parameter beamFailureDetectionResourceList1 configuring the second BFD RS beam set q0-1 or the BFD RS beam set q0-1 with the lower set index/ID value could indicate/include/comprise the SR ID of the second SR configuration or the SR configuration with the higher SR ID value (provided by schedulingRequestID). A BFD RS beam set is associated with a SR configuration indicated/included in the parameter configuring the BFD RS beam set.

The UE can provide in a first PUSCH MAC CE index(es) for at least the corresponding BFD RS beam set(s) with the radio link quality worse than the corresponding BFD threshold or the corresponding maximum number of BFI count reached before the expiration of the corresponding BFD timer, set index(es)/ID(s) of the corresponding BFD RS beam set(s), indication(s) of presence of new beam(s) for the corresponding BFD RS beam set(s), index(es) of NBI RS(s) corresponding to periodic CSI-RS resource configuration(s) or SSB(s) for the new beam(s), and set index(es)/ID(s) of the NBI RS beam set(s) associated with the corresponding BFD RS beam set(s).

More than one set indexes/IDs of BFD RS beam sets could be provided in the first PUSCH MAC CE. The UE can also provide in the first PUSCH MAC CE index(es) a bitmap with each entry/bit position in the bitmap corresponding to a BFD RS beam set; for a BFD RS beam set with the radio link quality worse than the corresponding BFD threshold or the corresponding maximum number of BFI count reached before the expiration of the corresponding BFD timer, the associated entry/bit position in the bitmap is set to ‘1’. Furthermore, whether to provide set index(es)/ID(s) of the NBI RS beam set(s) associated with the corresponding BFD RS beam set(s) could be: (1) fixed in the system specifications, e.g., the set index(es)/ID(s) of the NBI RS beam set(s) associated with the corresponding BFD RS beam set(s) shall be always provided in the first PUSCH MAC CE, (2) based on network's configuration, or (3) determined by the UE.

In one example, the UE shall provide in the first PUSCH MAC CE the set index(es)/ID(s) of the NBI RS beam set(s) associated with the corresponding failed BFD RS beam set(s) if the index(es) of NBI RS(s) corresponds to the SSB index(es) or CSI-RS resource configuration index(es) from the NBI RS beam set(s). In another example, the UE shall provide in the first PUSCH MAC CE the set index(es)/ID(s) of the NBI RS beam set(s) associated with the corresponding failed BFD RS beam set(s) if more than one set indexes/IDs of BFD RS beam sets are provided in the first PUSCH MAC CE.

The BFRR for the failed BFD RS(s)/BFD RS beam set(s) could be a PDCCH with a DCI format scheduling a PUSCH transmission for a same HARQ process ID/number as for the transmission of the first PUSCH MAC CE for the failed BFD RS(s)/BFD RS beam set(s) and having a toggled NDI field value. 28 symbols after the UE has received the BFRR for the failed BFD RS(s)/BFD RS beam set(s), the UE monitors PDCCH in all CORESETs associated with the failed BFD RS(s)/BFD RS beam set(s) using the same antenna port quasi-co-location parameters as the ones associated with the corresponding index(es) of the NBI(s) for the new beam(s).

Similar to the configurations of the PUCCH resource(s) and the corresponding spatial setting(s) for sending the BFRQ, the UE could also use one or more CF/CB RACH resources with one or more PRACH beams to send the BFRQ. The association between the CF/CB RACH resource(s) and/or the corresponding PRACH beam(s) and the BFD RS(s) in a BFD RS beam set/BFD RS beam set(s) could follow those described in Configuration-1, Configuration-2, Configuration-3, Configuration-I.A, Configuration-I.B, Configuration-I.C, Configuration-II.A, Configuration-II.B and Configuration-II.C. The methods of configuring the CF/CB RACH resource(s) and/or the corresponding PRACH beam(s) for sending the BFRQ could follow those described in Method-1, Method-2, Method-3, Method-I.A, Method-I.B, Method-I.C, Method-II.A, Method-II.B and Method-II.C.

If the UE uses RACH resource(s) to send the BFRQ and/or new beam information, four slots after the UE has transmitted the BFRQ and/or new beam information for the failed TRP(s) to the network, the UE could start to monitor one or more search spaces/CORESETs for the corresponding BFRR. The dedicated CORESET for BFRR is addressed to the UE-specific C-RNTI, and would be transmitted by the failed TRP(s) with the newly identified beam for the failed TRP(s). If the UE detects a valid UE-specific DCI in the dedicated CORESET for BFRR, the UE would assume that the beam failure recovery request for the failed TRP(s) has been successfully received by the network, and the UE would complete the BFR process for the failed TRP(s).

Other than the dedicated CORESET for BFRR, other types of search space/CORESET could be used for indicating the BFRR as well. For example, the UE could monitor the common search space (CSS) for the corresponding BFRR. For another example, the UE could monitor the UE-specific search space (USS) corresponding to the working TRP(s) for the BFRR for the failed TRP(s). Yet in another example, in a single-PDCCH based multi-TRP system, where the same DCI content is repeated across the coordinating TRPs, the UE could monitor the SS/CORESET where the multi-beam repetition is configured. After the UE has received the BFRR for the failed TRP(s), the UE would assume the new beam identified for the failed TRP(s) (from the TRP-specific/per TRP NBI RS(s) in a BFD RS beam set/BFD RS beam set(s)) as the spatial QCL source for the following DL transmissions from the failed TRP(s) until the UE receives MAC CE or RRC reconfiguration messages to indicate a new beam/TCI for the failed TRP(s).

In one embodiment, a reduced TRP-specific/per TRP BFR procedure is provided.

Different coordinating TRPs in a multi-TRP system could handle different types of traffic with different priorities. For example, the UE could conduct high-priority operations such as initial access, CSS monitoring, and etc. with only one of the coordinating TRPs, which could be regarded as a primary TRP. The other coordinating TRP(s) in the same multi-TRP system, therefore, could be regarded as secondary TRP(s), with which the UE could perform low-priority operations such as throughput/reliability enhancement. For example, if the UE has detected beam failure for the primary TRP in a multi-TRP system, the 3GPP Rel.15/16 RACH-based BFR procedure could be triggered for the corresponding cell (e.g., a PCell or a SpCell). For another example, if the UE has detected beam failure(s) for the secondary TRP(s) in a multi-TRP system, the UE would not need to (quickly) recover the failed BPL(s) with the secondary TRP(s) to reduce the power consumption and other implementation costs; the UE would still need to identify the failed beam(s) for the failed secondary TRP(s) and transmit the BFRQ for the failed secondary TRP(s) to the network. The above procedure can be referred to as a reduced TRP-specific/per TRP BFR procedure for a multi-TRP system.

The UE could receive from the network an indication to differentiate between the primary TRP and the secondary TRP(s) in a multi-TRP system; this indication could be via higher layer (RRC) or/and MAC CE or/and DCI based signaling; this indication could be via a separate (dedicated) parameter or joint with another parameter. In one example, the UE could be higher layer configured by the network (e.g., via higher layer RRC parameter) the PCI value(s)/TRP ID value(s)/CORESETPoolIndex value(s)/CORESETGroupIndex value(s)/other higher layer TRP-specific ID/index value(s) for the primary TRP and/or the secondary TRP(s). In another example, the UE could be first higher layer configured by the network (e.g., via higher layer RRC parameter) a list/set/pool of PCI values/TRP ID values/CORESETPoolIndex values/CORESETGroupIndex values/other higher layer TRP-specific ID/index values corresponding to the primary TRP and the secondary TRP(s) in the multi-TRP system. The UE could then receive from the network a MAC CE command activating the primary TRP and/or one or more secondary TRPs. Alternatively, the UE could receive from the network a bitmap indicating the primary TRP and/or one or more secondary TRPs. In yet another example, the UE could also receive the indication (e.g., a flag indicator) to differentiate between the primary TRP and/or the secondary TRP(s) along with the configuration of the BFD RS(s)/BFD RS beam set(s).

For the explicit BFD RS configuration, an indicator (e.g., a flag indicator) could be incorporated into the corresponding CSI resource setting. For instance, the indicator could be incorporated into the higher layer parameter CSI-ResourceConfig. For another, the indicator could be incorporated into the higher layer parameter NZP-CSI-RS-ResourceSet. The indicator could be incorporated into other higher layer parameters relevant to the CSI resource setting as well. For example, if the (flag) indicator is set to “1” and/or “ON,” the configured RS(s) for BFD or the BFD RS(s) is associated with/linked to the primary TRP. If the (flag) indicator is set to “0” and/or “OFF,” the configured RS(s) for BFD or the BFD RS(s) is associated with/linked to a secondary TRP. The UE could also be indicated by the network the association between the primary/secondary TRPs and the PCI values/TRP ID values/other higher layer TRP-specific ID/index values. For instance, the UE could be indicated by the network that the primary TRP corresponds to the lower PCI value, while the secondary TRP(s) corresponds to the higher PCI value(s).

For the implicit BFD RS configuration, an indicator (e.g., a flag indicator) could be incorporated into the active TCI state for the PDCCH with QCL-TypeD. The indicator could be incorporated into other higher layer parameters relevant to the active TCI state for the PDCCH as well. For example, if the (flag) indicator is set to “1” and/or “ON,” the QCL-TypeD source RS(s) in the active TCI state(s) or the BFD RS(s) is associated with/linked to the primary TRP. If the (flag) indicator is set to “0” and/or “OFF,” the QCL-TypeD source RS(s) in the active TCI state(s) or the BFD RS(s) is associated with/linked to a secondary TRP. The UE could also be indicated by the network the association between the primary/secondary TRPs and the CORESETPoolIndex/CORESETGroupIndex values. For instance, the UE could be indicated by the network that the primary TRP corresponds to the lower CORESETPoolIndex/CORESETGroupIndex value, while the secondary TRP(s) corresponds to the higher CORESETPoolIndex/CORESETGroupIndex value(s).

After the UE has detected/declared beam failure(s) for the BFD RS(s)/BFD RS beam set(s) associated with the primary TRP, the RACH-based BFR procedure could be triggered for the cell (e.g., a PCell or a SpCell). In one example, the UE could send the BFRQ and/or the new beam information via the CF RACH resource(s) as shown in FIG. 6B. In another example, the UE could initiate the CB RACH procedure to access/connect to the cell/TRPs.

After the UE has detected/declared beam failure(s) for the BFD RS(s)/BFD RS beam set(s) associated with the secondary TRP(s), the UE could send the BFRQ for the failed secondary TRP(s) on the PUCCH resource(s) associated with the (failed) BFD RS(s)/BFD RS beam set(s) (i.e., the failed secondary TRP(s)) or the PUCCH resource(s) associated with the (working) BFD RS(s)/BFD RS beam set(s) (i.e., the primary TRP) following those described in Method-1, Method-2, Method-3, Method-I.A, Method-I.B, Method-I.C, Method-II.A, Method-II.B and/or Method-II.C. After sending the BFRQ for the failed secondary TRP(s), the UE may perform one of following operation.

In one example, the UE would not wait for/monitor the UL grant in response to the BFRQ PUCCH-SR, measure/monitor the NBI RS(s)/NBI RS beam set(s) associated with the failed secondary TRP(s), send the failed secondary TRP(s) index/information and other necessary information via the scheduled PUSCH resource(s) for MAC CE, or/and wait for/monitor the BFRR from the network to complete the BFR procedure/process. The network may not even configure the NBI RS(s)/NBI RS beam set(s) for the failed secondary TRP(s).

In another example, the UE would wait for/monitor the UL grant in response to the BFRQ PUCCH-SR, and send the failed secondary TRP(s) index/information and other necessary information via the scheduled PUCCH resource(s) for MAC CE. The UE, however, would not measure/monitor the NBI RS(s)/NBI RS beam set(s) associated with the failed secondary TRP(s) or/and wait for/monitor the BFRR from the network to complete the BFR procedure/process. The network may not even configure the NBI RS(s)/NBI RS beam set(s) for the failed secondary TRP(s).

FIG. 11 illustrates a signaling flow 1100 for a reduced TRP-specific or per TRP BFR procedure in a multi-TRP system according to embodiments of the present disclosure. An embodiment of the signaling flow 1100 shown in FIG. 11 is for illustration only. For example, the signaling flow 1100 may be implemented between a UE (e.g., 111-116 as illustrated in FIG. 1) and BSs station (e.g., 101-103 as illustrated in FIG. 1).

An example illustrating the reduced TRP-specific or per TRP BFR procedure is shown in FIG. 11. In this example, a multi-TRP system comprising of two TRPs, TRP-1 and TRP-2, is assumed with TRP-1 as the primary TRP and TRP-2 as the secondary TRP. If the UE has detected/declared beam failure(s) for TRP-2 (e.g., by detecting/declaring beam failure(s) for the BFD RS(s)/BFD RS beam set(s) associated with TRP-2), the UE would send to the network the corresponding BFRQ for the failed TRP-2. It can be seen from FIG. 11 that the UE sends the BFRQ for TRP-2 to TRP-1 through the resource(s) (e.g., PUCCH resource(s)) associated with TRP-1, or the BFD RS(s)/BFD RS beam set(s) associated with TRP-1. After receiving the UL grant from TRP-1, the UE could send the failed TRP index and other necessary information to TRP-1 via its scheduled PUSCH resource(s) for MAC CE. The UE could then be configured by the network via MAC CE/RRC to fall back to the single-TRP operation until further reconfiguration from the network.

In the above illustrated reduced BFR procedure for the secondary TRP, the configuration of the NBI RSs for the secondary TRP is optional. That is, the UE may not be configured by the network with any NBI RSs for the secondary TRP, though the UE would still transmit the BFRQ for the secondary TRP if the UE has detected beam failure for the secondary TRP. The UE could be configured by the network with valid NBI RSs for the secondary TRP, but the UE may not be able to identify a new beam for the secondary TRP from the NBI RSs (their signal qualities are all below a given threshold). In this case, the UE would still transmit the BFRQ for the secondary TRP if the UE has detected beam failure for the secondary TRP.

As discussed above, the UE could fall back to the single-TRP operation after transmitting the BFRQ and other necessary information to the network. For the multi-TRP system shown in FIG. 10 with TRP-1 as the primary TRP and TRP-2 as the secondary TRP, if the UE has detected beam failure for TRP-2 and sent the corresponding BFRQ for TRP-2, the UE would not monitor the CORESETs associated with TRP-2. Even after the UE has fallen back to the single-TRP operation, the UE could still monitor the received signal qualities of the BFD RSs and/or NBI RSs (if configured) from the failed secondary TRP(s). If the received signal qualities of the BFD RSs and/or NBI RSs (if configured) from the failed secondary TRP are beyond a certain threshold for a given period of time, the UE would transmit a beam alive request for the failed secondary TRP(s) to the network. The UE could then be configured by the network to switch from the single-TRP operation to the multi-TRP operation.

The above described reduced TRP-specific/per TRP BFR procedure can be applied to the primary TRP in the multi-TRP system. That is, after the UE has detected/declared beam failure(s) for the BFD RS(s)/BFD RS beam set(s) associated with the primary TRP, the UE would only report to the network the BFRQ for the failed primary TRP. After that, the UE would not monitor/measure the NBI RS(s) configured for the primary TRP and/or the CORESET(s) associated with the primary TRP.

Alternatively, after the UE has detected/declared beam failure(s) for the BFD RS(s)/BFD RS beam set(s) associated with the primary TRP, the RACH-based BFR procedure could be triggered for the cell (e.g., a PCell or a SpCell). In one example, the UE could send the BFRQ and/or the new beam information via the CF RACH resource(s) as shown in FIG. 6B. In another example, the UE could initiate the CB RACH procedure (such as that shown in FIG. 7B) to access/connect to the cell/TRPs. As the primary TRP transmits/receives high-priority information to/from the UE, a full/complete TRP-specific/per TRP BFR procedure, such as that shown in FIG. 7B, can be applied to the primary TRP in the multi-TRP system.

Regardless how the primary/secondary TRPs are defined/specified in the multi-TRP system, the UE could receive from the network an indication to identify which TRP(s) in a multi-TRP system to apply the reduced TRP-specific/per TRP BFR procedure; this indication could be via higher layer (RRC) or/and MAC CE or/and DCI based signaling; this indication could be via a separate (dedicated) parameter or joint with another parameter. In one example, the UE could be higher layer configured by the network (e.g., via higher layer RRC parameter) the PCI value(s)/TRP ID value(s)/CORESETPoolIndex value(s)/CORESETGroupIndex value(s)/other higher layer TRP-specific ID/index value(s) for the TRP(s) to apply the reduced TRP-specific/per TRP BFR procedure. In another example, the UE could be first higher layer configured by the network (e.g., via higher layer RRC parameter) a list/set/pool of PCI values/TRP ID values/CORESETPoolIndex values/CORESETGroupIndex values/other higher layer TRP-specific ID/index values corresponding to all TRPs in the multi-TRP system. The UE could then receive from the network a MAC CE command activating the TRP(s) to apply the reduced TRP-specific/per TRP BFR procedure. Alternatively, the UE could receive from the network a bitmap indicating the TRP(s) to apply the reduced TRP-specific/per TRP BFR procedure. In yet another example, the UE could also receive the indication (e.g., a flag indicator) for identifying the TRP(s) to apply the reduced TRP-specific/per TRP BFR procedure along with the configuration of the BFD RS(s)/BFD RS beam set(s).

For the explicit BFD RS configuration, an indicator (e.g., a flag indicator) could be incorporated into the corresponding CSI resource setting. For instance, the indicator could be incorporated into the higher layer parameter CSI-ResourceConfig. For another example, the indicator could be incorporated into the higher layer parameter NZP-CSI-RS-ResourceSet. The indicator could be incorporated into other higher layer parameters relevant to the CSI resource setting as well. For example, if the (flag) indicator is set to “1” and/or “ON,” the configured RS(s) for BFD or the BFD RS(s) is associated with/linked to the TRP(s) not to apply the reduced TRP-specific/per TRP BFR procedure. If the (flag) indicator is set to “0” and/or “OFF,” the configured RS(s) for BFD or the BFD RS(s) is associated with/linked to the TRP(s) to apply the reduced TRP-specific/per TRP BFR procedure.

The UE could also be indicated by the network the association between the TRPs to apply the reduced TRP-specific/per TRP BFR procedure or not to apply the reduced TRP-specific/per TRP BFR procedure and the PCI values/TRP ID values/other higher layer TRP-specific ID/index values. For instance, the UE could be indicated by the network that the TRP not to apply the reduced TRP-specific/per TRP BFR corresponds to the lower PCI value, while the TRP to apply the reduced TRP-specific/per TRP BFR corresponds to the higher PCI value(s).

For the implicit BFD RS configuration, an indicator (e.g., a flag indicator) could be incorporated into the active TCI state for the PDCCH with QCL-TypeD. The indicator could be incorporated into other higher layer parameters relevant to the active TCI state for the PDCCH as well. For example, if the (flag) indicator is set to “1” and/or “ON,” the QCL-TypeD source RS(s) in the active TCI state(s) or the BFD RS(s) is associated with/linked to the TRP(s) not to apply the reduced TRP-specific/per TRP BFR procedure. If the (flag) indicator is set to “0” and/or “OFF,” the QCL-TypeD source RS(s) in the active TCI state(s) or the BFD RS(s) is associated with/linked to the TRP(s) to apply the reduced TRP-specific/per TRP BFR procedure.

The UE could also be indicated by the network the association between the TRPs to apply the reduced TRP-specific/per TRP BFR procedure or not to apply the reduced TRP-specific/per TRP BFR procedure and the CORESETPoolIndex/CORESETGroupIndex values. For instance, the UE could be indicated by the network that the TRP not to apply the reduced TRP-specific/per TRP BFR corresponds to the lower CORESETPoolIndex/CORESETGroupIndex value, while the TRP to apply the reduced TRP-specific/per TRP BFR corresponds to the higher CORESETPoolIndex/CORESETGroupIndex value(s).

In one embodiment, various methods of triggering/initiating different types of BFR for the multi-TRP operation are provided.

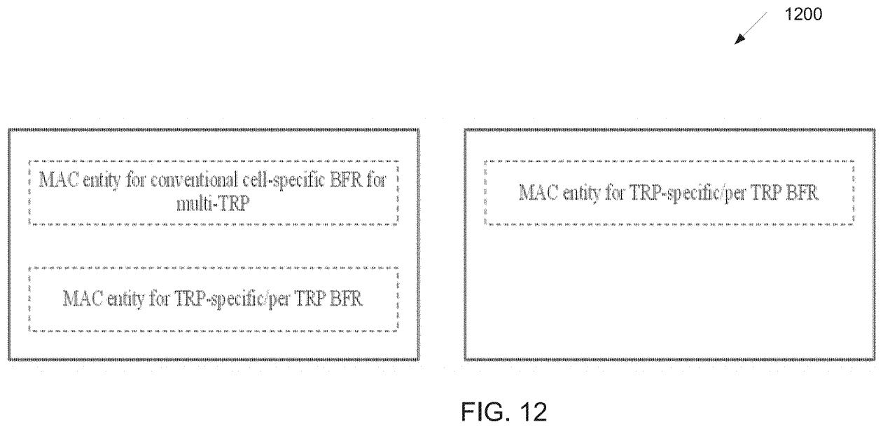

FIG. 12 illustrates an example of MAC entities 1200 for cell-specific or TRP-specific BFR operation according to embodiments of the present disclosure. An embodiment of the MAC entities 1200 for cell-specific or TRP-specific BFR operation shown in FIG. 12 is for illustration only.

The UE could configure one or more MAC entities for multi-TRP BFR. For example, the UE could configure one MAC entity for the conventional cell-specific BFR for a multi-TRP system. Note that in the conventional cell-specific BFR for the multi-TRP operation, the UE would only declare beam failure(s) if all the BFD RSs in all the BFD RS beam set(s) configured for/associated with all the coordinating TRPs in the multi-TRP system fail. As depicted on the LHS in FIG. 12, the UE could also have another MAC entity for the TRP-specific/per TRP BFR. In this case, if the UE has detected a conventional cell-specific BFR event for the multi-TRP system, the UE should have also detected all the TRP-specific or per TRP BFR events, each corresponding to a coordinating TRP or BFD RS(s)/BFD RS beam set(s) associated with a coordinating TRP.

In one example, the UE could simultaneously trigger/initiate a conventional cell-specific BFR for a PCell or a SpCell and one or more TRP-specific/per TRP BFRs for one or more SCells; the PCell (SpCell) and the SCells could be on different component carriers or the same component carriers. In another example, the UE could simultaneously trigger/initiate one or more TRP-specific/per TRP BFRs for one or more SCells; the SCells could be on different component carriers or the same component carrier.

Alternatively, the UE could only configure a single MAC entity for multi-TRP BFR, which is the TRP-specific/per TRP BFR MAC entity (shown on the RHS in FIG. 12). In this case, the MAC entity for conventional cell-specific BFR (e.g., the BFD counter, timer and etc.) is no longer configured. Hence, the UE could only be able to declare the beam failure event on a per TRP basis. Under certain settings, initiating/triggering the TRP-specific or per TRP BFR procedure could become inefficient. Hence, if the UE has detected more than one TRP-specific or per TRP beam failure events simultaneously or within a time window, the UE would trigger a conventional cell-specific BFR for the multi-TRP system rather than multiple independent/separate TRP-specific/per TRP BFR procedures. That is, if the UE has declared beam failures for all the configured BFD RS beam sets within the time window, the UE could initiate/trigger a RACH based transmission to send to the network the beam failure recovery request. In the present disclosure, the time window could be: (1) fixed in the system specifications, (2) configured by the network, or (3) determined by the UE. For some cases, the time window could correspond to zero.

For example, for S_q0/G_q0=2, within X symbols/slots/mini-slots after the UE has detected/declared beam failure for the BFD RS beam set q0-0 (or q0-1), i.e., the radio link quality for the BFD RS beam set q0-0 (or q0-1) is below the corresponding BFD threshold or the maximum number of BFI count associated with the BFD RS beam set q0-0 (or q0-1) is achieved/reached before the expiration of the BFD timer associated with the BFD RS beam set q0-0 (or q0-1), if the UE could detect/declare beam failure for the other BFD RS beam set q0-1 (or q0-0), i.e., the radio link quality for the other BFD RS beam set q0-1 (or q0-0) is below the corresponding BFD threshold or the maximum number of BFI count associated with the other BFD RS beam set q0-1 (or q0-0) is achieved/reached before the expiration of the BFD timer associated with the other BFD RS beam set q0-1 (or q0-0), the UE would trigger/initiate a CFRA or CBRA based transmission to send to the network the beam failure recovery request for both BFD RS beam sets q0-0 and q0-1. The UE could be configured by the network to use either the CFRA or the CBRA based transmission to send the beam failure recovery request.

The value(s) of X could be: (1) fixed in the system specifications, (2) based on network configuration, and (3) autonomously determined by the UE and/or reported to the network as a UE capability/feature signaling.

For another example, for S_q0/G_q0=2, consider that the UE has detected/declared beam failure for the BFD RS beam set q0-0 (or q0-1), i.e., the radio link quality for the BFD RS beam set q0-0 (or q0-1) is below the corresponding BFD threshold or the maximum number of BFI count associated with the BFD RS beam set q0-0 (or q0-1) is achieved/reached before the expiration of the BFD timer associated with the BFD RS beam set q0-0 (or q0-1). In this case, before the UE sends to the network the PUCCH-SR for BFR to request beam failure recovery for the failed BFD RS beam set q0-0 (or q0-1), if the UE could detect/declare beam failure for the other BFD RS beam set q0-1 (or q0-0), i.e., the radio link quality for the other BFD RS beam set q0-1 (or q0-0) is below the corresponding BFD threshold or the maximum number of BFI count associated with the other BFD RS beam set q0-1 (or q0-0) is achieved/reached before the expiration of the BFD timer associated with the other BFD RS beam set q0-1 (or q0-0), the UE could trigger/initiate a CFRA or CBRA based transmission to send to the network the beam failure recovery request for both BFD RS beam sets q0-0 and q0-1. The UE could be configured by the network to use either the CFRA or the CBRA based transmission to send the beam failure recovery request.

Yet for another example, for S_q0/G_q0=2, consider that the UE has detected/declared beam failure for the BFD RS beam set q0-0 (or q0-1), i.e., the radio link quality for the BFD RS beam set q0-0 (or q0-1) is below the corresponding BFD threshold or the maximum number of BFI count associated with the BFD RS beam set q0-0 (or q0-1) is achieved/reached before the expiration of the BFD timer associated with the BFD RS beam set q0-0 (or q0-1). In this case, before the UE receives from the network the uplink grant for sending information on the failed BFD RS beam set q0-0 (or q0-1) via PDSCH MAC CE, if the UE could detect/declare beam failure for the other BFD RS beam set q0-1 (or q0-0), i.e., the radio link quality for the other BFD RS beam set q0-1 (or q0-0) is below the corresponding BFD threshold or the maximum number of BFI count associated with the other BFD RS beam set q0-1 (or q0-0) is achieved/reached before the expiration of the BFD timer associated with the other BFD RS beam set q0-1 (or q0-0), the UE could trigger/initiate a CFRA or CBRA based transmission to send to the network the beam failure recovery request for both BFD RS beam sets q0-0 and q0-1. The UE could be configured by the network to use either the CFRA or the CBRA based transmission to send the beam failure recovery request.

Yet for another example, for S_q0/G_q0=2, consider that the UE has detected/declared beam failure for the BFD RS beam set q0-0 (or q0-1), i.e., the radio link quality for the BFD RS beam set q0-0 (or q0-1) is below the corresponding BFD threshold or the maximum number of BFI count associated with the BFD RS beam set q0-0 (or q0-1) is achieved/reached before the expiration of the BFD timer associated with the BFD RS beam set q0-0 (or q0-1). In this case, before the UE sends to the network information on the failed BFD RS beam set q0-0 (or q0-1) via the PDSCH MAC CE, if the UE has detected/declared beam failure for the other BFD RS beam set q0-1 (or q0-0), i.e., the radio link quality for the other BFD RS beam set q0-1 (or q0-0) is below the corresponding BFD threshold or the maximum number of BFI count associated with the other BFD RS beam set q0-1 (or q0-0) is achieved/reached before the expiration of the BFD timer associated with the other BFD RS beam set q0-1 (or q0-0), the UE could trigger/initiate a CFRA or CBRA based transmission to send to the network the beam failure recovery request for both BFD RS beam sets q0-0 and q0-1. The UE could be configured by the network to use either the CFRA or the CBRA based transmission to send the beam failure recovery request.

Yet for another example, for S_q0/G_q0=2, consider that the UE has detected/declared beam failure for the BFD RS beam set q0-0 (or q0-1), i.e., the radio link quality for the BFD RS beam set q0-0 (or q0-1) is below the corresponding BFD threshold or the maximum number of BFI count associated with the BFD RS beam set q0-0 (or q0-1) is achieved/reached before the expiration of the BFD timer associated with the BFD RS beam set q0-0 (or q0-1). In this case, before the UE receives from the network the beam failure recovery response (BFRR) for the failed BFD RS beam set q0-0 (or q0-1), if the UE has detected/declared beam failure for the other BFD RS beam set q0-1 (or q0-0), i.e., the radio link quality for the other BFD RS beam set q0-1 (or q0-0) is below the corresponding BFD threshold or the maximum number of BFI count associated with the other BFD RS beam set q0-1 (or q0-0) is achieved/reached before the expiration of the BFD timer associated with the other BFD RS beam set q0-1 (or q0-0), the UE could trigger/initiate a CFRA or CBRA based transmission to send to the network the beam failure recovery request for both BFD RS beam sets q0-0 and q0-1. The UE could be configured by the network to use either the CFRA or the CBRA based transmission to send the beam failure recovery request.

For the CFRA based BFR procedure/transmission, the UE would send to the network the BFRQ through a CF PRACH resource/preamble, whose index is associated with a NBI RS resource/new beam identified by the UE from the NBI RS beam set q1-0 or q1-1. The UE could be first configured by the network a set of PRACH resources/preambles, each corresponding to/associated with a NBI RS resource in the NBI RS beam sets q1-0 and q1-1. The UE could then select the PRACH resource/preamble that has the one-to-one correspondence to the selected/identified NBI RS resource (the new beam) from the NBI RS beam set q1-0 or q1-1 to send the BFRQ. From the index of the selected PRACH resource/preamble, the network could know which beam is selected/identified by the UE as the new beam. Otherwise, e.g., for S_q0/G_q0=2, within X symbols/slots/mini-slots after the UE has detected beam failure for the BFD RS beam set q0-0 (or q0-1), if the UE could not detect beam failure for the other BFD RS beam set q0-1 (or q0-0), the UE would declare beam failure for the failed BFD RS beam set q0-0 (or q0-1) following the TRP-specific/per TRP BFR procedures specified in the present disclosure.

To initiate and complete the conventional cell-specific BFR procedure for the multi-TRP system, the UE could first determine the target TRP toward which, the UE would transmit the BFRQ, new beam information and etc., and from which the UE would receive the BFRR. There could be various factors that would affect the determination of the target TRP such as the most recent available resources for each coordinating TRP to convey the BFRQ, channel conditions between the UE and the coordinating TRPs, and etc. The UE could be indicated by the network the target TRP(s).

Alternatively, the UE could also autonomously determine/select the target TRP(s) and indicate to the network their selection. Further, the UE could even trigger a TRP-specific/per TRP BFR without waiting for all the TRP-specific BFD RSs to fail. For instance, for the multi-TRP system shown in FIG. 10, assume that three BFD RSs are configured in the TRP-2 BFD RS beam set. Instead of waiting for all three BFD RSs to fail, the UE could trigger beam failure for TRP-2 as soon as the UE has detected that the received signal quality of one of the three BFD RSs falls below the BFD threshold before the BFD timer expires.

The TRP-specific/per TRP BFR could be regarded as one type, or a special case of partial BFR for the multi-TRP system. In addition to the TRP-specific/per TRP partial BFR, another type of partial BFR could be defined such that the BFD RSs (NBI RSs) in a (virtual) BFD RS beam set ((virtual) NBI RS beam set) are associated with/from different coordinating TRPs (non-per TRP partial BFR).

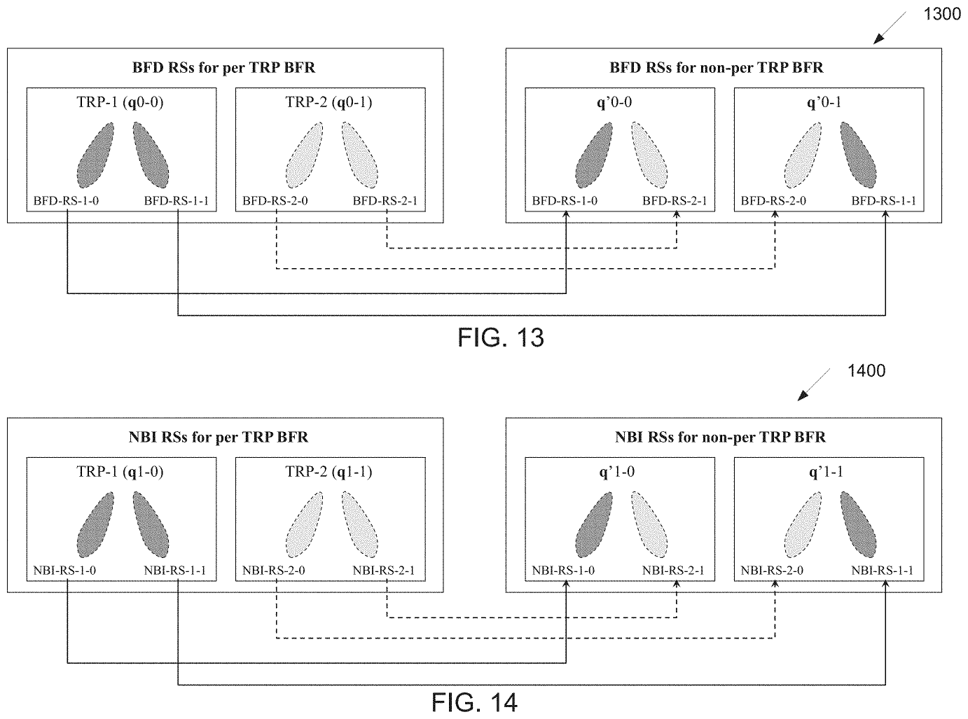

FIG. 13 illustrates an example of BFD RSs configurations 1300 in a multi-TRP system according to embodiments of the present disclosure. An embodiment of the BFD RSs configurations 1300 in a multi-TRP system shown in FIG. 13 is for illustration only.

FIG. 14 illustrates another example of BFD RSs configurations 1400 in a multi-TRP system according to embodiments of the present disclosure. An embodiment of the BFD RSs configurations 1400 in a multi-TRP system shown in FIG. 14 is for illustration only.

In FIG. 13, conceptual examples of BFD RSs configurations for both per TRP partial BFR and non-per TRP partial BFR are presented. In the per TRP BFR design, the BFD RS beam set for TRP-1 (q0_0) contains two BFD RSs, i.e., BFD-RS-1-0 and BFD-RS-1-1, and the BFD RS beam set for TRP-2 (q0_1) contains two BFD RSs, i.e., BFD-RS-2-0 and BFD-RS-2-1. As shown on the RHS in FIG. 13, virtual BFD RS beams sets are defined for the non-per TRP partial BFR design such that a first virtual BFD RS beam set (q′0-0) could contain BFD-RS-1-0 from TRP-1 (q0-0) and BFD-RS-2-1 from TRP-2 (q0-1), and a second virtual BFD RS beam set (q′0-1) could contain BFD-RS-1-1 from TRP-1 (q0-0) and BFD-RS-2-0 from TRP-2 (q0-1).

Similar design principles could be applied to the configurations of the NBI RSs for the non-per TRP partial BFR as well. As can be seen from the examples shown in FIG. 14, a first virtual NBI RS beam set (q′1-0) for non-per TRP partial BFR could contain NBI-RS-1-0 from TRP-1 (q1-0) and NBI-RS-2-1 from TRP-2 (q1-1), and a second NBI RS beam set (q′1-1) for non-per TRP partial BFR could contain NBI-RS-1-1 from TRP-1 (q1-0) and NBI-RS-2-0 from TRP-2 (q1-1).

Furthermore, as can be seen from TABLE 4, the BFD threshold/timer, the BFR threshold/timer and the maximum number of BFI count could all be defined on the basis of virtual BFD RS beam set/NBI RS beam set. For example, BFDtimer′-1 is defined for the virtual BFD RS beam set q′0-0, and BFDtimer′-2 is defined for the virtual BFD RS beam set q′0-1. That is, BFD-RS-1-0 and BFD-RS-1-1 could correspond to two different BFD RS timers, though they are transmitted from the same TRP-1. The UE could be configured by the network with the parameters shown in TABLE 4 via higher layer signaling such as RRC signaling. For instance, the UE could be configured/indicated by the network about the rules of constructing the virtual BFD/RS beam sets and how they would be mapped to the coordinating TRPs. It is evident from TABLE 4 that a new MAC entity for non-per TRP partial BFR could be configured by the UE.

TABLE 4
BFR parameters for partial BFR

| | q’0-0, q’1-0 | q’0-1, q’1-1 |
|---|---|---|
| Maximum number | maxBFIcount’-0 | maxBFIcount’-1 |
| of BFI count | | |
| BFD timer | BFDtimer’-0 | BFDtimer’-1 |
| BFR timer | BFRtimer’-0 | BFRtimer’-1 |
| BFD threshold | Qout-0 | Qout-1 |
| BFR threshold | Qin-0 | Qin-1 |

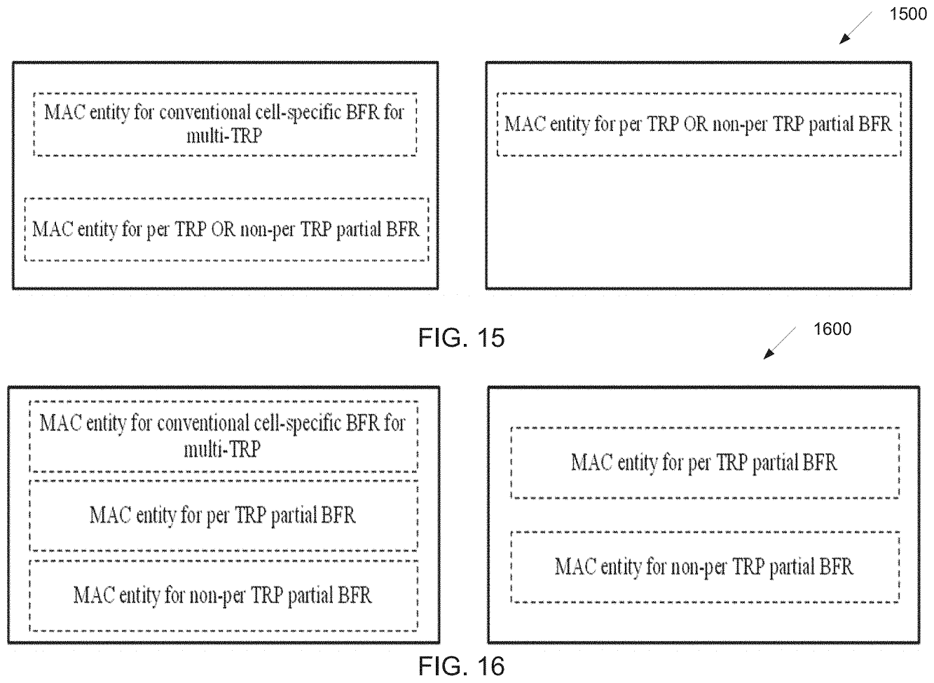

FIG. 15 illustrates an example of a MAC entity for partial BFR 1500 in a multi-TRP system according to embodiments of the present disclosure. An embodiment of the MAC entity for partial BFR 1500 in a multi-TRP system shown in FIG. 15 is for illustration only.

FIG. 16 illustrates another example of a MAC entity for partial BFR 1600 in a multi-TRP system according to embodiments of the present disclosure. An embodiment of the MAC entity for partial BFR 1600 in a multi-TRP system shown in FIG. 16 is for illustration only.

In FIG. 15, a MAC entity for partial BFR for multi-TRP is configured. As illustrated in FIG. 15, with the single MAC entity for partial BFR for multi-TRP, the UE could detect/declare either per TRP BFR or non-per TRP BFR. For instance, assume that the MAC entity for partial BFR for multi-TRP is configured as non-per TRP BFR. For the design example shown on the RHS in FIG. 15, the UE would initiate a conventional cell-specific BFR for the multi-TRP system if the UE has detected more than one non-per TRP partial beam failure events simultaneously or within a configured time window.

In FIG. 16, separate MAC entities are configured for per TRP partial BFR and non-per TRP partial BFR. In this case, the UE could be able to detect beam failure events based on the BFD RSs from both the TRP-specific BFD RS beam set and the virtual BFD RS beam set. The UE could, therefore, initiate the per TRP partial BFR and the non-per TRP partial BFR at the same time.

For illustrative purposes the steps of this algorithm are described serially, however, some of these steps may be performed in parallel to each other. The above operation diagrams illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive a first pair of reference signal (RS) sets including (i) a first set of RSs, through a first set of RS resources, for detecting a first beam failure and (ii) a second set of RSs, through a second set of RS resources, for identifying a first candidate beam for recovering the first beam failure, wherein the first set of RSs and the second set of RSs have a same resource set index or identity (ID); and
receive a second pair of RS sets including (i) a third set of RSs, through a third set of RS resources, for detecting a second beam failure and (ii) a fourth set of RSs, through a fourth set of RS resources, for identifying a second candidate beam for recovering the second beam failure, wherein the third set of RSs and the fourth set of RSs have a same resource set index or ID; and
a processor operably coupled to the transceiver, the processor configured to:
detect the first or second beam failure; and
identify a physical uplink control channel (PUCCH) resource, from a first PUCCH resource associated with the first set of RSs and a second PUCCH resource associated with the third set of RSs, for transmission of a recovery request for the detected first or second beam failure,
wherein the transceiver is further configured to transmit a first signal to request recovery of the first or second beam failure using the PUCCH resource.

2. The UE of claim 1, wherein the processor is further configured to identify:
the first set of RS resources based on quasi co-location (QCL) information for physical downlink control channel (PDCCH) reception in one or more first control resource sets (CORESETs) configured with a value of 0 for a pool index of the one or more first CORESETs (CORESETPoolIndex); and
the third set of RS resources based on QCL information for PDCCH reception in one or more second CORESETs configured with a value of 1 for CORESETPoolIndex.

3. The UE of claim 1, wherein the transceiver is further configured to receive:
a first parameter configuring the first PUCCH resource, wherein the first parameter indicates the resource set index or ID of the first set of RS resources; and
a second parameter configuring the second PUCCH resource, wherein the second parameter indicates the resource set index or ID of the third set of RS resources.

4. The UE of claim 1, wherein:
the transceiver is further configured to receive a medium access control control element (MAC CE) or bitmap indicating to update one or more RS resources in the first set or third set of RS resources, and
the MAC CE or bitmap indicates at least one of:
the resource set index or ID of the first or third set of RS resources;
a physical cell identity (PCI);
a pool index of a control resource set (CORESETPoolIndex); and
a one-bit flag or indicator.

5. The UE of claim 1, wherein:
the transceiver is further configured to receive information regarding a first RS received power (RSRP) threshold; and
the processor is further configured to:
identify a first or second radio link quality by measuring the first or third set of RS resources, respectively;
increment a first or second beam failure instance (BFI) count by one if the first or second radio link quality is smaller than the first RSRP threshold; and
declare the first or second beam failure for the first or third set of RSs if the first or second BFI count reaches a maximum number of BFI counts before a beam failure detection timer expires.

6. The UE of claim 1, wherein:
the transceiver is further configured to receive information regarding a second RS received power (RSRP) threshold; and
the processor is further configured to:
identify a third or fourth radio link quality by respectively measuring the second or fourth set of RS resources if the first or second beam failure is declared; and
identify the first or second candidate beam if the third or fourth radio link quality is larger than or equal to the second RSRP threshold.

7. The UE of claim 1, wherein the transceiver is further configured to:
receive information on a time window for a beam failure declaration;
receive configuration information on a set of preambles configured for a beam failure recovery request; and
transmit a second signal for requesting beam failure recovery and indicating the first or second candidate beam through a preamble using a physical random access channel (PRACH) if both of the first and second beam failures are declared within the time window, wherein the preamble is identified from the set of preambles configured for the beam failure recovery request.

8. The UE of claim 7, wherein:
the set of preambles configured for the beam failure recovery request is associated with the second or fourth set of RS resources; and
the preamble is identified from the configuration information on the set of preambles configured for the beam failure recovery request according to the first or second candidate beam.

9. A base station (BS), comprising:
a processor; and
a transceiver operably coupled to the processor, the transceiver configured to:
transmit:
a first pair of reference signal (RS) sets including (i) a first set of RSs, through a first set of RS resources, for detecting a first beam failure and (ii) a second set of RSs, through a second set of RS resources, for identifying a first candidate beam for recovering the first beam failure, wherein the first set of RSs and the second set of RSs have a same resource set index or identity (ID); or
a second pair of RS sets including (i) a third set of RSs, through a third set of RS resources, for detecting a second beam failure and (ii) a fourth set of RSs, through a fourth set of RS resources, for identifying a second candidate beam for recovering the second beam failure, wherein the third set of RSs and the fourth set of RSs have a same resource set index or ID; and
responsive to the first or second beam failure, receive a first signal including a request for recovery of the first or second beam failure through a physical uplink control channel (PUCCH) resource that is one of a first PUCCH resource associated with the first set of RSs and a second PUCCH resource associated with the third set of RSs.

10. The BS of claim 9, wherein:
the first set of RS resources is indicated based on based on quasi co-location (QCL) information for physical downlink control channel (PDCCH) transmission in one or more first control resource sets (CORESETs) configured with a value of 0 for a pool index of the one or more first CORESETs (CORESETPoolIndex); and
the third set of RS resources is indicated based on QCL information for PDCCH transmission in one or more second CORESETs configured with a value of 1 for CORESETPoolIndex.

11. The BS of claim 9, wherein the transceiver is further configured to transmit:
a first parameter configuring the first PUCCH resource, wherein the first parameter indicates the resource set index or ID of the first set of RS resources; and
a second parameter configuring the second PUCCH resource, wherein the second parameter indicates the resource set index or ID of the third set of RS resources.

12. The BS of claim 9, wherein:
the transceiver is further configured to transmit a medium access control control element (MAC CE) or bitmap indicating to update one or more RS resources in the first set or third set of RS resources, and
the MAC CE or bitmap indicates at least one of:
the resource set index or ID of the first or third set of RS resources;
a physical cell identity (PCI);
a pool index of a control resource set (CORESETPoolIndex); and
a one-bit flag or indicator.

13. The BS of claim 9, wherein the transceiver is further configured to:
transmit information on a time window for a beam failure declaration;
transmit configuration information on a set of preambles configured for a beam failure recovery request; and
receive a second signal for requesting beam failure recovery and indicating the first or second candidate beam through a preamble using a physical random access channel (PRACH) if both of the first and second beam failures are declared within the time window, wherein the preamble is indicated in the set of preambles configured for the beam failure recovery request.

14. The BS of claim 13, wherein:
the set of preambles configured for the beam failure recovery request is associated with the second or fourth set of RS resources; and
the preamble is indicated by the configuration information on the set of preambles configured for the beam failure recovery request according to the first or second candidate beam.

15. A method for operating a user equipment (UE), the method comprising:
receiving a first pair of reference signal (RS) sets including (i) a first set of RSs, through a first set of RS resources, for detecting a first beam failure and (ii) a second set of RSs, through a second set of RS resources, for identifying a first candidate beam for recovering the first beam failure, wherein the first set of RSs and the second set of RSs have a same resource set index or identity (ID);
receiving a second pair of RS sets including (i) a third set of RSs, through a third set of RS resources, for detecting a second beam failure and (ii) a fourth set of RSs, through a fourth set of RS resources, for identifying a second candidate beam for recovering the second beam failure, wherein the third set of RSs and the fourth set of RSs have a same resource set index or ID; and
detecting the first or second beam failure;
identifying a physical uplink control channel (PUCCH) resource, from a first PUCCH resource associated with the first set of RSs and a second PUCCH resource associated with the third set of RSs, for transmission of a recovery request for the detected first or second beam failure; and
transmitting a first signal to request recovery of the first or second beam failure using the PUCCH resource.

16. The method of claim 15, further comprising:
identifying the first set of RS resources based on quasi co-location (QCL) information for physical downlink control channel (PDCCH) reception in one or more first control resource sets (CORESETs) configured with a value of 0 for a pool index of the one or more first CORESETs (CORESETPoolIndex); and
identifying the third set of RS resources based on QCL information for PDCCH reception in one or more second CORESETs configured with a value of 1 for CORESETPoolIndex.

17. The method of claim 15, further comprising:
receiving a first parameter configuring the first PUCCH resource, wherein the first parameter indicates the resource set index or ID of the first set of RS resources; and
receiving a second parameter configuring the second PUCCH resource, wherein the second parameter indicates the resource set index or ID of the third set of RS resources.

18. The method of claim 15, further comprising:
receiving information regarding a first RS received power (RSRP) threshold; and
identifying a first or second radio link quality by measuring the first or third set of RS resources, respectively;
incrementing a first or second beam failure instance (BFI) count by one if the first or second radio link quality is smaller than the first RSRP threshold; and
declaring the first or second beam failure for the first or third set of RSs if the first or second BFI count reaches a maximum number of BFI counts before a beam failure detection timer expires.

19. The method of claim 15, further comprising:
receiving information regarding a second RS received power (RSRP) threshold;
identifying a third or fourth radio link quality by respectively measuring the second or fourth set of RS resources if the first or second beam failure is declared; and
identifying the first or second candidate beam if the third or fourth radio link quality is larger than or equal to the second RSRP threshold.

20. The method of claim 15, further comprising:
receiving information on a time window for a beam failure declaration;
receiving configuration information on a set of preambles configured for a beam failure recovery request; and
transmitting a second signal for requesting beam failure recovery and indicating the first or second candidate beam through a preamble using a physical random access channel (PRACH) if both of the first and second beam failures are declared within the time window, wherein the preamble is identified from the set of preambles configured for the beam failure recovery request.
